(19) United States
(12) Patent Application Publication
(10) Pub. No.: US 2026/0200790 A1
(43) Pub. Date: Jul. 16, 2026

(54) GLASS ARTICLES, NATIVELY COLORED GLASS HOUSINGS, AND METHODS OF MAKING THE SAME

(71) Applicant: CORNING INCORPORATED, CORNING, NY (US)

(72) Inventors: Kaveh Adib, Corning, NY (US); Xiaoju Guo, Pittsford, NY (US); Scott Michael Jarvis, Ithaca, NY (US); Po Hsuen Kuo, Painted Post, NY (US); Sean Thomas Ralph Locker, Corning, NY (US); Susan Lee Schiefelbein, Ithaca, NY (US); Randall Eugene Youngman, Horseheads, NY (US)

(21) Appl. No.: 19/137,500

(22) PCT Filed: Dec. 7, 2023
(86) PCT No.: PCT/US2023/082806

§ 371 Date: Jun. 10, 2025

Related U.S. Application Data
(60) Provisional application No. 63/433,065, filed on Dec. 16, 2022.
(60) Provisional application No. 63/536,103, filed on Sep. 1, 2023.

(51) Int. Cl. C03C 4/02; C03C 10/00

(52) U.S. Cl. CPC C03C 4/02; C03C 10/0027; C03C 10/0054

(57) ABSTRACT

The invention relates to a thermal infrared transparent polymer film suitable for use in an identification device, said film comprising an infrared transparent polymer matrix with a pigment dispersed therein, wherein the thickness of the polymer film is greater than 30 micron and wherein the polymer film has an average transmission in the thermal infrared of greater than or equal to 0.5. Preferably, the pigment comprises an inorganic material. There is further provided a thin film, thermally reflective material (20) comprising the afore-mentioned infrared transparent film (21) and an infrared reflective layer provided on one surface thereof (22).

### CROSS-REFERENCE TO RELATED APPLICATIONS

This application claims the benefit of priority under 35 U.S.C. § 119 of U.S. Provisional Application No. 63/536,103 filed Sep. 1, 2023, and claims the benefit of priority under 35 U.S.C. § 119 of U.S. Provisional Application No. 63/433,065 filed Dec. 16, 2022, the content of which is incorporated herein by reference in its entirety.

### FIELD

The present disclosure relates generally to glass articles and natively colored glass housings and methods of making the same and, more particularly, to glass articles and natively colored glass housings comprising a multi-valent colorant.

### BACKGROUND

Glass articles are commonly used, for example, in display devices, for example, liquid crystal displays (LCDs), electrophoretic displays (EPD), organic light-emitting diode displays (OLEDs), plasma display panels (PDPs), or the like. Glass articles can form part of a housing as well as covering the display.

Aluminosilicate glass articles may exhibit superior ion-exchangeability and drop performance. Various industries, including the consumer electronics industry, desire colored materials with the same or similar strength and fracture toughness properties as existing, non-colored, ion-exchange strengthened glasses. However, the color of glass articles may be limited by existing techniques. Accordingly, a need exists to develop methods of making new colors of glass articles

### SUMMARY

There are set forth herein glass articles and natively colored glass housings including the same comprising a multi-valent colorant. The glass articles can exhibit a high brightness (e.g., CIE L* value greater than 50 or greater than 70 and less than 96.5) color. A predetermined color of the glass article and/or natively colored glass can be achieved by controlling an amount of the multi-valent colorant in a reduced form compared to an oxidized form. Additionally, colors not previously obtainable from a given colorant package can be obtained by controlling a molar ratio of the multi-valent colorant in the reduced form to the total amount of the multi-valent colorant.

The glass-based material of the glass article can provide good dimensional stability, good impact resistance, good crack resistance, good puncture resistance, and/or good flexural strength. The glass article can include a compressive stress region (e.g., be chemically strengthened), which can provide improved crack resistance, puncture resistance, impact resistance, and/or improved flexural strength. Also, minimizing the combination of R₂O, CaO, MgO, and ZnO in the glass composition may provide the resultant colored glass article with a desirable dielectric constant, for example when the colored glass article is used as a portion of a housing for an electronic device. Providing a dielectric constant for frequencies from 10 GHz to 60 GHz from 5.6 to 6.4 can allow wireless communication through the glass article.

Providing a natively colored glass housing with a colored glass article can eliminate the need for an additional layer to impart color to the housing, which can simplify assembly and provide a more consistent color. Consequently, the natively colored glass housing including the glass article can provide an aesthetically pleasing appearance (e.g., color) while simultaneously protecting an electronic device from damage and/or permitting wireless communication therethrough.

Methods include forming a glass article from precursor materials comprising a multi-valent colorant with a precursor molar ratio that is different than the molar ratio of the multi-valent colorant in the resulting glass article. The molar ratio can be decreased by, for example, including a source of nitrate, sulfate, zinc, or combinations thereof in the precursor materials. The molar ratio can be increased by, for example, including a source of carbon, iron, antimony, or combinations thereof in the precursor materials. Adjusting a cooling rate of a melt formed from melting the precursor materials can also be used to control a molar ratio of the multi-valent colorant. Controlling the molar ratio of the multi-valent colorant can enable the glass article to reliably produce a predetermined color (e.g., CIE color coordinates). Controlling the molar ratio of the multi-valent colorant can increase a color gamut and/or a resolution of the colors obtained for a predetermined colorant package including the multi-valent colorant.

Some example aspects of the disclosure are described below with the understanding that any of the features of the various aspects may be used alone or in combination with one another.

Aspect 1. A method of making a housing for a consumer electronic device comprising:
melting precursor materials together to form a glass article,
wherein the glass article comprises a silicate glass with a multi-valent colorant having a reduced form and an oxidized form, the precursor materials comprising the multi-valent colorant, the multi-valent colorant is a metal selected from a group consisting of cerium, titanium, cobalt copper, nickel, vanadium, chromium, and combinations thereof, a precursor molar ratio of the reduced form of the multi-valent colorant in the precursor materials to a total of the oxidized form and the reduced form of the multi-valent colorant in the precursor materials is different than a molar ratio of the oxidized form of the multi-valent colorant in the glass article to the total of the oxidized form and the reduced form of the multi-valent colorant in the glass article.

Aspect 2. The method of aspect 1, wherein an absolute value of a difference between the precursor molar ratio of the precursor materials and the molar ratio of the glass article is from about 0.1 to about 0.5.

Aspect 3. The method of any one of aspects 1-2, wherein the precursor molar ratio of the precursor materials is greater than the molar ratio of the glass article.

Aspect 4. The method of any one of aspects 1-3, wherein the precursor materials further comprise 0.02 wt % or more of a source of sulfate, zinc, or combinations thereof.

Aspect 5. The method of aspect 4, wherein the precursor materials comprise from 0.1 wt % to 0.3 wt % of the source of sulfate.

Aspect 6. The method of any one of aspects 4-5, wherein the precursor materials comprise from 0.25 wt % to about 1 wt % of the source of zinc.

Aspect 7. The method of any one of aspects 1-6, wherein the precursor materials further comprise 0.05 wt % or more of a source of nitrate.

Aspect 8. The method of aspect 7, wherein the precursor materials comprise from 0.1 wt % to 3 wt % of the source of nitrate.

Aspect 9. The method of any one of aspects 1-2, wherein the molar ratio of the glass article is greater than the precursor molar ratio of the precursor materials.

Aspect 10. The method of aspect 9, wherein the precursor materials comprise about 0.01 wt % or more of a source of antimony, iron, or combinations thereof.

Aspect 11. The method of aspect 10, wherein the precursor materials comprise from 300 ppm to about 1,300 ppm of the source of iron.

Aspect 12. The method of any one of aspects 1-2 or 10-11 inclusive, wherein the precursor materials comprise from 0.01 wt % to about 0.5 wt % of a source of antimony.

Aspect 13. The method of any one of aspects 1-2 or 10-12 inclusive, wherein the precursor materials comprise from 0.004 wt % to about 0.05 wt % of a source of carbon.

Aspect 14. The method of any one of aspects 1-13, wherein the melting the precursor materials comprises heating the precursor materials to a first temperature of about 1500° C. or more to form a melt, and cooling the melt at a predetermined rate from the first temperature to about 1400° C. before forming the glass article from the melt.

Aspect 15. The method of aspect 14, wherein the predetermined rate is about 0.5° C./min or more.

Aspect 16. The method of any one of aspects 14-15, wherein the predetermined rate is from about 0.5° C./min to about 2° C./min.

Aspect 17. The method of any one of aspects 14-16, further comprising exposing the melt to an atmosphere comprising a partial pressure of oxygen of about 25 kiloPascals or more.

Aspect 18. The method of any one of aspects 14-17, wherein the precursor materials comprise a source of iron, zinc, or combinations thereof.

Aspect 19. The method of any one of aspects 1-18, wherein the multi-valent colorant is chromium.

Aspect 20. The method of any one of aspects 1-19, further comprising disposing the glass article on a reflector layer, the reflector layer is opaque and has a CIE L* value of 70 or more.

Aspect 21. The method of any one of aspects 1-20, wherein an absolute value of a CIE a* value of the glass article is about 0.3 or more, and an absolute of a CIE b* value of the glass article is about 0.2 or more.

Aspect 22. The method of any one of aspects 1-20, wherein a CIE a* value of the glass article is less than −3.

Aspect 23. The method of any one of aspects 1-20, wherein a CIE b* value of the glass article is greater than 5.

Aspect 24. The method of any one of aspects 1-23, wherein a CIE L* value of the glass article is 70 or more.

Aspect 25. The method of any one of aspects 1-24, wherein the molar ratio of the reduced form to the total of the reduced form and the oxidized form in the glass article is from 0.5 to 0.9.

Aspect 26. A natively colored glass housing for a consumer electronic device, the natively colored glass housing comprising a glass article comprising a thickness defined between a first major surface and a second major surface opposite the first major surface, the thickness is from 200 μm to 5 mm, wherein the glass article comprises a silicate glass with a multi-valent colorant having a reduced form and an oxidized form, a molar ratio of the reduced form of the multi-valent colorant to a total of the reduced form and the oxidized form is from 0.3 to 0.9, and a total transmittance of at least one 10 nm band within a wavelength range of 380 nm to 750 nm through the thickness is from 3% to 80%.

Aspect 27. The natively colored glass housing of aspect 26, further comprising a reflector layer overlaying the second major surface, the reflector layer is opaque and has a CIE L* value of 70 or more.

Aspect 28. The natively colored glass housing of any one of aspects 26-27, wherein an absolute value of a CIE a* value of the glass article is about 0.3 or more, and an absolute of the CIE b* value of the glass article is about 0.2 or more.

Aspect 29. The natively colored glass housing of any one of aspects 26-28, wherein a CIE a* value of the glass article is less than −3.

Aspect 30. The natively colored glass housing of any one of aspects 26-29, wherein a CIE b* value of the glass article is greater than 5.

Aspect 31. The natively colored glass housing of any one of aspects 26-30, wherein a CIE L* value of the glass article is 70 or more.

Aspect 32. The natively colored glass housing of any one of aspects 26-31, wherein the molar ratio of the reduced form to the total of the reduced form and the oxidized form is from 0.5 to 0.9.

Aspect 33. The natively colored glass housing of any one of aspects 26-32, wherein the glass article further comprises 200 ppm or more of Fe₂O₃.

Aspect 34. The natively colored glass housing of aspect 33, wherein the glass article comprises from 300 ppm to about 600 ppm of Fe₂O₃.

Aspect 35. The natively colored glass housing of any one of aspects 26-34, wherein the glass article comprises from 0.25 wt % to about 1 wt % of ZnO.

Aspect 36. The natively colored glass housing of any one of aspects 26-35, wherein the glass article comprises from 0.01 wt % to about 0.5 wt % of Sb₂O₃.

Aspect 37. The natively colored glass housing of any one of aspects 26-36, wherein the multi-valent colorant is a metal selected from a group consisting of cerium, titanium, cobalt, copper, nickel, vanadium, chromium, and combinations thereof.

Aspect 38. The natively colored glass housing of aspect 37, wherein the multi-valent colorant is chromium.

Aspects 39. The natively colored glass housing of any one of aspects 26-38, wherein the glass article comprises, as a mol % of the glass article:
from about 50 mol % to about 75 mol % SiO₂;
from about 7 mol % to about 20 mol % Al₂O₃;
from about 10 mol % to about 20 mol % of at least one alkali metal oxide, alkali metal oxides including Li₂O, Na₂O, and K₂O;
from 0.001 mol % to about 1 mol % of the multi-valent colorant; and
at least one of B₂O₃ or P₂O₅.

Aspect 40. The natively colored glass housing of any one of aspects 26-38, wherein the glass article comprises, as a mol % of the glass article:
from 60 mol % to 65 mol % SiO₂;
from 12 mol % to 17 mol % Al₂O₃;
from 3 mol % to 6 mol % B₂O₃;
from 10 mol % to 16 mol % of at least one alkali metal oxide, alkali metal oxides including Li₂O, Na₂O, and K₂O;
from 3 mol % to 5 mol % CaO;
from 0 mol % to 1 mol % ZrO₂;
from 0 mol % to 0.25 mol % SnO₂; and
from 0.005 mol % to about 0.2 mol % of the multi-valent colorant.

Aspect 41. The natively colored glass housing of any one of aspects 26-40, wherein the glass article comprises at least one crystalline phase.

Aspect 42. The natively colored glass housing of aspect 41, wherein a crystallinity of the glass article is 10 wt % or less.

Aspect 43. The natively colored glass housing of any one of aspects 26-42, further comprising a first compressive stress region extending to a first depth of compression from the first compressive stress region.

Aspect 44. The natively colored glass housing of aspect 43, wherein a maximum compressive stress of the first compressive stress region is about 400 MegaPascals or more.

Aspect 45. The natively colored glass housing of any one of aspects 26-44, wherein the glass article comprises a dielectric constant at frequencies from 10 GigaHertz to 60 GigaHertz of from about 5.6 to about 6.4.

Aspects 46. The natively colored glass housing of any one of aspects 26-45, wherein the glass article exhibits a fracture toughness of 0.60 MPam^{1/2} or more, and a Young's modulus from about 50 GigaPascals to about 100 GigaPascals.

Aspect 47. The natively colored glass housing of any one of aspects 26-46, further comprising:
circuitry comprising an antenna that transmits signals within a range of 26 GHz to 40 GHz;
the natively colored glass housing at least partially surrounding the circuitry; and
a structure formed as an integral portion of the glass article, wherein the structure comprises a perimeter demarcating a second thickness of the structure that differs from the thickness of the glass article by at least 150 μm,
wherein the antenna is positioned and oriented such that the signals are transmitted through the structure of the glass sheet of the panel of the housing.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### BRIEF DESCRIPTION OF THE DRAWINGS

The above and other features and advantages of aspects of the present disclosure are better understood when the following detailed description is read with reference to the accompanying drawings, in which:

FIG. 1 is a schematic plan view of an example consumer electronic device according to aspects of the disclosure;

FIG. 2 is a schematic perspective view of the example consumer electronic device of FIG. 1;

FIG. 3 is a conceptual diagram from a back view of a communicating device, more specifically of a cellular phone, according to an aspect of the disclosure;

FIG. 4 is a simplified conceptual view of the device of FIG. 3 in a slightly exploded cross-section taken along line 4-4 of FIG. 3;

FIG. 4A shows an enlarged view 4A of FIG. 4;

FIG. 4B shows an enlarged view 4B of FIG. 4;

FIG. 5 is a cross-sectional view of a natively colored glass housing including a glass article in accordance with aspects of the disclosure; and

FIG. 6 illustrates a flow chart of methods of making glass articles and/or natively colored glass housings in accordance with aspects of the disclosure;

FIG. 7 illustrates a step in a method of making glass articles and/or natively colored glass housings comprising ion exchange;

FIGS. 8-9 illustrate the results of X-ray photoelectron spectroscopy of chromium-containing raw materials;

FIGS. 10-15 schematically represent cross-sections of glass articles as discussed in the Examples and in accordance with aspects of the disclosure; and

FIG. 16 shows transmission as a function of wavelength for glass articles with various amounts of iron in accordance with aspects of the disclosure.

### DETAILED DESCRIPTION

Aspects will now be described more fully hereinafter with reference to the accompanying drawings in which example aspects are shown. Whenever possible, the same reference numerals are used throughout the drawings to refer to the same or like parts.

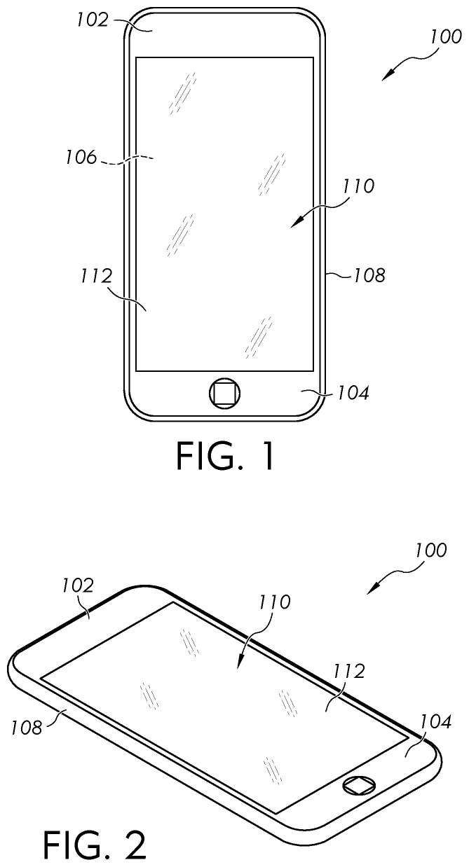

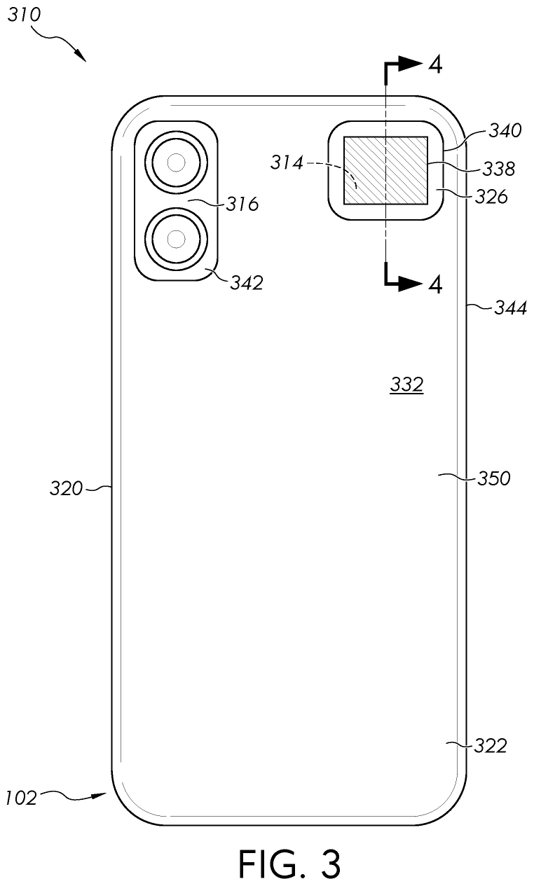

FIGS. 3-5 illustrate views of natively colored glass housings 322 or 500 including glass articles 511 that can be incorporated to consumer electronic products (e.g., display devices), for example, those shown in FIGS. 1-4. Unless otherwise noted, a discussion of features of aspects of one foldable apparatus can apply equally to corresponding features of any aspects of the disclosure. For example, identical part numbers throughout the disclosure can indicate that, in some aspects, the identified features are identical to one another and that the discussion of the identified feature of one aspect, unless otherwise noted, can apply equally to the identified feature of any of the other aspects of the disclosure.

Aspects of the disclosure can comprise a consumer electronic product. The consumer electronic product can comprise a front surface, a back surface, and side surfaces. The consumer electronic product can further comprise electrical components at least partially within the housing. The electrical components can comprise a controller, a memory, and a display. The display can be at or adjacent to the front surface of the housing. The display can comprise liquid crystal display (LCD), an electrophoretic displays (EPD), an organic light-emitting diode (OLED) display, or a plasma display panel (PDP). The consumer electronic product can comprise a cover substrate disposed over the display. In aspects, at least one of a portion of the housing or the cover substrate comprises the foldable apparatus discussed throughout the disclosure. The consumer electronic product can comprise a portable electronic device, for example, a smartphone, a tablet, a wearable device, or a laptop.

The foldable apparatus disclosed herein may be incorporated into another article, for example, an article with a display (or display articles) (e.g., consumer electronics, including mobile phones, tablets, computers, navigation systems, wearable devices (e.g., watches), and the like), architectural articles, transportation articles (e.g., automotive, trains, aircraft, sea craft, etc.), appliance articles, or any article that may benefit from some transparency, scratch-resistance, abrasion resistance or a combination thereof. An exemplary article incorporating any of the foldable apparatus disclosed herein is shown in FIGS. 1-2. Specifically, FIGS. 1-2 show a consumer electronic device 100 including a housing 102 having front 104, back 106, and side surfaces 108. Although not shown, the consumer electronic device can comprise electrical components that are at least partially inside or entirely within the housing. For example, electrical components include at least a controller, a memory, and a display. As shown in FIGS. 1-2, the display 110 can be at or adjacent to the front surface of the housing 102. The consumer electronic device can comprise a cover substrate 112 at or over the front surface of the housing 102 such that it is over the display 110. In aspects, at least a portion of the housing 102 may include the glass article and/or the natively colored glass housing disclosed herein.

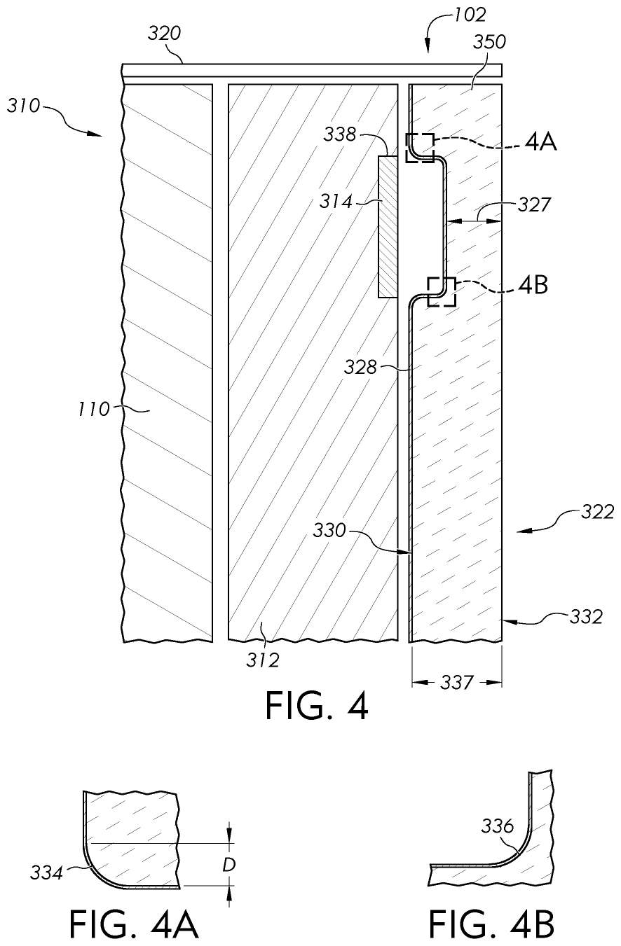

Referring to FIGS. 3-4, a communicating device 310 (i.e., electronic device with wireless signal communication capability; e.g., broadband communicating device, cellular phone, smartphone, control panel, console, dashboard, tablet, handheld computer, electronic tool) includes circuitry 312 (see FIG. 4). The consumer electronic device 100 shown in FIGS. 1-2 is an example of the communicating device 310. In aspects, the circuitry 312 includes an antenna 314. The circuitry 312 may further include other components, for example a camera 316 (FIG. 3), printed circuit board, processor, memory, display 110 (FIG. 3), battery, connector port, and other componentry.

In aspects, the antenna 314 can comprise a patterned metal wire or layer, or other such device (e.g., transceiver, receiver, transmitter, antenna array, communication module) configured to transmit and/or receive communication signals at or over a frequency range. A surface area of the antenna is defined as an area within a perimeter 338 surrounding the antenna. In further aspects, the surface area of the antenna can be 25 cm² or less, 15 cm² or less, 10 cm² or less, 100 μm² or more, 1 mm² or more, 25 mm² or more, or 100 mm² or more. In further aspects, the antenna 314 can be configured for wireless communication (e.g., transmitting, receiving, operating, and/or otherwise communicating) with transmission of signals at a frequency of 100 MHz or more, 1 GHz or more, 10 GHz or more, 24 GHz or more, 24.25 GHz or more, GHz or more, 26 GHz or more, 28 GHz or more, 100 GHz or less, 60 GHz or less, 50 GHz or less, 47 GHz or less, or 40 GHz or less. For example, the antenna may operate in a frequency range from 26 GHz to 40 GHz or from 60 GHz to 80 GHz. Communication at a frequency greater than 26 GHz may be particularly benefited from the present disclosure because such signals may be more inhibited by transmission through solid materials, and may accordingly be improved greatly by use of a housing 102 incorporating the structure 326 described herein. As such, the antenna 314 can be positioned and/or oriented such that signals are transmitted through the structure 326 (e.g., directly facing the structure 326, the structure 326 may overlay at least a portion of the antenna 314). In further aspects, a minimum distance between the antenna 314 to a portion of the glass article defining the structure 326 can be 5 mm or less, 3 mm or less, 2 mm or less, or 0.6 mm or less. Alternatively, the antenna 314 and the portion of the glass article defining the structure 326 may be in direct contact or separated only by a thickness of the coating 328.

In aspects, as shown in FIGS. 3-4, the communicating device 310 includes a housing 102 enclosing some or all of the circuitry 312. The housing 102 may include a frame 320, for example a metallic (e.g., aluminum, steel) sidewall, a natively colored glass housing 322 (e.g., back), and a display 110 (e.g., see FIGS. 1-2). The housing 102 may include alternative structures as well, for example a panel integral with frame forming a back with sidewalls within which circuitry 312 and other components may be located, and/or such as having the housing 102 integrated with a keyboard, touch panel, or other features in addition to or instead of the display.

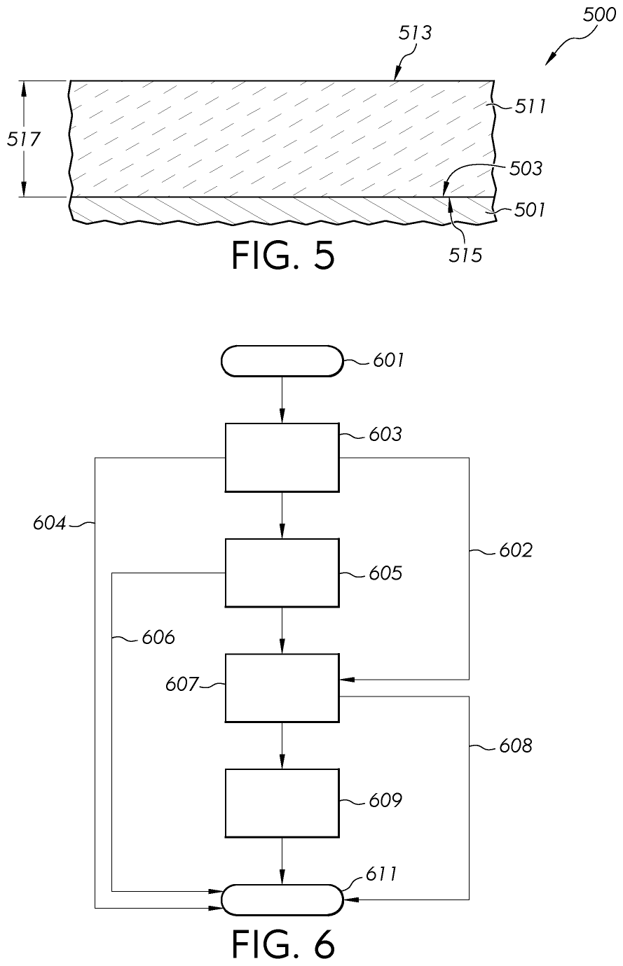

In aspects, as shown in FIGS. 3-4, the natively colored glass housing 322 may comprise (e.g., include, mostly consist of by weight or volume, be) a glass article 350. The glass article 350 may be flat, may have curved edges, may be bowed, or otherwise. As shown in FIG. 4, The natively colored glass housing 322 may include layer(s) 328, for example a scratch-resistant coating, an anti-reflective, or other coatings on a surface of the glass article 350 (e.g., first major surface 332, second major surface 330 of the glass article 350), and may further include decorative ink and/or other layers on a surface thereof as well. For example, the coating 328 on the second major surface 330 of the glass article can comprise any of the aspects and/or be the same as the reflector 501 discussed below with reference to FIG. 5. Conceivably, although not shown, the natively colored glass housing may simply consist of a sheet of glass, where layers, coatings, etc. are unneeded for the corresponding device.

In aspects, as shown in FIG. 4, the glass article 350 includes a structure 326. The structure 326 may be an integral portion of the glass article 350 such that glass of the glass article 350 continuously extends throughout the glass article 350, including defining the structure 326. For example, the structure 326 may be a recess, trench, bump, plateau, or other feature formed in or on the glass article 350. The glass article 350 may have more than one such structure 326. Such a structure may be formed in many conceivable ways, for example, by etching away a portion of the glass article 350, milling away a portion of the glass article 350, pressing the glass of the glass article 350 in a mold, welding additional glass onto the glass article 350. As such, glass forming the structure 326 may have the same composition as the glass of the glass article 350 outside of the structure 326. The glass of the structure 326 may also share a common microstructure with the glass of the glass article 350 outside of the structure 326, such as having the same types and distributions of crystals, for example if the glass is a glass-ceramic, and/or the same types and distributions of colorants. In aspects, as shown in FIG. 4, the structure 326 is formed as a recess relative to a major surface (e.g., second major surface 330) of the glass article 350. As used herein, the “major surfaces” of the glass article 350 sheet are sides of the sheet having the most surface area (e.g., front and back sides). A major surface may be surrounded by edges of a sheet that extend between the major surfaces. For a more complex body, major surfaces may be surfaces thereof have areas defined by perimeters of edges, where the major surfaces have surface areas substantially greater than other surfaces of the body (e.g., sidewalls), for example at least 50% greater.

In aspects, as shown in FIG. 4, the glass article 350 comprises a thickness 337, which is defined as an average distance between the second major surface 330 and the first major surface 332 opposite the first major surface excluding any portion of the glass article 350 including the structure 326 descried above. In further aspects, the thickness 337 can be within one or more of the ranges discussed below for the thickness 517 with reference to FIG. 5. In further aspects, the thickness 337 can be substantially uniform across the second major surface 330 and/or more than 50% of the glass article can comprise a local thickness within 10% of the thickness 337.

In aspects, as shown in FIGS. 3-4, the structure 326 comprises a perimeter 340 on a major surface (e.g., second major surface 330) of the glass article 350, where the perimeter 340 demarcates a second thickness 327 of the structure 326 that differs from the thickness 337, for example, by 50 μm or more, by 100 μm or more, by 150 μm or more, by 200 μm or more, by 300 μm or more, by 500 μm or more (e.g., located at corner 336 as shown in FIG. 4B). For example, the second thickness 327 of the structure 326 may be 600 μm or less, 500 μm or less, or 400 μm or less, while the thickness 337 of the glass article 350 may be 600 μm or more, 700 μm or more, 800 μm or more (or any of the ranges described herein for the thickness 517). Alternatively, although not shown, the second thickness 327 may be greater than the thickness 337 by 50 μm or more, by 100 μm or more, by 150 μm or more, by 200 μm or more, by 300 μm or more, by 500 μm or more. As shown in FIGS. 3-4, the perimeter 340 forms a closed loop on the major surface (e.g., second major surface 330), where a shape of the perimeter 340 may be rectilinear, curved, or curvilinear and can comprise any shape (e.g., square, blocky, ziggurat-shaped with rectangular rows of diminishing length overlaying one another, triangular, oval, or even more complex geometries). For example, the perimeter 340 of the structure 326 may be shaped as a silhouette of a logo and/or registered trademark or other recognizable design or shape. As used herein, a surface area of the structure is defined as the surface area within the perimeter of the structure projected onto the first major surface of the glass article. In aspects, a surface area of the structure 326 may be 100 cm² or less, 50 cm² or less, 25 cm² or less, 25 μm² or more, 100 μm² or more, 1 mm² or more, 25 mm² or more, or 4 cm² or more. In aspects, the glass article can comprise a housing of a communicating device and the glass article may have more than one such structure, as shown in FIG. 3, where the structure 326 overlays the antenna 314 while another structure 342 forms a portion of a camera or sensor encasement (e.g., camera 316). In further aspects, the structure 326 and/or 342 can overlay at least a portion and/or all of the surface area corresponding to the antenna 314 and/or the camera 316.

Forming the structure 326 and/or 342 in a middle or interior portion of the glass article 350, spaced inward from outside edges 344 of the glass article 350 (see, FIG. 3) may help mitigate structural weaknesses or stress concentrations of the glass article 350 that may be associated forming the structure 326 and/or 342. Forming edges or corners 334 and/or 336 (see FIGS. 4A-4B) or the perimeter 340 of the structure 326 with a geometry that reduces concentration of stress at the edges or corners 334 and/or 336 may also help strengthen the glass article 350 when forming the structure 326. Such a geometry may include rounding or dulling vertices or corners 334 and/or 336 of the structure 326, as may be done through etching or localized melting/heating (e.g., with a laser). For example, the glass article 350 may smoothly transition between the thickness 337 and the second thickness 327 at corner 334 and/or 336 over a distance “D” (see FIG. 4A) from about 5 μm to 700 μm, from about 10 μm to about 500 μm, from about 20 μm to about 500 μm, from about 100 μm to about 500 μm, or any range or subrange therebetween, as measured in a direction perpendicular to a direction of the thickness 337.

Throughout the disclosure, CIE color coordinates are with reference to the CIELAB 1976 color space established by the International Commission on Illumination (CIE). Unless otherwise indicated, CIE color coordinates are measured in transmission through the glass article using an F02 illuminant and an observer angle of 10°. The CIELAB 1976 color space expresses color as three values: L* for the lightness from black (0) to white (100), a* from green (−) to red (+), and b* from blue (−) to yellow (+).

FIG. 5 illustrates a natively colored glass housing 500 comprising the glass article 511 and the reflector 501. In aspects, the reflector 501 comprises an opaque material. As used herein, opaque means than an average transmittance in the wavelength range of 400 nm to 700 nm through a 1.0 mm thick piece of a material is 10% or less. The average transmittance in the wavelength range of 400 nm to 700 nm is calculated by measuring the transmittance of whole number wavelengths from about 400 nm to about 700 nm and averaging the measurements. In aspects, the reflector comprises a CIE L* value of about 70 or more. An exemplary material for the reflector is aluminum. In aspects, as shown in FIG. 5, the glass article 511 can be disposed on and/or contact a surface 503 of the reflector 501 can contact the glass article 511. Providing the reflector can increase a perceived brightness of the glass article.

Unless otherwise indicated, transmittance data (total transmittance and diffuse transmittance) in the visible spectrum is measured with a Lambda 950 UV/Vis/NIR Spectrophotometer manufactured by PerkinElmer Inc. (Waltham, Massachusetts USA). The Lambda 950 apparatus was fitted with a 150 mm integrating sphere. Data was collected using an open beam baseline and a Spectralon® reference reflectance disk. For total transmittance (Total Tx), the sample is fixed at the integrating sphere entry point. The term “average transmittance,” as used herein with respect to the visible spectrum, refers to the average of transmittance measurements made within a given wavelength range with each whole numbered wavelength weighted equally. Unless otherwise indicated, as described herein, the “average transmittance” with respect to the visible spectrum is reported over the wavelength range from 380 nm to 750 nm (inclusive of endpoints). Unless otherwise specified, the average transmittance is indicated for article thicknesses from 0.4 mm to 5 mm, inclusive of endpoints. Unless otherwise specified, when average transmittance is indicated, this means that each thickness within the range of thicknesses from 0.4 mm to 5 mm has an average transmittance as specified. For example, colored glass articles having average transmittances of 10% to 92% over the wavelength range from 380 nm to 750 nm means that each thickness within the range of 0.4 mm to 5 mm (e.g., 0.6 mm, 0.9 mm, 2 mm, etc.) has an average transmittance in the range of 10% to 92% for the wavelength range from 380 nm to 750 nm.

As used herein, if a first layer and/or component is described as “disposed over” a second layer and/or component, other layers may or may not be present between the first layer and/or component and the second layer and/or component. Furthermore, as used herein, “disposed over” does not refer to a relative position with reference to gravity. For example, a first layer and/or component can be considered “disposed over” a second layer and/or component, for example, when the first layer and/or component is positioned underneath, above, or to one side of a second layer and/or component. As used herein, a first layer and/or component described as “bonded to” a second layer and/or component means that the layers and/or components are bonded to each other, either by direct contact and/or bonding between the two layers and/or components or via an adhesive layer. As used herein, a first layer and/or component described as “contacting” or “in contact with” a second layer and/or components refers to direct contact and includes the situations where the layers and/or components are bonded to each other.

As shown in FIG. 5, the glass article 511 comprises a first major surface 513 and a second major surface 515 opposite the first major surface 513. In aspects, as shown, the first major surface 513 and/or the second major surface 515 can comprise planar surfaces, although other shapes and designs are possible in other aspects. A thickness 517 of the glass article 511 is defined as an average distance between the first major surface 513 and the second major surface 515. In aspects, the thickness 517 can be about 30 micrometers (μm) or more, about 50 μm or more, about 80 μm or more, about 100 μm or more, about 150 μm or more, about 200 μm or more, about 400 μm or more, about 500 μm or more, about 600 μm or more, about 5 millimeters (mm) or less, about 3 mm or less, about 2 mm or less, about 1 mm or less, about 800 μm or less, about 700 μm or less, about 600 μm or less, about 550 μm or less, about 500 μm or less, or about 300 μm or less. In aspects, the thickness 517 can be in a range from about 30 μm to about 5 mm, from about 50 μm to about 5 mm, from about 80 μm to about 5 mm, from about 100 μm to about 5 mm, from about 200 μm to about 5 mm, from about 400 μm to about 3 mm, from about 500 μm to about 2 mm, from about 600 μm to about 1 mm, or any range or subrange therebetween.

The glass article 511 and/or 350 comprises a glass-based material. In aspects, the glass-based material can comprise a pencil hardness of 8H or more, for example, 9H or more. As used herein, pencil hardness is measured using ASTM D 3363-20 with standard lead graded pencils. Throughout the disclosure, an elastic modulus (e.g., Young's modulus) and/or a Poisson's ratio is measured using ISO 527-1:2019. In aspects, the glass article 511 and/or 350 can comprise an elastic modulus in a range from about 40 GPa to about 140 GPa, from about 50 GPa to about 100 GPa, from about 60 GPa to about 80 GPa, or any range or subrange therebetween.

As used herein, “glass-based” includes both glasses and glass-ceramics, wherein glass-ceramics have one or more crystalline phases and an amorphous, residual glass phase. A glass-based material may comprise an amorphous material (e.g., glass) and optionally one or more crystalline materials (e.g., ceramic). Amorphous materials and glass-based materials may be strengthened. As used herein, the term “strengthened” may refer to a material that has been chemically strengthened, for example, through ion exchange of larger ions for smaller ions in the surface of the glass article, as discussed below. However, other strengthening methods, for example, thermal tempering, or utilizing a mismatch of the coefficient of thermal expansion between portions of the glass article to create compressive stress and central tension regions, may be utilized to form strengthened glass articles. Exemplary glass-based materials, which may be free of lithia or not, comprise soda lime glass, alkali aluminosilicate glass, alkali-containing borosilicate glass, alkali-containing aluminoborosilicate glass, alkali-containing phosphosilicate glass, and alkali-containing aluminophosphosilicate glass. In aspects, glass-based material can comprise an alkali-containing glass or an alkali-free glass, either of which may be free of lithia or not. In aspects, the glass material can be alkali-free and/or comprise a low content of alkali metals (e.g., R₂O of about 10 mol % or less, wherein R₂O comprises Li₂O Na₂O, K₂O, or the more expansive list provided below). In one or more aspects, a glass-based material may comprise, in mole percent (mol %): SiO₂ in a range from about 40 mol % to about 80 mol %, Al₂O₃ in a range from about 5 mol % to about 30 mol %, B₂O₃ in a range from 0 mol % to about 10 mol %, ZrO₂ in a range from 0 mol % to about 5 mol %, P₂O₅ in a range from 0 mol % to about 15 mol %, TiO₂ in a range from 0 mol % to about 2 mol %, R₂O in a range from 0 mol % to about 20 mol %, and RO in a range from 0 mol % to about 15 mol %. As used herein, R₂O can refer to an alkali-metal oxide, including Li₂O, Na₂O, and K₂O. As used herein, RO can refer to MgO, CaO, SrO, BaO, and ZnO. In further aspects, the glass-based material may comprise (in mol %) from about 50 mol % to about 75 mol % SiO₂, from about 7 mol % to about 20 mol % Al₂O₃, from about 10 mol % to about 20 mol % of at least one alkali metal oxide (R₂O), from 0.001 mol % to about 1 mol % of a multi-valent colorant, and at least one of B₂O₃ or P₂O₅. In further aspects, the glass-based material may comprise (in mol %) from 60 mol % to 65 mol % SiO₂, from 12 mol % to 17 mol % Al₂O₃, from 3 mol % to 6 mol % B₂O₃, from 10 mol % to 16 mol % of at least one alkali metal oxide (R₂O), from 3 mol % to 5 mol % CaO, from 0 mol % to 1 mol % ZrO₂, from 0 mol % to 0.25 mol % SnO₂, and from 0.005 mol % to about 0.2 mol % of the multi-valent colorant. In aspects, a glass-based material may optionally further comprise in a range from 0 mol % to about 2 mol % of each of Na₂SO₄, NaCl, NaF, NaBr, K₂SO₄, KCl, KF, KBr, As₂O₃, Sb₂O₃, SnO₂, Fe₂O₃, MnO, MnO₂, MnO₃, Mn₂O₃, Mn₃O₄, Mn₂O₇. In aspects, the glass-based material can comprise an iron oxide, titanium dioxide, an antimony oxide, a cobalt oxide, a cerium oxide, and/or a chromium oxide. In aspects, the glass-based material can comprise a multi-valent colorant selected from a group consisting of chromium, cobalt, cerium, titanium, copper, nickel, vanadium, or combinations thereof. In further aspects, the glass-based material can comprise from 200 parts-per-million (ppm) to about 5,000 ppm of chromium.

Unless otherwise indicated, compositions are specified in mole percent (mol %). The terms “0 mol %” and “free,” when used to describe the concentration and/or absence of a particular constituent component in a glass composition, means that the constituent component is not present in the glass composition. The term “substantially free,” when used to describe the concentration and/or absence of a particular constituent component in a glass composition and the resultant colored glass article, means that the constituent component is not intentionally added to the glass composition and the resultant colored glass article. However, the glass composition and the resultant colored glass article may contain traces of the constituent component as a contaminant or tramp in amounts of less than 200 ppm unless specified otherwise herein. It is noted that the definition of “substantially free” is exclusive of gold (Au) which may be intentionally added to the glass composition in relatively small amounts, for example and without limitation, amounts less than 200 ppm (or the equivalent in mol %) to achieve a desired color in the resultant colored glass article.

“Glass-ceramics” include materials produced through controlled crystallization of glass. In aspects, glass-ceramics have about 1% to about 99% crystallinity. Examples of suitable glass-ceramics may include Li₂O—Al₂O₃—SiO₂ system (i.e., LAS-System) glass-ceramics, MgO—Al₂O₃—SiO₂ system (i.e., MAS-System) glass-ceramics, ZnO×Al₂O₃×nSiO₂ (i.e., ZAS system), and/or glass-ceramics that include a predominant crystal phase including β-quartz solid solution β-spodumene, cordierite, petalite, and/or lithium disilicate. The glass-ceramic materials may be strengthened using the chemical strengthening processes. In one or more aspects, MAS-System glass-ceramic materials may be strengthened in Li₂SO₄ molten salt, whereby an exchange of 2Li⁺ for Mg²⁺ can occur. In aspects, the glass article 511 and/or 350 can be a glass-ceramic comprising one or more crystalline phases. In further aspects, a total amount of the one or more crystalline phases, as a weight % (wt %) of the glass article 511 and/or 350, can be about 10 wt % or less, about 8 wt % or less, about 6 wt % or less, about 4 wt % or less, about 4 wt % or less, about 2 wt % or less, about 1 wt % or less, about 0.1 wt % or more, about 0.5 wt % or more, or about 1 wt % or more.

As used herein, a multi-valent colorant comprises at least two oxidation states where the oxidation state of the colorant is non-zero and two or more of the at least two oxidation states exhibit a color, as measured by absorbance from 400 nm to 750 nm or CIE a* and/or b* values. For example, chromium is a multi-valent colorant because chromium can exist as Cr³⁺ and Cr⁶⁺, where Cr³⁺ is associated with a green color and Cr⁶⁺ can be associated with a yellow color. Likewise, cerium is a multi-valent colorant because cerium can exist as Ce⁴⁺ and Ce³⁺, where Ce⁴⁺ is associated with a yellow color and Ce³⁺ is associated with a red color. Likewise, titanium is a multi-valent colorant because titanium can exist as Ti²⁺ and Ti⁴⁺, where Ti²⁺ is associated with a purple color and Ti⁴⁺ is associated with a white color or maybe colorless. Likewise, copper is a multi-valent colorant because copper can exist as Cu¹⁺ and Cu²⁺, where Cu¹⁺ is associated with a green color and Cu²⁺ is associated with a blue color. Likewise, nickel is a multi-valent colorant because nickel can exist as Ni²⁺ and Ni³⁺, where Ni²⁺ is associated with yellow color and Ni³⁺ is associated with purple color. Likewise, vanadium is a multi-valent colorant because vanadium can exist as V⁴⁺ and V⁵⁺, where V⁴⁺ is associated with a green color and V⁵⁺ is associated with a blue color. However, “multi-valent colorants” of the present disclosure do not include iron. While iron can be included in colorant packages of glasses of the present disclosure, the colorant package will further include a multi-valent colorant.

The glass articles described herein may be described as aluminoborosilicate glass compositions and colored glass articles and comprise SiO₂, Al₂O₃, and B₂O₃. Additionally, the glass articles described herein include one or more colorants in a colorant package to impart a desired color to the resultant colored glass article. The glass articles described herein also include alkali oxides (e.g., Li₂O and Na₂O) to enable the ion-exchangeability of the colored glass articles. In aspects, the glass articles described herein may further include other components to improve colorant retention and produce colored glass articles having the desired color. In aspects, the difference between R₂O and Al₂O₃ (i.e. R₂O (mol %)—Al₂O₃ (mol %)) in the glass articles described herein may be adjusted to produce a desired observable color (e.g., pink, purple, red, orange, or blue). In aspects, the viscosity of the glass composition may be adjusted to prevent devitrification of the glass composition.

SiO₂ is the primary glass former in the glass articles described herein and may function to stabilize the network structure of the colored glass articles. The concentration of SiO₂ in the glass articles should be sufficiently high (e.g., 40 mol % or more) to enhance the chemical durability of the glass composition and, in particular, the resistance of the glass composition to degradation upon exposure to acidic solutions, basic solutions, and in water. The amount of SiO₂ may be limited (e.g., 80 mol % or less) to control the melting point of the glass composition, as the melting point of pure SiO₂ or high SiO₂ glasses is undesirably high. Thus, limiting the concentration of SiO₂ may aid in improving the meltability and the formability of the resultant colored glass article. In aspects, the glass article may comprise from 40 mol % to 80 mol % SiO₂ or from 50 mol % to 80 mol % SiO₂. In aspects, the glass article may comprise from about 45 mol % to about 67 mol % SiO₂ or from 53 mol % to 67 mol % SiO₂. In aspects, the concentration of SiO₂ in the glass article may be 40 mol % or more, 45 mol % or more, 50 mol % or more, 52 mol % or more, 53 mol % or more, 54 mol % or more, 55 mol % or more, 56 mol % or more, 57 mol % or more, 58 mol % or more, 60 mol % or more, 80 mol % or less, 75 mol % or less, 73 mol % or less, 71 mol % or less 70 mol % or less, 68 mol % or less, 67 mol % or less, 66 mol % or less, 65 mol % or less 64 mol % or less, 63 mol % or less, 62 mol % or less, 61 mol % or less, 60 mol % or less, or 59 mol % or less. In aspects, the concentration of SiO₂ in the glass article may be from 40 mol % to 70 mol %, 45 mol % to 70 mol %, from 50 mol % to about 68 mol %, from about 52 mol % to about 68 mol %, from about 53 mol % to about 67 mol %, from about 54 mol % to about 67 mol %, from about 55 mol % to about 66 mol %, from about 56 mol % to about 65 mol %, from about 57 mol % to about 65 mol %, from about 58 mol % to about 65 mol %, from about 60 mol % to about 65 mol %, from about 60 mol % to about 64 mol %, from about 60 mol % to about 63 mol %, from about 60 mol % to about 62 mol %, or any range or subrange therebetween.

Like SiO₂, Al₂O₃ may also stabilize the glass network and additionally provides improved mechanical properties and chemical durability to the glass article. The amount of Al₂O₃ may also be tailored to control the viscosity of the glass composition. Al₂O₃ may be included such that the resultant glass article has the desired fracture toughness (e.g., greater than or equal to 0.7 MPa·m^{1/2}). However, if the amount of Al₂O₃ is too high (e.g., 25 mol % or more), the viscosity of the glass melt may increase, thereby diminishing the formability of the glass article. In aspects, if the amount of Al₂O₃ is too high, the solubility of one or more colorants of the colorant package in the glass melt may decrease, resulting in the formation of undesirable crystal phases in the glass. For example and without limitation, when the colorant package includes Cr₂O₃, the solubility of Cr₂O₃ in the glass melt may decrease with increasing Al₂O₃ concentrations (e.g., concentrations greater than or equal to 17.5 mol %), leading to the precipitation of undesirable crystal phases. Without wishing to be bound by theory, it is hypothesized that similar behavior may occur with colorants other than Cr₂O₃. Accordingly, in aspects, the glass com article may comprise from 7 mol % to 25 mol % Al₂O₃, from 7 mol % to 20 mol % Al₂O₃, or from 8 mol % to 20 mol % Al₂O₃. In aspects, the glass article may comprise from 10 mol % to 20 mol % Al₂O₃, from 10 mol % to about 17.5 mol % Al₂O₃, or from 12 mol % to about 17.25 mol % Al₂O₃. In aspects, the glass article may comprise from 11 mol % to 19 mol % Al₂O₃ or from 14 mol % to 17 mol % Al₂O₃. In aspects, the concentration of Al₂O₃ in the glass article may be 7 mol % or more, 8 mol % or more, 9 mol % or more, 10 mol % or more, 11 mol % or more 12 mol % or more, 12.5 mol % or more, 13 mol % or more, 13.5 mol % or more, 14 mol % or more, 14.5 mol % or more, 15 mol % or more, 15.5 mol % or more, 16 mol % or more, 25 mol % or less, 23 mol % or less, 20 mol % or less, 19 mol % or less, 18 mol % or less, 17.5 mol % or less, 17.25 mol % or less, 17 mol % or less, 16.75 mol % or less, or 16 mol % or less. In aspects, the concentration of Al₂O₃ in the glass article may be from 7 mol % to 25 mol %, from 7 mol % to 23 mol %, from 8 mol % to 20 mol %, from 9 mol % to 19 mol %, from 10 mol % to 18 mol %, from 11 mol % to 17.5 mol %, from 12 mol % to 17.25 mol %, from 13 mol % to 17 mol %, from 14 mol % to 16.75 mol %, from 14.5 mol % to 16 mol %, or any range or subrange therebetween.

B₂O₃ decreases the melting point of the glass composition, which may improve retention of certain colorants in the glass, for example and without limitation, Au. B₂O₃ may also improve the damage resistance of the resultant colored glass article. In addition, B₂O₃ may be added to reduce the formation of non-bridging oxygen, the presence of which may reduce fracture toughness. The concentration of B₂O₃ should be sufficiently high (e.g., 1 mol % or more) to reduce the melting point of the glass composition, improve the formability, and increase the fracture toughness of the colored glass article. However, if B₂O₃ is too high (e.g., 15 mol % or more), the annealing point and strain point may decrease, which increases stress relaxation and reduces the overall strength of the colored glass article. In aspects, the glass article may comprise from 1 mol % to 15 mol % B₂O₃, from 1 mol % to 10 mol % B₂O₃, from 3 mol % to 10 mol % B₂O₃, or from 3.5 mol % to 9 mol % B₂O₃. In aspects, the glass article may comprise from 2 mol % to 12 mol % B₂O₃ or from 2 mol % to 8 mol % B₂O₃. In aspects, the concentration of B₂O₃ in the glass article may be 1 mol % or more, 2 mol % or more, 3 mol % or more, 3.5 mol % or more, 4 mol % or more, 4.5 mol % or more, 5 mol % or more, 5.5 mol % or more, 15 mol % or less, 12 mol % or less, 10 mol % or less, 9 mol % or less, 8 mol % or less, 7.5 mol % or less, 7 mol % or less, 6.5 mol % or less, or 6 mol % or less. In aspects, the concentration of B₂O₃ in the glass article may be from 1 mol % to 15 mol %, from 2 mol % to 12 mol %, from 3 mol % to 10 mol %, from 3.5 mol % to 9 mol %, from 4 mol % to 8 mol %, from 4.5 mol % to 7.5 mol %, from 5 mol % to 7 mol %, from 5.5 mol % to 6.5 mol %, or any range or subrange therebetween.

As described hereinabove, the glass articles may contain alkali oxides (e.g., Li₂O, Na₂O, and K₂O) to enable the ion-exchangeability of the glass articles.

Li₂O aids in the ion-exchangeability of the glass article and also reduces the softening point of the glass composition, thereby increasing the formability of the glass articles. The addition of Li₂O facilitates the exchange of both Na⁺ and K⁺ cations into the glass for strengthening the glass and also facilitates producing a relatively high surface compressive stress and relatively deep depth of compression, improving the mechanical characteristics of the resultant colored glass article. In addition, Li₂O decreases the melting point of the glass composition, which may improve retention of colorants in the glass, for example and without limitation, Au. The concentration of Li₂O in the glass articles should be sufficiently high (e.g., 1 mol % or more) to reduce the melting point of the glass composition and achieve the desired maximum central tension (e.g., 40 MPa or more) following ion exchange. However, if the amount of Li₂O is too high (e.g., greater than 20 mol %), the liquidus temperature may increase, thereby diminishing the manufacturability of the colored glass article. In aspects, the glass article may comprise from 1 mol % to 20 mol % Li₂O or from 1 mol % to 20 mol % Li₂O. In aspects, the glass article may comprise from 3 mol % to 18 mol % Li₂O, from 7 mol % to 18 mol % Li₂O, from 8.8 mol % to 14 mol % Li₂O, or from 9 mol % to 13.5 mol % Li₂O. In aspects, the concentration of Li₂O in the glass article may be 1 mol % or more, 3 mol % or more, 5 mol % or more, 7 mol % or more, 7.5 mol % or more, 8 mol % or more, 8.5 mol % or more, 8.8 mol % or more, 9 mol % or more, 9.2 mol % or more, 9.4 mol % or more, 9.6 mol % or more, 9.8 mol % or more, 10 mol % or more, 11 mol % or more, 11.5 mol % or more, 12 mol % or more, 20 mol % or less, 18 mol % or less, 17 mol % or less, 16 mol % or less, 15 mol % or less, 14 mol % or less, 13.5 mol % or less, 13 mol % or less, 12.5 mol % or less, 12 mol % or less, 11.5 mol % or less, or 11 mol % or less. In aspects, the concentration of Li₂O in the glass article may be from 1 mol % to 20 mol %, from 3 mol % to 18 mol %, from 5 mol % to 17 mol %, from 7 mol % to 16 mol %, from 7.5 mol % to 15 mol %, from 8 mol % to 14 mol %, from 8.5 mol % to 13.5 mol %, from 8.8 mol % to 13 mol %, from 9 mol % to 12.5 mol %, from 9.2 mol % to 12.5 mol %, from 9.4 mol % to 12 mol %, from 9.6 mol % to 12 mol %, from 9.8 mol % to 11.5 mol %, from 10 mol % to 11 mol %, or any range or subrange therebetween.

Na₂O improves diffusivity of alkali ions in the glass and thereby reduces ion-exchange time and helps achieve the desired surface compressive stress (e.g., 300 MPa or more). The addition of Na₂O also facilitates the exchange of K⁺ cations into the glass for strengthening and improving the mechanical characteristics of the resultant colored glass article. Na₂O also improves the formability of the colored glass article. In addition, Na₂O decreases the melting point of the glass composition, which may improve retention of certain colorants in the glass, for example, Au. However, if too much Na₂O is added to the glass composition, the melting point may be too low. In aspects, the concentration of Li₂O present in the glass article may be greater than the concentration of Na₂O present in the glass article. In aspects, the glass article may comprise greater than 0 mol %, from 0.01 mol % to 15 mol % Na₂O, from 0.5 mol % to 15 mol % Na₂O, or from 1 mol % to 15 mol % Na₂O. In aspects, the glass article may comprise from 1 mol % to 12 mol % Na₂O or from 2 mol % to 10 mol % Na₂O. In aspects, the glass article may comprise from 0.01 mol % to 4 mol % Na₂O. In aspects, the glass article may comprise from 1.5 mol % to 8 mol % Na₂O or from 2 mol % to 7.5 mol % Na₂O. In aspects, the concentration of Na₂O in the glass article may be greater than 0 mol %, 0.01 mol % or more, 0.5 mol % or more, 1 mol % or more, 1.5 mol % or more, 2 mol % or more, 2.5 mol % or more, 3 mol % or more, 3.5 mol % or more, 4 mol % or more, 4.5 mol % or more, 15 mol % or less, 12 mol % or less, 10 mol % or less, 9 mol % or less, 8.5 mol % or less, 8 mol % or less, 7.5 mol % or less, 7 mol % or less, 6.5 mol % or less, 6 mol % or less, 5.5 mol % or less, 5 mol % or less, 4.5 mol % or less, or 4 mol % or less. In aspects, the concentration of Na₂O in the glass article may be from greater than 0 mol % to 15 mol %, from 0.01 mol % to 12 mol %, from 0.5 mol % to 12 mol %, from 1 mol % to 10 mol %, from 1.5 mol % to 9 mol %, from 2 mol % to 8.5 mol %, from 2.5 mol % to 8 mol %, from 3 mol % to 7.5 mol %, from 3.5 mol % to 7 mol %, from 4 mol % to 6.5 mol %, from 4.5 mol % to 6 mol %, or any range or subrange therebetween In aspects, the concentration of Na₂O in the glass article may be from 0.5 mol % to 10 mol %, from 1 mol % to 9 mol %, from 1 mol % to 8 mol %, from 1 mol % to 7 mol %, from 1 mol % to 6.5 mol %, from 1 mol % to 6 mol %, from 1 mol % to 5.5 mol %, from 1 mol % to 5 mol %, from 1.5 mol % to 4.5 mol %, from 2 mol % to 4 mol %, or any range or subrange therebetween.

K₂O, when included, promotes ion-exchange and may increase the depth of compression and decrease the melting point to improve the formability of the colored glass article. However, adding too much K₂O may cause the surface compressive stress and melting point to be too low. Accordingly, in aspects, the amount of K₂O added to the glass composition may be limited. In aspects, the glass article may optionally comprise from greater than 0 mol % to 3 mol % K₂O, from greater than 0 mol % to 1 mol % K₂O, from 0.01 mol % to 1 mol % K₂O, or from 0.1 mol % to 1 mol % K₂O. In aspects, the glass article may optionally comprise from 0.1 mol % to 0.5 mol % K₂O. In aspects, the concentration of K₂O in the glass article may be greater than 0 mol %, 0.01 mol % or more, 0.1 mol % or more, 0.2 mol % or more, 0.25 mol % or more, 0.3 mol % or more, 0.4 mol % or more, 0.5 mol % or more, 3 mol % or less, 2.5 mol % or less, 2 mol % or less, 1.5 mol % or less, 1 mol % or less, 0.75 mol % or less, 0.5 mol % or less, or 0.25 mol % or less. In aspects, the concentration of K₂O in the glass article may be from greater 0 mol % to 3 mol %, from 0.01 mol % to 2.5 mol %, from 0.1 mol % to 2 mol %, from 0.2 mol % to 1.5 mol %, from 0.25 mol % to 1 mol %, from 0.3 mol % to 0.75 mol %, from 0.4 mol % to 0.5 mol %, or any range or subrange therebetween.

R₂O, as used herein, is the sum (in mol %) of Li₂O, Na₂O, and K₂O present in the glass article (i.e., R₂O═Li₂O (mol %)+Na₂O (mol %)+K₂O (mol %). Like B₂O₃, the alkali oxides aid in decreasing the softening point and molding temperature of the glass composition, thereby offsetting the increase in the softening point and molding temperature of the glass composition due to higher amounts of SiO₂ in the glass composition, for example. The softening point and molding temperature may be further reduced by including combinations of alkali oxides (e.g., two or more alkali oxides) in the glass composition, a phenomenon referred to as the “mixed alkali effect.” However, it has been found that if the amount of alkali oxide is too high, the average coefficient of thermal expansion of the glass composition increases to greater than 100×10⁻⁷/° C., which may be undesirable. In aspects, the concentration of R₂O in the glass article can be from 1 mol % to 35 mol %, from 6 mol % to 25 mol %, or from 8 mol % to 23 mol %. In aspects, the concentration of R₂O in the glass article can be 2 mol % or more, 4 mol % or more, 6 mol % or more, 8 mol % or more, 10 mol % or more, 10.3 mol % or more, 11 mol % or more, 12 mol % or more 13 mol % or more, 14 mol % or more, 35 mol % or less, 30 mol % or less, 25 mol % or less, 23 mol % or less, 22 mol % or less, 21 mol % or less, 20 mol % or less, 19 mol % or less, 18 mol % or less, 17 mol % or less, 16 mol % or less, or 15 mol % or less. In aspects, the concentration of R₂O in the glass article can range from 2 mol % to 35 mol %, from 4 mol % to 30 mol %, from 6 mol % to 25 mol %, from 8 mol % to 23 mol %, from 8 mol % to 22 mol %, from 10 mol % to 21 mol %, from 10.3 mol % to 20 mol %, from 11 mol % to 19 mol %, from 12 mol % to 18 mol %, from 13 mol % to 17 mol %, from 14 mol % to 16 mol %, or any range or subrange therebetween.

In aspects, a difference between R₂O and Al₂O₃ (i.e. R₂O (mol %)-Al₂O₃ (mol %)) in the glass article may be adjusted to produce a desired observable color (e.g., pink, purple, red, orange, or blue). The analyzed R₂O—Al₂O₃ of the glass article, along with the added colorant package, may correlate with the observable color of the colored glass article after an optional heat treatment, as discussed herein. In aspects, R₂O—Al₂O₃ in the glass article may be from −5 mol % to 7 mol % or from −3 mol % to 2 mol %. In aspects, R₂O—Al₂O₃ in the glass article may be from −3 mol % to 6 mol % or from −1 mol % to 5 mol %. In aspects, R₂O—Al₂O₃ in the glass article may be from −5 mol % to 1.5 mol % or from −3 mol % to 1.5 mol %. In aspects, R₂O—Al₂O₃ in the glass article may be from 1.5 mol % to 7 mol % or from 1.5 mol % to 5 mol %. In aspects, R₂O—Al₂O₃ in the glass article may be −5 mol % or more, −4 mol % or more, −3 mol % or more, −2.5 mol % or more, −2 mol % or more, −1.5 mol % or more, 0.2 mol % or more, 0.5 mol % or more, 1 mol % or more, 1.5 mol % or more, 2 mol % or more, 7 mol % or less, 6.5 mol % or less, 6 mol % or less, 5.5 mol % or less, 5 mol % or less, 4.5 mol % or less, 4 mol % or less, 3.5 mol % or less, 3 mol % or less, 2.5 mol % or less, 2 mol % or less, 1.5 mol % or less, 1 mol % or less, or 0.5 mol % or less. In aspects, R₂O—Al₂O₃ in the glass article may be from −5 mol % to 7 mol %, from −4 mol % to 6.5 mol %, from −3 mol % to 6 mol %, from −2.5 mol % to 5.5 mol % from −2 mol % to 5 mol %, from −1.5 mol % to 4.5 mol %, from 0.2 mol % to 4 mol %, from 0.5 mol % to 3.5 mol %, from 1 mol % to 3 mol %, from 1.5 mol % to 2.5 mol %, or any range or subrange therebetween.

In aspects, the glass articles described herein further include MgO and/or ZnO to improve retention of colorants in the glass, such as Au or the like, for example, by lowering the melting point of the glass composition. Decreasing the melting point of the glass composition may help improve colorant retention because the glass compositions may be melted at relatively lower temperatures and the evaporation of colorants from the glass, such as gold, may be reduced. Without wishing to be bound by theory, it is also believed that partially replacing Li₂O and/or Na₂O with MgO and/or ZnO may also help improve retention of the colorants. Specifically, Li₂O and/or Na₂O is included in the batch glass composition as lithium carbonate and sodium carbonate, respectively. Upon melting the glass composition, carbonate gas is released from the glass composition. Colorants such as Au escape from the glass composition within the carbonate gas. Therefore, the improved colorant retention may be due to the reduced amount of carbonate. Further, it is believed that MgO and/or ZnO may improve the solubility of some colorants in the glass (e.g., Cr₂O₃), thereby avoiding the formation of undesirable crystal phases (e.g., Cr-spinel crystals) and expanding the color gamut that may be achieved by the resultant colored glass articles. As used herein, “color gamut” refers to the pallet of colors that may be achieved by the colored glass articles within the CIELAB color space. For example, in aspects where the colorant includes Cr₂O₃, the sum of MgO and ZnO present in the glass article (i.e., MgO (mol %)+ZnO (mol %)) may be from greater than 0 mol % to 6 mol % or 4.5 mol % or less. Without wishing to be bound by theory, it is hypothesized that similar behavior may occur with colorants other than Au and Cr₂O₃. In aspects, the sum (in mol %) of MgO and ZnO present in the glass article (i.e., MgO (mol %)+ZnO (mol %)) may be greater than 0 mol %, 0.1 mol % or more, 0.5 mol % or more, 1 mol % or more, 1.5 mol % or more, 2 mol % or more, 2.5 mol % or more, 3 mol % or more, 3.5 mol % or more, 7 mol % or less, 6 mol % or less, 5.5 mol % or less, 5 mol % or less, 4.5 mol % or less, 4.25 mol % or less, or 4 mol % or less. In aspects, the sum of MgO and ZnO in the glass may be from greater than 0 mol % to 8 mol %, from 0.1 mol % to 7 mol %, from 0.1 mol % to 6 mol %, from 0.5 mol % to 6 mol %, from 1 mol % to 5.5 mol %, from 1.5 mol % to 5 mol %, from 2 mol % to 4.5 mol %, from 2.5 mol % to 4.25 mol %, from 3 mol % to 4 mol %, or any range or subrange therebetween.

In addition to improving colorant retention, MgO lowers the viscosity of the glass compositions, which enhances the formability, the strain point, and the Young's modulus, and may improve ion-exchangeability. However, when too much MgO is added to the glass composition, the diffusivity of sodium and potassium ions in the glass composition decreases which, in turn, adversely impacts the ion-exchange performance (i.e., the ability to ion-exchange) of the resultant colored glass article. In aspects, the glass article may comprise from greater than 0 mol % to 8 mol % MgO or from 0 mol % to 4.5 mol % MgO. In aspects, the glass article may comprise from 0.5 mol % to 7 mol % MgO. In aspects, the concentration of MgO in the glass article may be greater than 0 mol %, 0.5 mol % or more, 1 mol % or more, 1.5 mol % or more, 2 mol % or more, 2.5 mol % or more, 8 mol % or less, 7 mol % or less, 6 mol % or less, 5.5 mol % or less, 5 mol % or less, 4.5 mol % or less, 4 mol % or less, 3.5 mol % or less, 3 mol % or less, 2.5 mol % or less, 2 mol % or less, 1.5 mol % or less, or 1 mol % or less. In aspects, the concentration of MgO in the glass article may be from greater than or equal to 0 mol % to 8 mol %, from 0.5 mol % to 7 mol %, from 0.5 mol % to 6 mol %, from 1 mol % to 5.5 mol %, from 1 mol % to 5 mol %, from 1.5 mol % to 4.5 mol %, from 1.5 mol % to 4 mol %, from 2 mol % to 3.5 mol %, from 2.5 mol % to 3 mol %, or any range or subrange therebetween. In aspects, the glass article may be substantially free or free of MgO.

In addition to improving colorant retention, ZnO lowers the viscosity of the glass compositions, which enhances the formability, the strain point, and the Young's modulus, and may improve ion-exchangeability. However, when too much ZnO is added to the glass composition, the diffusivity of sodium and potassium ions in the glass composition decreases which, in turn, adversely impacts the ion-exchange performance (i.e., the ability to ion-exchange) of the resultant colored glass article. In aspects, the glass article may comprise from greater than 0 mol % to 5 mol % ZnO, from greater than 0 mol % to 4.5 mol % ZnO, from 0.1 mol % to 4 mol % ZnO, from 0.25 mol % to 1.25 mol %, or from 0.5 mol % to 1 mol %. In aspects, the concentration of ZnO in the glass article may be greater than 0 mol %, 0.1 mol % or more, 0.25 mol % or more, 0.5 mol % or more, 0.7 mol % or more, 1 mol % or more, 1.5 mol % or more, 2 mol % or more, 5 mol % or less, 4.5 mol % or less, 4 mol % or less, 3.5 mol % or less, 3 mol % or less, 2.5 mol % or less, 2 mol % or less, 1.75 mol % or less, 1.5 mol % or less, 1.25 mol % or less, or 1 mol % or less. In aspects, the concentration of ZnO in the glass composition may be from greater than 0 mol % to 5 mol %, from 0.1 mol % to 4.5 mol %, from 0.25 mol % to 4 mol %, from 0.5 mol % to 3.5 mol %, from 0.75 mol % to 3 mol %, from 1 mol % to 2.5 mol %, from 1.5 mol % to 2 mol %, or any range or subrange therebetween. In aspects, the glass article may be substantially free or free of ZnO.

Like ZnO and the alkaline earth oxide MgO, other alkaline earth oxides, for example CaO, SrO and BaO, decrease the melting point of the glass composition. Accordingly, CaO, SrO, and/or BaO may be included in the glass articles to lower the melting point of the glass composition, which may help improve colorant retention.

In aspects, the glass articles described herein may further comprise CaO. CaO lowers the viscosity of a glass composition, which enhances the formability, the strain point and the Young's modulus, and may improve the ion-exchangeability. However, when too much CaO is added to the glass composition, the diffusivity of sodium and potassium ions in the glass composition decreases which, in turn, adversely impacts the ion-exchange performance (i.e., the ability to ion-exchange) of the resultant glass. In aspects, the concentration of CaO in the glass article may be 0 mol % or more, 0.25 mol % or more, 0.5 mol % or more, 0.75 mol % or more, 1 mol % or more, 7 mol % or less, 6.5 mol % or less, 6 mol % or less, 5.5 mol % or less, 5 mol % or less, 4.5 mol % or less, 4 mol % or less, 3.5 mol % or less, 3 mol % or less, 2.5 mol % or less, 2 mol % or less, 1.75 mol % or less, 1.5 mol % or less, 1.25 mol % or less, or 1 mol % or less. In aspects, the concentration of CaO in the glass article may be from greater than 0 mol % to 7 mol %, from greater than 0 mol % to 6.5 mol %, from 0.25 mol % to 6 mol %, from 0.25 mol % to 5.5 mol %, from 0.25 mol % to 5 mol %, from 0.5 mol % to 4.5 mol %, from 0.5 mol % to 4 mol %, from 0.5 mol % to 3.5 mol %, from 0.75 mol % to 3 mol %, from 0.75 mol % to 2.5 mol %, from 0.75 mol % to 2 mol %, from 1 mol % to 1.75 mol %, from 1 mol % to 1.5 mol %, or any range or subrange therebetween.

In aspects, the concentration of SrO in the glass article may be greater than 0 mol %, 0.25 mol % or more, 0.5 mol % or more, 0.75 mol % or more, 1 mol % or more, 2 mol % or less, 1.75 mol % or less, 1.5 mol % or less, 1.25 mol % or less, or 1 mol % or less. In aspects, the concentration of SrO in the glass article may be from greater than 0 mol % to 2 mol %, from 0.25 mol % to 1.75 mol %, from 0.5 mol % to 1.5 mol %, from 0.75 mol % to 1.25 mol %, from 0.75 mol % to 1 mol %, or any range or subrange therebetween. In aspects, the glass article may be substantially free or free of SrO.

In aspects, the concentration of BaO in the glass article may be greater than 0 mol %, 0.25 mol % or more, 0.5 mol % or more, 0.75 mol % or more, 1 mol % or more, 2 mol % or less, 1.75 mol % or less, 1.5 mol % or less, 1.25 mol % or less, or 1 mol % or less. aspects, the concentration of BaO in the glass article may be from greater than 0 mol % to 2 mol %, from 0.25 mol % to 1.75 mol %, from 0.5 mol % to 1.5 mol %, from 0.75 mol % to 1.25 mol %, from 0.75 mol % to 1 mol %, or any range or subrange therebetween. In aspects, the glass article may be substantially free or free of BaO.

R′O, as used herein, is the sum (in mol %) of MgO, ZnO, CaO, BaO, and SrO (i.e. R′O═MgO (mol %)+ZnO (mol %)+CaO (mol %)+BaO (mol %)+SrO (mol %)). In aspects, the concentration of R′O in the glass article may be greater than 0 mol %, 0.5 mol % or more, 1 mol % or more, 1.5 mol % or more, 2 mol % or more, 2.5 mol % or more, 8 mol % or less, 7.5 mol % or less, 7 mol % or less, 6.5 mol % or less, 6 mol % or less, 5.5 mol % or less, 5 mol % or less, 4.5 mol % or less, 4 mol % or less, or 3.5 mol % or less. In aspects, the concentration of R′O in the glass article may be from greater than 0 mol % to 8 mol %, from 0.5 mol % to 7.5 mol %, from 0.5 mol % to 7 mol %, from 1 mol % to 6.5 mol % from 1 mol % to 6 mol %, from 1.5 mol % to 5.5 mol %, from 1.5 mol % to 5 mol %, from 2 mol % to 4.5 mol %, from 2 mol % to 4 mol %, from 2.5 mol % to 3.5 mol %, or any range or subrange therebetween.

In aspects, a sum of R₂O, CaO, MgO, and ZnO (R₂O (mol %)+CaO (mol %)+MgO (mol %)+ZnO (mol %) may be 35 mol % or less, for example, from 1 mol % to 30 mol %, from 2 mol % to 30 mol %, from 3 mol % to 25 mol %, from 4 mol % to 25 mol %, from 5 mol % to 20 mol %, 6 mol % to 20 mol %, from 7 mol % to 15 mol %, from 8 mol % to 10 mol %, or any range or subrange therebetween.

In aspects, a sum of Al₂O₃, MgO, and ZnO present in the glass article (i.e., Al₂O₃ (mol %)+MgO (mol %)+ZnO (mol %)) may be from 12 mol % to 22 mol %. Without wishing to be bound by theory, it is believed that combinations of Al₂O₃, MgO, and ZnO within this range may aid in avoiding the formation of undesired crystal phases in the resultant colored glass articles. For example and without limitation, when the colorant package in the glass article includes Cr₂O₃, combinations of Al₂O₃, MgO, and ZnO within this range may avoid the formation of Cr-spinel crystals by increasing the solubility of the Cr₂O₃ colorant and thereby expanding the color gamut that may be achieved in the resultant colored glass articles. In aspects, a sum of Al₂O₃, MgO, and ZnO in the glass article may be from 13 mol % to 21.5 mol %. In aspects, the sum of Al₂O₃, MgO, and ZnO in the glass article may be 12 mol % or more, 13 mol % or more, 14 mol % or more, 15 mol % or more, 16 mol % or more, 22 mol % or less, 21.5 mol % or less, 21 mol % or less, 20.5 mol % or less, or 20 mol % or less. In aspects, the sum of Al₂O₃, MgO, and ZnO in the glass article may be from 12 mol % to 22 mol %, from 13 mol % to 21.5 mol %, from 14 mol % to 21 mol %, from 15 mol % to 20.5 mol %, from 16 mol % to 20 mol %, or any range or subrange therebetween.

In aspects, a sum of Al₂O₃, MgO, CaO, and ZnO present in the glass article (i.e., Al₂O₃ (mol %)+MgO (mol %)+CaO (mol %)+ZnO (mol %)) may be from 12 mol % to 24 mol %. Without wishing to be bound by theory, it is believed that combinations of Al₂O₃, MgO, CaO, and ZnO within this range may aid in avoiding the formation of undesired crystal phases in the glass article. In addition, a relatively high concentration of high field strength modifiers, for example Mg, Ca, and Zn cations, may also improve the mechanical properties, for example fracture toughness, elastic modulus, and drop test performance, of the resultant colored glass article. In aspects, a sum of Al₂O₃, MgO, CaO, and ZnO in the glass article may be from 12 mol % to 24 mol %. In aspects, the sum of Al₂O₃, MgO, CaO, and ZnO in the glass article may be 12 mol % or more, 13 mol % or more, 14 mol % or more, 15 mol % or more, 16 mol % or more, 24 mol % or less, 23 mol % or less, 22 mol % or less, 21.5 mol % or less, 21 mol % or less, 20.5 mol % or less, or 20 mol % or less. aspects, the sum of Al₂O₃, MgO, CaO, and ZnO in the glass article may be from 12 mol % to 24 mol %, from 13 mol % to 23 mol %, from 13 mol % to 22 mol %, from 14 mol % to 21.5 mol %, from 14 mol % to 21 mol %, from 15 mol % to 20.5 mol %, from 16 mol % to 20 mol %, or any range or subrange therebetween.

In aspects, the glass article may optionally include Cl, which may enable growth of particular crystal phases containing colorant. For example, when the colorant package included in the glass comprises Au, the inclusion of Cl may enable the growth of certain Au crystals. In aspects, the concentration of Cl in the glass article may be greater than 0 mol %, 0.1 mol % or more, 0.5 mol % or less, or 0.25 mol % or less. In aspects, the concentration of Cl in the glass article may be from greater than 0 mol % to 0.5 mol %, from 0.1 mol % to 0.25 mol %, or any range or subrange therebetween. In aspects, the glass article may be substantially free or free of Cl. In aspects where the colorant package comprises Ag, the glass article can include less than 100 ppm of halides, including Cl.

In aspects, the glass articles described herein may further comprise ZrO₂. Without wishing to be bound by theory, it is believed that ZrO₂ may act as a multivalent species that serves as redox couples to supply oxygen to certain colorants, for example Au, during relatively low-temperature heat treatment, which helps improve retention of the colorant. ZrO₂ may also act as an additional colorant, producing colored glass articles that may be, for example, red in color. In aspects, the glass article may comprise ZrO₂ in an amount of 0.01 mol % or more, 0.1 mol % or more, 0.2 mol % or more 0.25 mol % or more, 0.5 mol % or more, 0.75 mol % or more, 1 mol % or more, 2 mol % or less, 1.75 mol % or less, 1.5 mol % or less, 1 mol % or less, or 0.5 mol % or less. In aspects, the glass article may comprise ZrO₂ in an amount from 0.01 mol % to 2 mol %, from 0.1 mol % to 1.75 mol %, from 0.2 mol % to 1.5 mol %, from 0.25 mol % to 1.25 mol %, from 0.5 mol % to 1 mol %, from 0.75 mol % to 1 mol %, or any range or subrange therebetween.

In aspects, the glass compositions and the resultant colored glass articles described herein may further comprise Fe₂O₃, which may help improve colorant retention and/or color striking. Fe₂O₃ is a multivalent species that serves as redox couples to supply oxygen to certain colorants, for example Au, during relatively low-temperature heat treatment, which helps improve retention of the colorant. Fe₂O₃ may also act as a colorant, producing colored glass articles that may, for example, be pink or red in color. In aspects, the glass article may comprise Fe₂O₃ in an amount of greater than 0 mol %, 0.01 mol % or more, 0.05 mol % or more, 0.1 mol % or more, 1 mol % or more, 1 mol % or less, 0.75 mol % or less, 0.5 mol % or less, 0.25 mol % or less, or 0.1 mol % or less. In aspects, the glass article may comprise Fe₂O₃ in an amount from greater than 0 mol % to 1 mol %, from 0.01 mol % to 0.75 mol %, from 0.05 mol % to 0.5 mol %, from 0.1 mol % to 0.25 mol %, or any range or subrange therebetween. In aspects, the glass article may comprise Fe₂O₃ in an amount of 200 parts-per-million (ppm) or more, 250 ppm or more, 300 ppm or more, 350 ppm or more, 400 ppm or less, 1,000 ppm or less, 600 ppm or less, 550 ppm or less, 500 ppm or less, or 450 ppm or less. In aspects, the glass article can comprise Fe₂O₃ in an amount from about 200 ppm to about 1,000 ppm, from about 300 ppm to about 600 ppm, from about 350 ppm to about 550 ppm, from about 400 ppm to about 500 ppm, or any range or subrange therebetween. In aspects, the glass article may be substantially free or free of Fe₂O₃.

In aspects, the glass compositions and the resultant colored glass articles described herein may further comprise SnO₂, Sb₂O₃, and/or Bi₂O₃. Like MgO and ZnO, SnO₂, Sb₂O₃, and Bi₂O₃ may help lower the melting point of the glass composition. Accordingly, SnO₂, Sb₂O₃, and/or Bi₂O₃ may be included in the glass articles to lower the melting point and improve colorant retention. In aspects in which the colorant package includes Ag, SnO₂ also aids in the reduction of Ag in the glass leading to the formation of silver particles in the glass. Without wishing to be bound by theory, in aspects where the colorant package includes Au, it is believed that additions of SnO₂ may also aid in the reduction of Au in the glass, leading to the formation of gold particles. In aspects that include SnO₂ and/or Sb₂O₃, the SnO₂ and/or Sb₂O₃ may also function as a fining agent.

In aspects, the glass article may comprise SnO₂ in an amount of greater than 0 mol %, 0.01 mol % or more, 0.05 mol % or more, 0.1 mol % or more, 0.25 mol % or more, 1 mol % or less, 0.75 mol % or less, 0.5 mol % or less, 0.25 mol % or less, or 0.1 mol % or less. In aspects, the glass article may comprise SnO₂ in an amount from greater than 0 mol % to 1 mol %, from 0.01 mol % to 0.75 mol %, from 0.05 mol % to 0.5 mol %, from 0.1 mol % to 0.25 mol %, or any range or subrange therebetween. In aspects, the glass article may be substantially free or free of SnO₂.

In aspects, the concentration of Sb₂O₃ in the glass article may be greater than 0 mol %, 0.01 mol % or more, 0.05 mol % or more, 0.1 mol % or more, 1 mol % or less, 0.75 mol % or less, 0.5 mol % or less, 0.25 mol % or less, or 0.1 mol % or less. aspects, the concentration of Sb₂O₃ in the glass article may be from greater than 0 mol % to 1 mol %, from 0.01 mol % to 0.75 mol %, from 0.05 mol % to 0.5 mol %, from 0.1 mol % to 0.25 mol %, or any range or subrange therebetween. In aspects, the glass article may be substantially free or free of Sb₂O₃. In aspects, the glass article can comprise Sb₂O₃ in an amount from 0.01 wt % to about 0.5 wt %, from 0.02 wt % to about 0.4 wt %, from 0.05 wt % to about 0.3 wt %, from 0.1 wt % to about 0.2 wt %, or any range or subrange therebetween.

In aspects, the concentration of Bi₂O₃ in the glass article may be greater than 0 mol %, 0.01 mol % or more, 0.05 mol % or more, 0.1 mol % or more, 1 mol % or less, 0.75 mol % or less, 0.5 mol % or less, 0.25 mol % or less, or 0.1 mol % or less. In aspects, the concentration of Bi₂O₃ in the glass article may be from greater than 0 mol % to 1 mol %, from 0.01 mol % to 0.75 mol %, from 0.05 mol % to 0.5 mol %, from 0.1 mol % to 0.25 mol %, or any range or subrange therebetween. In aspects, the glass article may be substantially free or free of Bi₂O₃.

In aspects, the concentration of SO₃ in the glass article may be 0.1 mol % or less, 0.01 mol % or less, or 0.001 mol % or less. In aspects, the glass article may be substantially free or free of SO₃.

In aspects, the glass articles described herein may further comprise a reduced concentration or be substantially free or free of P₂O₅. In aspects where P₂O₅ is included, the P₂O₅ may enhance the ion exchange characteristics of the resultant colored glass article. However, an increased concentration (i.e., greater than 1 mol %) of P₂O₅ may reduce the retention of one or more colorants in the colorant package. Without wishing to be bound by theory, it is believed that P₂O₅ may be more volatile than other glass network formers, for example SiO₂, which may contribute to reduced retention of colorants in the colorant package. In aspects, the concentration of P₂O₅ in the glass article may comprise be greater than 0 mol %, 0.1 mol % or more, 0.25 mol % or more, 1 mol % or less, 0.75 mol % or less, 0.5 mol % or less, or 0.25 mol % or less. In aspects, the concentration of P₂O₅ in the glass article may comprise be from greater than 0 mol % to 1 mol %, from 0.1 mol % to 0.75 mol %, from 0.25 mol % to 0.5 mol %, or any range or subrange therebetween. In aspects, the glass article may be substantially free or free of P₂O₅.

In aspects, the glass articles can comprise at least one colorant in a colorant package that functions to impart a desired color to the glass article. In aspects, the colorant package may comprise at least one of Au, Ag, Cr₂O₃, transition metal oxides (e.g., CuO, NiO, Co₃O₄, TiO₂, Cr₂O₃, V₂O₅), rare earth metal oxides (e.g., CeO₂), and/or combinations thereof. In aspects, the glass articles may be from 1×10⁻⁶ mol % to 10 mol % of colorant (i.e., the sum of all colorants in the colorant package). In aspects, the concentration of the colorant package in the glass article may be 1×10⁻⁶ mol % or more, 0.0005 mol % or more, 0.001 mol % or more, 0.01 mol % or more, 0.1 mol % or more, 10 mol % or less, 9.5 mol % or less, 9 mol % or less, 8.5 mol % or less, 8 mol % or less, 7.5 mol % or less, 7 mol % or less, 6.5 mol % or less, 6 mol % or less, 5.5 mol % or less, 5 mol % or less, 4.5 mol % or less, 4 mol % or less, 3.5 mol % or less, 3 mol % or less, 2.5 mol % or less, 2 mol % or less 1.5 mol % or less 1 mol % or less, 0.5 mol % or less. In aspects, the concentration of the colorant package in the glass article may be from 1×10⁻⁶ mol % to 10 mol %, from 1×10⁻⁶ mol % to 9 mol %, from 1×10⁻⁶ mol % to 8 mol %, from 0.0005 mol % to 7 mol %, from 0.0005 mol % to 6 mol %, from 0.0005 mol % to 5 mol %, from 0.001 mol % to 4 mol %, from 0.001 mol % to 3 mol %, from 0.001 mol % to 2 mol %, from 0.01 mol % to 1.5 mol %, from 0.01 mol % to 1 mol %, from 0.1 mol % to about 0.5 mol %, or any range or subrange therebetween. In aspects, the concentration of the colorant package in the glass article may be from 1×10⁻⁶ mol % to 1 mol %, from 0.0005 mol % to about 0.5 mol %, from 0.001 mol % to 0.25 mol %, from 0.01 mol % to 0.1 mol %, or any range or subrange therebetween.

In aspects, the colorant package in the glass compositions and the resultant colored glass articles may include colorants that comprise or consist of transition metal oxides, rare earth oxides, or combinations thereof, to achieve a desired color. In aspects, transition metal oxides and/or rare earth oxides may be included in the glass compositions as the sole colorant or in combination with other colorants. In aspects, the multi-valent colorant can comprise Cr₂O₃, CeO₂, Co₃O₄CuO, TiO₂, NiO, V₂O₅, or combinations thereof. In further aspects, the multi-valent colorant can consist of Cr₂O₃, CeO₂, or combinations thereof. In further aspects, the colorants can further include Co₃O₄. For example, in aspects where Cr₂O₃ is utilized as the multi-valent colorant, transition metal oxides may be included in the glass composition to modify the color imparted to the glass, including, for example Co₃O₄. As described herein, in aspects, the glass compositions and the resultant colored glass articles may be formulated to improve the solubility of Cr₂O₃, thereby expanding the color gamut achievable in the resultant colored glass articles. In aspects, colorants based on transition metal oxides and/or rare earth oxides may further include oxides of V, Mn, Fe, Cu, Zr, Nb, Mo, Tc, Ru, Rh, Pd, Cd, Hf, Ta, W, Re, Os, Ir, Pt, Pr, Nd, Sm, Eu, Gd, Tb, Dy, Ho, and Er.

In aspects, the glass article may comprise Cr₂O₃ of greater than 0 mol % or more, 0.001 mol % or more, 0.005 mol % or less, 0.01 mol % or more, 0.05 mol % or more, 2 mol % or less, 1.5 mol % or less, 1 mol % or less, 0.5 mol % or less, or 0.1 mol % or less. In aspects, the glass article may comprise Cr₂O₃ from greater than 0 mol % to 2 mol %, from 0.001 mol % to 1.5 mol %, from 0.005 mol % to 1 mol %, from 0.01 mol % to 0.05 mol %, from 0.05 mol % to 0.1 mol %, or any range or subrange therebetween. In aspects, the glass article may comprise Cr₂O₃ from 100 ppm to 10,000 ppm, from 100 ppm to 5,000 ppm, from 300 ppm to 2,000 ppm, from 500 ppm to 1,000 ppm, or any range or subrange therebetween.

In aspects where the colorant package includes Cr₂O₃ as a colorant, the glass compositions and the resultant colored glass articles are per-alkali (i.e., R₂O (mol %)+R′O (mol %)−Al₂O₃ (mol %) is 0.5 mol % or more) to increase the solubility of Cr₂O₃ and avoid Cr-spinel crystal formation. However, when the glass composition has an excessive amount of alkali after charge balancing Al₂O₃, the alkali may form non-bridging oxygen around SiO₂, which degrades fracture toughness. Accordingly, in aspects, R₂O+R′O—Al₂O₃ in the glass article may be limited (e.g., less than or equal to 6 mol %) to prevent a reduction in fracture toughness.

In aspects, the glass article may comprise a concentration of NiO+Co₃O₄+Cr₂O₃+CuO+CeO₂+TiO₂ of greater than 0 mol %, 0.001 mol % or more, 0.01 mol % or more, 0.02 mol % or more, 0.1 mol % or more, 0.5 mol % or more, 0.7 mol % or more, 0.9 mol % or more, 5 mol % or less, 4 mol % or less, 3 mol % or less, 2.5 mol % or less, 2 mol % or less, 1.5 mol % or less, 1 mol % or less, 0.75 mol % or less, 0.5 mol % or less, or 0.25 mol % or less. In aspects, the glass article may comprise a concentration of NiO+Co₃O₄+Cr₂O₃+CuO+CeO₂+TiO₂ can range from grater that 0 mol % to 5 mol %, from 0.001 mol % to 4 mol %, from 0.01 mol % to 3 mol %, from 0.02 mol % to 2.5 mol %, from 0.1 mol % to 2 mol %, from 0.5 mol % to 1.5 mol %, from 0.7 mol % to 1 mol %, or any range or subrange therebetween. In aspects, the glass composition and resultant glass article may comprise 0 mol % of one or more of NiO, Co₃O₄, Cr₂O₃, CuO, CeO₂, V₂O₅, and/or TiO₂.

In aspects, the glass article may comprise a concentration of NiO+Co₃O₄+Cr₂O₃+CuO from 0.001 mol to 3 mol %. In aspects, the glass article may comprise a concentration of NiO+Co₃O₄+Cr₂O₃+CuO of greater than 0 mol %, 0.001 mol % or more, 0.01 mol % or more, 0.02 mol % or more, 0.1 mol % or more, 0.2 mol %, 0.5 mol %, 3 mol % or less, 2.5 mol % or less, 2 mol % or less, 1.5 mol % or less, 1 mol % or less, 0.5 mol % or less, or 0.4 mol % or less. In aspects, the glass article may comprise a concentration of NiO+Co₃O₄+Cr₂O₃+CuO from greater than 0 mol % to 3 mol %, from 0.001 mol % to 2.5 mol %, from 0.01 mol % to 2 mol %, from 0.02 mol % to 1.5 mol %, from 0.1 mol % to 1 mol %, from 0.2 mol % to 0.5 mol %, from 0.2 mol % to 0.4 mol %, or any range or subrange therebetween. In aspects, the glass composition and resultant glass article may comprise 0 mol % of one or more of NiO, Co₃O₄, Cr₂O₃, and/or CuO.

In aspects, the glass article may comprise a concentration of TiO₂ of greater than 0 mol %, 0.01 mol % or more, 0.1 mol % or more, 0.2 mol % or more, 0.3 mol % or more, 2 mol % or less, 1.5 mol % or less, 1 mol % or less, 0.75 mol % or less, 0.5 mol % or less, or 0.4 mol % or less. In aspects, the glass article may comprise a concentration of TiO₂ from greater than 0 mol % to 2 mol %, from 0.01 mol % to 1.5 mol %, from 0.1 mol % to 1 mol %, from 0.2 mol % to 0.75 mol %, from 0.3 mol % to 0.5 mol %, from 0.3 mol % to 0.4 mol %, or any range or subrange therebetween.

In aspects, the glass article may comprise a concentration of CeO₂ of 0.1 mol % or more, 0.2 mol % or more, 0.3 mol % or more, 2 mol % or less, 1.5 mol % or less, 1 mol % or less, 0.75 mol % or less, 0.5 mol % or less, or 0.4 mol % or less. In aspects, the glass article may comprise a concentration of CeO₂ from 0.1 mol % to 2 mol %, from 0.2 mol % to 1.5 mol %, from 0.2 mol % to 1 mol %, from 0.3 mol % to 0.75 mol %, from 0.3 mol % to 0.5 mol, from 0.3 mol % to 0.4 mol %, or any range or subrange therebetween.

In aspects, the glass article may comprise a concentration of NiO of greater than 0 mol %, 0.01 mol % or more, 0.015 mol % or more, 0.02 mol % or more, 0.05 mol % or less, 0.04 mol % or less, 0.035 mol % or less, 0.03 mol % or less, 0.025 mol % or less, 0.02 mol % or less, or 0.015 mol % or less. In aspects, the glass article may comprise a concentration of NiO can be from greater than 0 mol % to 0.05 mol %, from 0.01 mol % to 0.04 mol %, from 0.01 mol % to 0.035 mol %, from 0.015 mol % to 0.03 mol %, from 0.02 mol % to 0.025 mol %, or any range or subrange therebetween.

In aspects, the glass article may comprise a concentration of CuO of greater than 0 mol %, 0.1 mol % or more, 0.15 mol % or more, 0.5 mol % or less, 0.4 mol % or less, 0.35 mol % or less, 0.3 mol % or less, 0.25 mol % or less, 0.2 mol % or less, or 0.15 mol % or less. In aspects, the glass article may comprise a concentration of CuO from greater than 0 mol % to 0.5 mol %, from 0.1 mol % to 0.4 mol % from 0.1 mol % to 0.35 mol %, from 0.15 mol % to 0.3 mol %, from 0.15 mol % to 0.25 mol %, from 0.15 mol % to 0.2 mol %, or any range or subrange therebetween.

In aspects, the glass article may comprise a concentration of V₂O₅ of 0.1 mol % or more, 0.2 mol % or more, 0.3 mol % or more, 2 mol % or less, 1.5 mol % or less, 1 mol % or less, 0.75 mol % or less, 0.5 mol % or less, or 0.4 mol % or less. In aspects, the glass article may comprise a concentration of V₂O₅ from 0.1 mol % to 2 mol %, from 0.2 mol % to 1.5 mol %, from 0.2 mol % to 1 mol %, from 0.3 mol % to 0.75 mol %, from 0.3 mol % to 0.5 mol, from 0.3 mol % to 0.4 mol %, or any range or subrange therebetween.

In aspects, the glass article may comprise a concentration of Nd₂O₃ of greater than 0 mol %, 0.1 mol % or more, 4 mol % or less, 3 mol % or less, 1.5 mol % or less, or 0.5 mol % or less. aspects, the glass article may comprise a concentration of Nd₂O₃ of from greater than 0 mol % to 4 mol %, from 0 mol % to 3 mol %, from 0.1 mol % to 1.5 mol %, from 0.1 mol % to 0.5 mol %, or any range or subrange therebetween. In aspects, the glass articles may comprise Er₂O₃ within one or more of the ranges discussed above in this paragraph for the amount of Nd₂O₃.

In aspects, the glass article may comprise a concentration of Co₃O₄ of greater than 0 mol %, 0.0001 mol % or more, 0.0002 mol % or more, 0.0005 mol % or more, 0.001 mol % or more, 0.01 mol % or less, 0.0095 mol % or less, 0.009 mol % or less, 0.0085 mol % or less, 0.008 mol % or less, 0.0075 mol % or less, 0.007 mol % or less, 0.0065 mol % or less, 0.006 mol % or less, 0.0055 mol % or less, 0.005 mol % or less, 0.0045 mol % or less, 0.004 mol % or less, 0.0035 mol % or less, 0.003 mol % or less, 0.0025 mol % or less, or 0.002 mol % or less. In aspects, the glass article may comprise a concentration of Co₃O₄ from greater than 0 mol % to 0.01 mol % or less, from 0.0001 mol % to 0.009 mol % or less, from 0.0001 mol % to 0.008 mol %, from 0.0001 mol % to 0.007 mol %, from 0.0002 mol % to 0.006 mol %, from 0.0002 mol % to 0.005 mol %, from 0.0005 mol % to 0.004 mol %, from 0.0005 mol % to 0.003 mol %, from 0.01 mol % to 0.02 mol %, or any range or subrange therebetween.

In aspects, the glass article may comprise greater an amount of Cr₂O₃ that is greater than 0 mol %, 0.01 mol % or more, 0.015 mol % or more, 0.05 mol % or less, 0.04 mol % or less, 0.035 mol % or less, 0.03 mol % or less, 0.025 mol % or less, 0.02 mol % or less, or 0.015 mol % or less. In aspects, the glass article may comprise greater an amount of Cr₂O₃ that is from greater than 0 mol % to 0.05 mol %, from greater than 0 mol % to 0.04 mol %, from 0.01 mol % to 0.035 mol %, from 0.01 mol % to 0.03 mol %, from 0.015 mol % to 0.025 mol %, from 0.015 mol % to 0.02 mol %, or any range or subrange therebetween.

In aspects, the glass article may comprise at least one of: 0.001 mol % or more of NiO+Co₃O₄+Cr₂O₃+CuO (e.g., from 0.001 mol % to 3 mol or any of the ranges of NiO+Co₃O₄+Cr₂O₃+CuO described herein); 0.1 mol % or more of CeO₂ (e.g., from 0.1 mol % to 1.5 mol % or any of the ranges of CeO₂ described herein); and/or 0.1 mol % or more of TiO₂ (e.g., from 0.1 mol % to 2 mol % or any of the ranges of TiO₂ described herein).

In aspects, the glass compositions and the resultant colored glass articles described herein may further include tramp materials, for example, MnO, MoO₃, WO₃, Y₂O₃, CdO, As₂O₃, sulfur-based compounds (e.g., sulfates), halogens, or combinations thereof. In aspects, the glass composition and the resultant colored glass article may be substantially free or free of tramp materials, for example MnO, MoO₃, WO₃, Y₂O₃, CdO, As₂O₃, sulfur-based compounds (e.g., sulfates), halogens, or combinations thereof.

In aspects, decreasing the melting point of the glass article may help improve colorant retention because the glass compositions may be melted at relatively lower temperatures and colorant evaporation may be reduced. Accordingly, the glass articles described herein may optionally include MgO and/or ZnO, which help lower the melting point of the glass articles. B₂O₃, Li₂O, and Na₂O also decrease the melting point of the glass articles. As described herein, other components may be added to the glass article to lower the melting point thereof, for example SnO₂, Sb₂O₃, and Bi₂O₃. In aspects, the glass article may have a melting point of 1300° C. or more, 1325° C. or more, 1350° C. or more, 1375° C. or more, 1400° C. or more, 1550° C. or less, 1525° C. or less, 1500° C. or less, 1475° C. or less, or 1450° C. or less. In aspects, the melting point of the glass article can be from 1300° C. to 1550° C., from 1325° C. to 1525° C., from 1350° C. to 1500° C., from 1375° C. to 1475° C., from 1400° C. to 1450° C., or any range or subrange therebetween. In aspects, a liquidus temperature of the glass article may be 1000° C. or more, 1050° C. or more, 1100° C. or more, 1400° C. or less, 1350° C. or less, or 1300° C. or less. In aspects, a liquidus temperature of the glass article may be from 1000° C. to 1400° C., from 1050° C. to 1350° C., from 1100° C. to 1300, or any range or subrange therebetween.

In aspects, the viscosity of the glass article may be adjusted to prevent devitrification of the glass composition and formation of colorant particles, for example Au particles, during melting and forming. Formation of colorant particles during melting and forming may limit the color gamut that may be achieved by heat treatment. In aspects, to achieve the desired viscosity and thereby prevent formation of colorant particles before melting, the glass articles described herein may satisfy the relationship 5.72*Al₂O₃ (mol %)-21.4*ZnO (mol %)-2.5*P₂O₅ (mol %)-35*Li₂O (mol %)-16.6*B₂O₃ (mol %)-20.5*MgO (mol %)-23.3*Na₂O (mol %)-27.9*SrO (mol %)-18.5*K₂O (mol %)-26.3*CaO (mol %) is greater than −609 mol %. In aspects, the glass articles described herein may satisfy the relationship 5.72*Al₂O₃ (mol %)-21.4*ZnO (mol %)-2.5*P₂O₅ (mol %)-35*Li₂O (mol %)-16.6*B₂O₃ (mol %)-20.5*MgO (mol %)-23.3*Na₂O (mol %)-27.9*SrO (mol %)-18.5*K₂O (mol %)-26.3*CaO (mol %) is greater than −609 mol %, greater than or equal to −575 mol %, greater than or equal to −550 mol %, or even greater than or equal to −525 mol %. In aspects, the glass compositions and the resultant glass articles described herein may satisfy the relationship 5.72*Al₂O₃ (mol %)-21.4*ZnO (mol %)-2.5*P₂O₅ (mol %)-35*Li₂O (mol %)-16.6*B₂O₃ (mol %)-20.5*MgO (mol %)-23.3*Na₂O (mol %)-27.9*SrO (mol %)-18.5*K₂O (mol %)-26.3*CaO (mol %) is less than or equal to −400 mol %, less than or equal to −425 mol %, or even less than or equal to −450 mol %. In aspects, the glass articles described herein may satisfy the relationship 5.72*Al₂O₃ (mol %)-21.4*ZnO (mol %)-2.5*P₂O₅ (mol %)-35*Li₂O (mol %)-16.6*B₂O₃ (mol %)-20.5*MgO (mol %)-23.3*Na₂O (mol %)-27.9*SrO (mol %)-18.5*K₂O (mol %)-26.3*CaO (mol %) is from −609 mol % to −400 mol %, from −575 mol % to −425 mol %, from −550 mol % to −450 mol %, from −525 mol % to −450 mol %, or any range or subrange therebetween.

In aspects, the glass article may comprise from 50 mol % to 80 mol % SiO₂; from 7 mol % to 25 mol % Al₂O₃; from 1 mol % to 15 mol % B₂O₃; from 5 mol % to 20 mol % Li₂O; from 0.5 mol % to 15 mol % Na₂O; from greater than 0 mol % to 1 mol % K₂O; and from 1×10⁻⁶ mol % to 1 mol % Au, wherein: R₂O—Al₂O₃ is from −5 mol % to 7 mol %. In aspects, the glass article can comprise from 50 mol % to 70 mol % SiO₂; from 10 mol % to 17.5 mol % Al₂O₃; from 3 mol % to 10 mol % B₂O₃; from 8.8 mol % to 14 mol % Li₂O; from 1.5 mol % to 8 mol % Na₂O; and from 0 mol % to 2 mol % Cr₂O₃, wherein: R₂O+R′O—Al₂O₃ is from 0.5 mol % to 6 mol %, and Al₂O₃+MgO+ZnO is from 12 mol % to 22 mol %.

In aspects, the glass article may comprise from 50 mol % to 70 mol % SiO₂; from 10 mol % to 20 mol % Al₂O₃; from 4 mol % to 10 mol % B₂O₃; from 7 mol % to 17 mol % Li₂O; from 1 mol % to 9 mol % Na₂O; from 0.01 mol % to 1 mol % SnO₂; and from 0.01 mol % to 5 mol % Ag, wherein R₂O—Al₂O₃ is from 0.2 mol % to 5.00 mol %. In aspects, the glass article may comprise from 50 mol % to 70 mol % SiO₂; from 10 mol % to 20 mol % Al₂O₃; from 1 mol % to 10 mol % B₂O₃; from 7 mol % to 14 mol % Li₂O; from 0.01 mol % to 8 mol % Na₂O; from 0.01 mol % to 1 mol % K₂O; from 0 mol % to 7 mol % CaO; and from 0 mol % to 8 mol % MgO, wherein Li₂O+K₂O+Na₂O+CaO+MgO+ZnO is 25 mol % or more and at least one of: CuO+NiO+Co₃O₄+Cr₂O₃ is 0.001 mol % or more, CeO₂ is 0.1 mol % or more, and/or TiO₂ is 0.1 mol % or more.

Throughout the disclosure, fracture toughness (K_{IC}) represents the ability of a glass composition to resist fracture. Fracture toughness is measured on a non-strengthened glass article, such as measuring the K_{IC} value prior to ion exchange (IOX) treatment of the glass article, thereby representing a feature of a glass substrate prior to IOX. The fracture toughness test methods described herein are not suitable for glasses that have been exposed to IOX treatment. Accordingly, where the fracture toughness of an ion exchanged article is referred to, it means the fracture toughness of a non-ion exchanged article with the same composition and microstructure (when present) as the center (i.e., a point located at least 0.5t from every surface of the article or substrate where t is the thickness of the article or substrate) of the ion exchanged article (which corresponds to the portion of the ion exchanged article least affected by the ion exchange process and, hence, a composition and microstructure comparable to a non-ion exchanged glass). Fracture toughness is measured by the chevron notched short bar method. The chevron notched short bar (CNSB) method is disclosed in Reddy, K. P. R. et al, “Fracture Toughness Measurement of Glass and Ceramic Materials Using Chevron-Notched Specimens,” J. Am. Ceram. Soc., 71 [6], C-310-C-313 (1988) except that Y*ₘ is calculated using equation 5 of Bubsey, R. T. et al., “Closed-Form Expressions for Crack-Mouth Displacement and Stress Intensity Factors for Chevron-Notched Short Bar and Short Rod Specimens Based on Experimental Compliance Measurements,” NASA Technical Memorandum 83796, pp. 1-30 (October 1992). Unless otherwise specified, all fracture toughness values were measured by chevron notched short bar (CNSB) method.

In aspects, the glass articles formed from the glass compositions described herein may have an increased fracture toughness such that the colored glass articles are more resistant to damage. In aspects, the glass article may have a K_{IC} fracture toughness as measured by a CNSB method, prior to ion exchange, of 0.7 MPa·m^{1/2} or more, 0.8 MPa·m^{1/2} or more, 0.9 MPa·m^{1/2} or more, or 1.0 MPa·m^{1/2} or more. In aspects, the glass article 350 and/or 511 formed from the glass compositions described herein may have an increased fracture toughness such that the colored glass articles are more resistant to damage. In aspects, the glass article 350 and/or 511 may have a K_{IC} fracture toughness as measured by the DCB method, prior to ion exchange, of 0.6 MPa·m^{1/2} or more, 0.7 MPa·m^{1/2} or more, 0.8 MPa·m^{1/2} or more, 0.9 MPa·m^{1/2} or more, 1.0 MPa·m^{1/2} or more.

Throughout the disclosure, the dielectric constant of the glass article is measured using a split post dielectric resonator (SPDR) at a frequency of 10 GHz. The dielectric constant was measured on samples of the glass article having a length of 3 inches (76.2 mm), a width of 3 inches (76.2 mm), and a thickness of less than 0.9 mm. In aspects, the glass article 350 and/or 511 comprises a dielectric constant Dk at 10 GHz of 6.4 or less, 6.3 or less, 6.2 or less, 6.1 or less, 6 or less, 5.6 or more, 5.7 or more, 5.8 or more, 5.9 or more, or 6.0 or more. In aspects, the glass article 350 and/or 511 comprises a dielectric constant Dk at 10 GHz in a range from 5.6 to 6.4, from 5.7 to 6.3, from 5.8 to 6.2, from 5.9 to 6.1, from 5.9 to 6, or any range or subrange therebetween. In aspects, the dielectric constant at frequencies from 10 GHz to 60 GHz (e.g., from 26 GHz to 40 GHz) can be within one or more of the above-mentioned ranges. Without wishing to be bound by theory, it is believed that the dielectric constant of the glass article measured at 10 GHz approximates the dielectric constant at frequencies from 10 GHz to 60 GHz. Accordingly, a dielectric constant reported for a colored glass article at a frequency of 10 GHz approximates the dielectric constant of the colored glass article at frequencies in a range from 10 GHz to 60 GHz, inclusive of endpoints.

In aspects, although not shown, the natively colored glass housing can further comprise a coating disposed on the first major surface of the glass article, for example. For example, the coating can be an anti-reflective coating, an anti-glare coating, an easy-to-clean coating, a low-friction coating, an oleophobic coating, a diamond-like coating, a scratch-resistant, coating, an abrasion-resistant coating, a polymeric hard coating, or a combination thereof. A scratch-resistant coating may comprise an oxynitride, for example, aluminum oxynitride or silicon oxynitride with a thickness of about 500 micrometers or more. In such aspects, the abrasion-resistant layer may comprise the same material as the scratch-resistant layer. In aspects, a low friction coating may comprise a highly fluorinated silane coupling agent, for example, an alkyl fluorosilane with oxymethyl groups pendant on the silicon atom. In such aspects, an easy-to-clean coating may comprise the same material as the low friction coating. In other aspects, the easy-to-clean coating may comprise a protonatable group, for example an amine, for example, an alkyl aminosilane with oxymethyl groups pendant on the silicon atom. In such aspects, the oleophobic coating may comprise the same material as the easy-to-clean coating. In aspects, a diamond-like coating comprises carbon and may be created by applying a high voltage potential in the presence of a hydrocarbon plasma.

In further aspects, a polymeric hard coating can comprise one or more of an ethylene-acid copolymer, a polyurethane-based polymer, an acrylate resin, and a mercapto-ester resin. Example aspects of ethylene-acid copolymers include ethylene-acrylic acid copolymers, ethylene-methacrylic acid copolymers, and ethylene-acrylic-methacrylic acid terpolymers (e.g., Nucrel, manufactured by DuPont), ionomers of ethylene acid copolymers (e.g., Surlyn, manufactured by DuPont), and ethylene-acrylic acid copolymer amine dispersions (e.g., Aquacer, manufactured by BYK). Example aspects of polyurethane-based polymers include aqueous-modified polyurethane dispersions (e.g., Eleglas®, manufactured by Axalta). Example aspects of acrylate resins that can be UV curable include acrylate resins (e.g., Uvekol® resin, manufactured by Allinex), cyanoacrylate adhesives (e.g., Permabond® UV620, manufactured by Krayden), and UV radical acrylic resins (e.g., Ultrabond windshield repair resin, for example, Ultrabond (45CPS)). Example aspects of mercapto-ester resins include mercapto-ester triallyl isocyanurates (e.g., Norland optical adhesive NOA 61). In further aspects, the polymeric hard coating can comprise ethylene-acrylic acid copolymers and ethylene-methacrylic acid copolymers, which may be ionomerized to form ionomer resins through neutralization of the carboxylic acid residue with typically alkali-metal ions, for example, sodium and potassium, and also zinc. Such ethylene-acrylic acid and ethylene-methacrylic acid ionomers may be dispersed in water and coated onto the substrate to form an ionomer coating. Alternatively, such acid copolymers may be neutralized with ammonia which, after coating and drying liberates the ammonia to reform the acid copolymer as the coating. By providing a coating comprising a polymeric coating, the foldable apparatus can comprise low energy fracture. In further aspects, the polymeric hard coating can comprise an optically transparent hard-coat layer. Suitable materials for an optically transparent polymeric hard-coat layer include but are not limited to a cured acrylate resin material, an inorganic-organic hybrid polymeric material, an aliphatic or aromatic hexafunctional urethane acrylate, a siloxane-based hybrid material, and a nanocomposite material, for example, an epoxy and urethane material with nanosilicate. As used herein, “inorganic-organic hybrid polymeric material” means a polymeric material comprising monomers with inorganic and organic components. An inorganic-organic hybrid polymer is obtained by a polymerization reaction between monomers having an inorganic group and an organic group. An inorganic-organic hybrid polymer is not a nanocomposite material comprising separate inorganic and organic constituents or phases, for example, inorganic particulates dispersed within an organic matrix. More specifically, suitable materials for an optically transparent polymeric (OTP) hard-coat layer include, but are not limited to, a polyimide, a polyethylene terephthalate (PET), a polycarbonate (PC), a poly methyl methacrylate (PMMA), organic polymer materials, inorganic-organic hybrid polymeric materials, and aliphatic or aromatic hexafunctional urethane acrylates. In aspects, an OTP hard-coat layer may consist essentially of an organic polymer material, an inorganic-organic hybrid polymeric material, or aliphatic or aromatic hexafunctional urethane acrylate. In aspects, an OTP hard-coat layer may consist of a polyimide, an organic polymer material, an inorganic-organic hybrid polymeric material, or aliphatic or aromatic hexafunctional urethane acrylate. In aspects, an OTP hard-coat layer may include a nanocomposite material. In aspects, an OTP hard-coat layer may include a nano-silicate and at least one of epoxy or urethane materials. Suitable compositions for such an OTP hard-coat layer are described in U.S. Pat. Pub. No. 2015/0110990, which is hereby incorporated by reference in its entirety by reference thereto. As used herein, “organic polymer material” means a polymeric material comprising monomers with only organic components. In aspects, an OTP hard-coat layer may comprise an organic polymer material manufactured by Gunze Limited and having a hardness of 9H, for example Gunze's “Highly Durable Transparent Film.” As used herein, “inorganic-organic hybrid polymeric material” means a polymeric material comprising monomers with inorganic and organic components. An inorganic-organic hybrid polymer is obtained by a polymerization reaction between monomers having an inorganic group and an organic group. An inorganic-organic hybrid polymer is not a nanocomposite material comprising separate inorganic and organic constituents or phases, for example, inorganic particulates dispersed within an organic matrix. In aspects, the inorganic-organic hybrid polymeric material may include polymerized monomers comprising an inorganic silicon-based group, for example, a silsesquioxane polymer. A silsesquioxane polymer may be, for example, an alkyl-silsesquioxane, an aryl-silsesquioxane, or an aryl alkyl-silsesquioxane having the following chemical structure: (RSiO_{1.5})ₙ, where R is an organic group for example, but not limited to, methyl or phenyl. In aspects, an OTP hard-coat layer may comprise a silsesquioxane polymer combined with an organic matrix, for example, SILPLUS manufactured by Nippon Steel Chemical Co., Ltd. In aspects, an OTP hard-coat layer may comprise 90 wt % to 95 wt % aromatic hexafunctional urethane acrylate, e.g., PU662NT (Aromatic hexafunctional urethane acrylate) manufactured by Miwon Specialty Chemical Co.) and 10 wt % to 5 wt % photo-initiator (e.g., Darocur 1173 manufactured by Ciba Specialty Chemicals Corporation) with a hardness of 8H or more. In aspects, an OTP hard-coat layer composed of an aliphatic or aromatic hexafunctional urethane acrylate may be formed as a stand-alone layer by spin-coating the layer on a polyethylene terephthalate (PET) substrate, curing the urethane acrylate, and removing the urethane acrylate layer from the PET substrate.

In aspects, the glass article 350 and/or 511 can comprise one or more compressive stress regions. In aspects, a compressive stress region may be created by chemically strengthening. Chemically strengthening may comprise an ion exchange process, where ions in a surface layer are replaced by—or exchanged with—larger ions having the same valence or oxidation state. Without wishing to be bound by theory, chemically strengthening the glass article can enable good impact resistance, good puncture resistance, and/or higher flexural strength. A compressive stress region may extend into a portion of glass article for a depth called the depth of compression (DOC). As used herein, depth of compression means the depth at which the stress in the chemically strengthened glass articles described herein changes from compressive stress to tensile stress. Depth of compression can be measured by a surface stress meter or a scattered light polariscope (SCALP, wherein values reported herein were made using SCALP-5 made by Glasstress Co., Estonia) depending on the ion exchange treatment and the thickness of the glass article being measured. Where the stress in the glass article is generated by exchanging potassium ions into the substrate, a surface stress meter, for example, the FSM-6000 (Orihara Industrial Co., Ltd. (Japan)), is used to measure depth of compression. Unless specified otherwise, compressive stress (including surface CS) is measured by surface stress meter (FSM) using commercially available instruments, for example the FSM-6000, manufactured by Orihara. Surface stress measurements rely upon the accurate measurement of the stress optical coefficient (SOC), which is related to the birefringence of the glass. Unless specified otherwise, SOC is measured according to Procedure C (Glass Disc Method) described in ASTM standard C770-16, entitled “Standard Test Method for Measurement of Glass Stress-Optical Coefficient,” the contents of which are incorporated herein by reference in their entirety. Where the stress is generated by exchanging sodium ions into the glass article, and the glass article is thicker than about 400 μm, SCALP is used to measure the depth of compression and central tension (CT). Where the stress in the glass article is generated by exchanging both potassium and sodium ions into the glass article, and the article being measured is thicker than about 400 μm, the depth of compression and CT are measured by SCALP. Without wishing to be bound by theory, the exchange depth of sodium may indicate the depth of compression while the exchange depth of potassium ions may indicate a change in the magnitude of the compressive stress (but not the change in stress from compressive to tensile). The refracted near-field (RNF; the RNF method is described in U.S. Pat. No. 8,854,623, entitled “Systems and methods for measuring a profile characteristic of a glass sample”, which is incorporated herein by reference in its entirety) method also may be used to derive a graphical representation of the stress profile. When the RNF method is utilized to derive a graphical representation of the stress profile, the maximum central tension value provided by SCALP is utilized in the RNF method. The graphical representation of the stress profile derived by RNF is force balanced and calibrated to the maximum central tension value provided by a SCALP measurement. As used herein, “depth of layer” (DOL) means the depth that the ions have exchanged into the glass article (e.g., sodium, potassium). Throughout the disclosure, DOL is measured in accordance with ASTM C-1422. Without wishing to be bound by theory, a DOL is usually greater than or equal to the corresponding DOC. Through the disclosure, when the maximum central tension cannot be measured directly by SCALP (as when the article being measured is thinner than about 400 μm) the maximum central tension can be approximated by a product of a maximum compressive stress and a depth of compression divided by the difference between the thickness of the glass article and twice the depth of compression, wherein the compressive stress and depth of compression are measured by FSM.

In aspects, the glass article 350 and/or 511 can comprise a first compressive stress region extending to a first depth of compression from the first major surface 332 and/or 513. In aspects, the glass article 350 and/or 511 can comprise a second compressive stress region extending to a second depth of compression from the second major surface 330 and/or 515. In aspects, the first depth of compression and/or the second depth of compression as a percentage of the thickness 337 and/or 517 can be about 5% or more, about 10% or more, about 12% or more, about 15% or more, about 30% or less, about 25% or less, about 22% or less, about 20% or less, about 17% or less, or about 15% or less. In aspects, the first depth of compression and/or the second depth of compression as a percentage of the thickness 337 and/or 517 can be in a range from about 5% to about 30%, from about 10% to about 25%, from about 10% to about 22%, from about 12% to about 20%, from about 12% to about 17%, from about 15% to about 17%, or any range or subrange therebetween. In aspects, the first depth of compression and/or the second depth of compression can be about 10 μm or more, about 20 μm or more, about 30 μm or more, about 40 μm or more, about 50 μm or more, about 60 μm or more, about 500 μm or less, about 200 μm or less, about 150 μm or less, about 100 μm or less, about 90 μm or less, or about 80 μm or less. In aspects, the first depth of compression and/or the second depth of compression can be in a range from about 10 μm to about 500 μm, from about 20 μm to about 200 μm, from about 30 μm to about 150 μm, from about 40 μm to about 100 μm, from about 50 μm to about 90 μm, from about 60 μm to about 80 μm, or any range or subrange therebetween.

In aspects, the glass article 350 and/or 511 can comprise a first depth of layer of one or more alkali-metal ions associated with the first compressive stress region, and/or the glass article 350 and/or 511 can comprise a second depth of layer of one or more alkali-metal ions associated with the second compressive stress region and the second depth of compression. As used herein, the one or more alkali-metal ions of a depth of layer of one or more alkali-metal ions can include sodium, potassium, rubidium, cesium, and/or francium. In aspects, the one or more alkali ions of the first depth of layer of the one or more alkali ions and/or the second depth of layer of the one or more alkali ions comprises potassium. In aspects, the first depth of layer and/or the second depth of layer, as a percentage of the thickness 517, can be about 1% or more, about 5% or more, about 10% or more, about 12% or more, about 15% or more, about 25% or less, about 20% or less, about 17% or less, about 15% or less, or about 10% or less. In aspects, the first depth of layer and/or the second depth of layer, as a percentage of the thickness 517, can be in a range from about 1% to about 25%, from about 5% to about 20%, from about 10% to about 17%, from about 12% to about 15%, or any range or subrange therebetween. In aspects, the first depth of layer of the one or more alkali-metal ions and/or the second depth of layer of the one or more alkali-metal ions can be about 1 μm or more, about 10 μm or more, about 15 μm or more, about 20 μm or more, about 25 μm or more, about 30 μm or more, about 200 μm or less, about 150 μm or less, about 100 μm or less, about 60 μm or less, about 45 μm or less, about 30 μm or less, or about 20 μm or less. In aspects, the first depth of layer of the one or more alkali-metal ions and/or the second depth of layer of the one or more alkali-metal ions can be in a range from about 1 μm to about 200 μm, from about 1 μm to about 150 μm, from about 10 μm to about 100 μm, from about 15 μm to about 600 μm, from about 20 μm to about 45 μm, from about 20 μm to about 30 μm, or any range or subrange therebetween.

In aspects, the first compressive stress region can comprise a maximum first compressive stress, and/or the second compressive stress region can comprise a maximum second compressive stress. In further aspects, the maximum first compressive stress and/or the maximum second compressive stress can be about 100 MegaPascals (MPa) or more, about 300 MPa or more, 400 MPa or more, about 500 MPa or more, about 600 MPa or more, about 700 MPa or more, about 1,500 MPa or less, about 1,200 MPa or less, about 1,000 MPa or less, or about 800 MPa or less. In further aspects, the maximum first compressive stress and/or the maximum second compressive stress can be in a range from about 100 MPa to about 1,500 MPa, from about 300 MPa to about 1,200 MPa, from about 400 MPa to about 1,000 MPa, from about 500 MPa to about 1,000 MPa, from about 600 MPa to about 900 MPa, from about 700 MPa to about 800 MPa, or any range or subrange therebetween.

In aspects, the glass article 350 and/or 511 can comprise a tensile stress region. In further aspects, the tensile stress region can be positioned between the first compressive stress region and the second compressive stress region. In further aspects, the tensile stress region can comprise a maximum tensile stress. In even further aspects, the maximum tensile stress can be about 10 MPa or more, about 30 MPa or more, about 50 MPa or more, about 60 MPa or more, about 80 MPa or more, about 250 MPa or less, about 200 MPa or less, about 100 MPa or less, about 80 MPa or less, or about 60 MPa or less. In even further aspects, the maximum tensile stress can be in a range from about 10 MPa to about 250 MPa, from about 30 MPa to about 200 MPa, from about 50 MPa to about 100 MPa, from about 60 MPa to about 80 MPa, or any range or subrange therebetween.

In aspects, the glass article 350 and/or 511 comprises an average transmittance over the wavelength range from 400 nm to 750 nm of 10% or more, about 15% or more, 20% or more, about 25% or more, about 30% or more, 40% or more, 60% or more, 70% or more, 75% or more, 80% or more, 82% or more, 85% or more, 87% or more, 92% or less, 91% or less, 90% or less, 89% or less, 88% or less, 87% or less 86% or less, 85% or less, 80% or less, 75% or less, or 70% or less. In aspects, the glass article 350 and/or 511 comprises an average transmittance over the wavelength range from 400 nm to 750 nm from 10% to 92%, from 15% to 92%, from 20% to 91%, from 20% to 91%, from 25% to 91%, from 30% to 90%, from 40% to 90%, from 60% to 89%, from 70% to 88%, from 75% to 87%, from 80% to 86%, from 82% to 85%, or any range or subrange therebetween.

In aspects, the color exhibited by glass article 350 and/or 511 can correspond to at least one 10 nm band with lower transmittance than the average transmittance over the visible spectrum (e.g., from 380 nm to 750 nm). In aspects, the glass article 350 and/or 511 can exhibit a total transmittance of at least one 10 nm band within the wavelength range of 380 nm to 750 nm that is 3% or more, 5% or more, 8% or more, 10% or more, 20% or more, 40% or more 50% or more, 60% or more, 70% or more, 80% or less, 78% or less, 75% or less, 72% or less, 70% or less, 68% or less, or 65% or less. In aspects, the glass article 350 and/or 511 can exhibit a total transmittance of at least one 10 nm band within the wavelength range of 380 nm to 750 nm in range from 3% to 80%, from 5% to 78%, from 8% to 75%, from 10% to 72%, from 20% to 70%, from 40% to 68%, from 50% to 65%, or any range or subrange therebetween.

In aspects, the glass article 350 and/or 511 can comprise a CIE L* value of 50 or more, 70 or more, 75 or more, 85 or more, 90 or more, 96.5 or less, 96 or less, 95 or less, 94 or less, 93 or less, or 92 or less. In aspects, the glass article 350 and/or 511 can comprise a CIE L* value from 50 to 96.5, from 70 to 96, 75 to 95, 75 to 94, 85 to 93, 90 to 92, or any range or subrange therebetween. Providing a CIE L* value from 50 to 96.5 can provide an aesthetically pleasing, bright color of the glass article. Without wishing to be bound by theory, it is believed that glasses having CIELAB color coordinates within the range of CIE L* values from 50 to 96.5 are transparent to wavelengths of visible light (i.e., wavelengths of light from 380 nm to 750 nm, inclusive of endpoints) rather than opaque while still provided a noticeable color. Glass articles with a CIE L* value greater than 96.5 may appear as colorless.

In aspects, the glass article 350 and/or 511 can comprise an absolute value of a CIE a* (i.e., |a*|) value of 0.3 or more, 0.5 or more, 0.8 or more, 1 or more, 3 or more, 5 or more, 10 or more, 15 or more, 18 or more, 20 or more, 25 or more, or 30 or more. In aspects, the CIE a* value can be about −35 or more, −20 or more, −18 or more, −15 or more, −10 or more, −5 or more, −3 or more, −1 or more, 0.3 or more, 0.5 or more, 0.8 or more, 1 or more, 5 or more, 8 or more, 10 or more, 18 or more, 20 or more, 25 or more, 65 or less, 40 or less, 25 or less, 18 or less, 10 or less, 8 or less, 5 or less, 3 or less, 1 or less, −0.3 or more, −0.5 or more, −0.8 or more, −1 or less, −3 or less, −5 or less, −8 or less, −10 or less, −15 or less, −18 or less, −20 or less, or −25 or less. In aspects, the CIE a* value (excluding values from −0.3 to 0.3) can range from about −35 to 65, from −20 to 40, from −18 to 25, from −15 to 20, from −10 to 18, from −5 to 10, from −3 to 5, from −1 to 3, from −0.8 to 1, or any range or subrange therebetween. For example, the CIE a* value (excluding value from −0.3 to 0.3) can range from −35 to 60, −20 to 60, −10 to 25, from −5 to 25, or any range or subrange therebetween. Alternatively, the CIE a* value can range from −35 to −0.3, from −18 to −0.3, from −15 to −0.3, from −10 to −0.3, from −8 to −0.5, from −5 to −1, or any range or subrange therebetween. Alternatively, the CIE a* value can range from 0.3 to 65, from 0.3 to 25, from 0.3 to 18, from 0.3 to 10, from 0.5 to 8, from 1 to 5, or any range or subrange therebetween. In aspects, the CIE a* value can be about −3 or less, for example, in a range from about −35 to about −3, from about −20 to about −3, from about −18 to about −3, from about −15 to about −3, from about −10 to about −5, or any range or subrange therebetween.

In aspects, the glass article 350 and/or 511 can comprise an absolute value of a CIE b* (i.e., |b*|) value of 0.2 or more, 0.3 or more, 0.5 or more, 1 or more, 3 or more, 5 or more, 8 or more, 10 or more, 20 or more, 50 or more, 70 or more, or 80 or more. In aspects, the CIE b* value can be −90 or more, −85 or more, −75 or more, −50 or more, −35 or more, −20 or more, −5 or more, −1 or more, 0.2 or more, 0.3 or more, 0.5 or more, 1 or more, 3 or more, 5 or more, 8 or more, 10 or more, 20 or more, 50 or more, 70 or more, 120 or less, 90 or less, 82 or less, 75 or less, 50 or less, 35 or less, 20 or less, 8 or less, 5 or less, −0.2 or less, −0.3 or less, −0.5 or less, −1 or less, −5 or less, −10 or less, −20 or less, −35 or less, −50 or less, or −70 or less. In aspects, the CIE b* value (excluding from −0.2 to 0.2) can range from −90 to 120, from −85 to 75, from −50 to 50, from −35 to 35, from −20 to 20, from −5 to 8, from −1 to 5, from 0.2 to 3, from 0.3 to 1, or any range or subrange therebetween. For example, the CIE b* value can range from −20 to 5, from −10 to 5, from −5 to 5, from −5 to 3, from −5 to 1, from −5 to −0.2, from −3 to −0.3, from −1 to −0.5, or any range or subrange therebetween. Alternatively, the CIE b* value can range from 0.2 to 90, from 0.5 to 82, from 1 to 75, from 1 to 20, from 1 to 5, or any range or subrange therebetween. Alternatively, the CIE b* value can range from −90 to −0.2, from −85 to −0.5, from −20 to −1, from −10 to −1, from −1 to −5, or any range or subrange therebetween. In aspects, the CIE b* value can be about 5 or more, for example, in a range from about 5 to about 120, from about 5 to about 90, from about 5 to about 75, from about 5 to about 50, from about 5 to about 35, from about 5 to about 25, from about 5 to about 20, from about 5 to about 8, or any range or subrange therebetween.

As used herein, a “molar ratio” of the multi-valent colorant in the glass article refers to an amount of the multi-valent colorant in the reduced form divided by a total amount of the multivalent colorant (i.e., the sum of the amount of the multi-valent colorant in the reduced form and the sum of the amount of the multi-valent colorant in the oxidized form). As used herein, the oxidized form has a higher oxidation state corresponding to fewer electrons than the reduced form. For example, chromium can exist as Cr³⁺ and Cr⁶⁺, where Cr⁶⁺ is the oxidized form and Cr³⁺ is the reduced form. Also, as discussed above, as used herein, a multi-valent colorant comprises at least two oxidation states where the oxidation state of the colorant is non-zero and two or more of the at least two oxidation states exhibit a color, as measured by absorbance from 400 nm to 750 nm or CIE a* and/or b* values. The molar ratio can be determined through X-ray photoelectron spectroscopy (XPS) or through correlation of the transmittance or absorbance spectrum with known reference samples.

In aspects, a molar ratio of the multi-valent colorant in the glass article can be about 0.1 or more, about 0.2 or more, about 0.3 or more, about 0.4 or more, about 0.5 or more, about 0.55 or more, about 0.6 or more, about 0.7 or more, about 0.9 or less, about 0.8 or less, about 0.75 or less, about 0.7 or less, about 0.65 or less, about 0.6 or less, about 0.5 or less, or about 0.4 or less. In aspects, the molar ratio of the multi-valent colorant in the glass article can range from about 0.1 to about 0.9, from about 0.2 to about 0.9, from about 0.3 to about 0.9, from about 0.4 to about 0.9, from about 0.5 to about 0.9, from about 0.55 to about 0.8, from about 0.6 to about 0.75, from about 0.6 to about 0.7, from about 0.6 to about 0.65, or any range or subrange therebetween. Alternatively, in aspects, the molar ratio of the multi-valent colorant can range from about 0.3 to about 0.9, from about 0.4 to about 0.8, from about 0.5 to about 0.75, from about 0.5 to about 0.7, from about 0.5 to about 0.65, from about 0.5 to about 0.6, or any range or subrange therebetween. Controlling the molar ratio of the multi-valent colorant can enable the glass article to reliably produce a predetermined color (e.g., CIE color coordinates). Controlling the molar ratio of the multi-valent colorant can increase a color gamut and/or a resolution of the colors obtained for a predetermined colorant package including the multi-valent colorant.

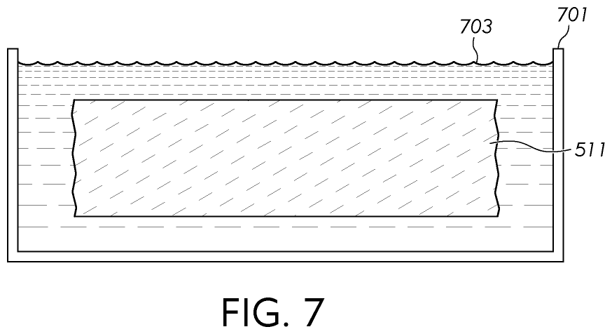

Aspects of methods of making the glass article and/or natively colored glass housing in accordance with aspects of the disclosure will be discussed with reference to the flow chart in FIG. 6 and example method step illustrated in FIG. 7.

In a first step 601 of methods of the disclosure, methods can start with obtaining raw materials for the glass article and/or natively colored glass article, which can be obtained, for example, by purchase or otherwise obtaining the raw materials.

After step 601, methods can proceed to step 603 comprising melting together the raw materials to form a glass article. The precursor materials comprise at least one multi-valent colorant. Amounts of the raw materials (e.g., mol % on an oxide basis, and/or wt %) can be within one or more of the ranges discussed above for the composition of the glass article. In aspects, one or more of the raw materials can modify a molar ratio of the multi-valent colorant in the precursor material to obtain the molar ratio of the multi-valent colorant in the glass article. For example, the precursor materials can comprise a source of iron (e.g., Fe₂O₃), a source of zinc (e.g., ZnO), and/or a source of antimony (e.g., Sb₂O₃), which can be configured to increase the redox ratio of the multi-valent colorant. In aspects, the precursor materials can comprise 0.02 wt % or more of a source of iron, zinc, or a combination thereof. In further aspects, the amount of iron in the precursor materials can be within one or more of the ranges discussed above for the amount of iron (e.g., Fe₂O₃) in the glass article. In further aspects, the amount of iron (e.g., Fe₂O₃) in the precursor materials can be about 200 ppm or more, about 250 ppm or more, about 300 ppm or more, about 350 ppm or more, about 400 ppm or more, about 600 ppm or more, about 800 ppm or more, about 1,000 ppm or more, about 1,500 ppm or less, about 1,300 ppm or less, 1,000 ppm or less, about 800 ppm or less, about 600 ppm or less, about 550 ppm or less, about 500 ppm or less, about 450 ppm or less, or about 400 ppm or less. In further aspects, the amount of iron (e.g., Fe₂O₃) in the precursor materials can range from about 200 ppm to about 1,500 ppm, from about 250 ppm to about 1,300 ppm, from about 300 ppm to about 1,300 ppm, from about 300 ppm to about 1,000 ppm, from about 350 ppm to about 800 ppm, from about 350 ppm to about 600 ppm, from about 400 ppm to about 550 ppm or less, from about 400 ppm to about 500 ppm, or any range or subrange therebetween. In further aspects, the amount of zinc (e.g., ZnO) in the precursor materials can be within one or more of the ranges discussed above for the amount of zinc (e.g., ZnO) in the glass article. In further aspects, the amount of zinc (e.g., ZnO) in the precursor materials can be about 0.2 wt % or more, about 0.25 wt % or more, about 0.4 wt % or more, about 0.5 wt % or more, about 0.6 wt % or less, about 1.5 wt % or less, about 1 wt % or less, about 0.8 wt % or less, about 0.7 wt % or less, or about 0.5 wt % or less. In further aspects, the amount of zinc (e.g., ZnO) in the precursor materials can range from about 0.2 wt % to about 1.5 wt %, from about 0.25 wt % to about 1 wt %, from about 0.4 wt % to about 0.8 wt %, from about 0.5 wt % to about 0.7 wt %, or any range or subrange therebetween. In aspects, an amount of antimony (e.g., Sb₂O₃) in the precursor materials can be within one or more of the ranges discussed above for the amount of antimony (e.g., Sb₂O₃) in the glass article. In aspects, the amount of antimony (e.g., Sb₂O₃) in the precursor materials can be about 0.005 wt % or more, about 0.01 wt % or more, about 0.02 wt % or more, about 0.05 wt % or more, about 0.1 wt % or more, about 0.2 wt % or more, about 1 wt % or less, about 0.5 wt % or less, about 0.4 wt % or less, about 0.3 wt % or less, about 0.2 wt % or less, or about 0.1 wt % or less. In aspects, the amount of antimony (e.g., Sb₂O₃) in the glass article can range from about 0.005 wt % to about 1 wt %, from about 0.01 wt % to about 0.5 wt %, from about 0.02 wt % to about 0.4 wt %, from about 0.05 wt % to about 0.3 wt %, from about 0.1 wt % to about 0.2 wt %, or any range or subrange therebetween.

In aspects, the precursor materials melted together in step 603 can include components that volatilize during step 603 but can change the molar ratio of the multi-valent colorant. In further aspects, the precursor materials can comprise a source of sulfate, a source of carbon, a source of nitrate, or combinations thereof. For example, the source of carbon can be graphite, charcoal, or carbon black; the source of nitrate can be an alkali metal nitrate (e.g., NaNO₃, KNO₃); and/or the source of sulfate can be an alkali metal sulfate (e.g., Na₂SO₄, K₂SO₄). In further aspects, an amount of the source of sulfate in the precursor materials can be about 0.01 wt % or more, about 0.02 wt % or more, about 0.05 wt % or more, about 0.1 wt % or more, about 0.15 wt % or more, about 0.2 wt % or more, about 1 wt % or less, about 0.5 wt % or less, about 0.3 wt % or less, about 0.25 wt % or less, or about 0.2 wt % or less. In further aspects, an amount of the source of sulfate in the precursor materials can range from about 0.01 wt % to about 1 wt %, from about 0.02 wt % to about 1 wt %, from about 0.05 wt % to about 0.5 wt %, from about 0.1 wt % to about 0.3 wt %, from about 0.15 wt % to about 0.25 wt %, from about 0.2 wt % to about 0.25 wt %, or any range or subrange therebetween. In further aspects, an amount of the source of carbon in the precursor materials can be about 0.001 wt % or more, about 0.004 wt % or more, about 0.006 wt % or more, about 0.01 wt % or more, about 0.02 wt % or more, about 0.1 wt % or less, about 0.05 wt % or less, about 0.04 wt % or less, about 0.03 wt % or less, about 0.02 wt % or less, or about 0.01 wt % or less. In further aspects, an amount of the source of carbon in the precursor materials can range from about 0.001 wt % to about 0.1 wt %, from about 0.004 wt % to about 0.05 wt %, from about 0.006 wt % to about 0.04 wt %, from about 0.01 wt % to about 0.03 wt %, or any range or subrange therebetween. In further aspects, an amount of the source of nitrate in the precursor materials can be about 0.05 wt % or more, about 0.1 wt % or more, about 0.2 wt % or more, about 0.3 wt % or more, about 0.5 wt % or more, about 1 wt % or more, about 5 wt % or less, about 3 wt % or less, about 2 wt % or less, about 1 wt % or less, about 0.8 wt % or less, or about 0.5 wt % or less. In further aspects, an amount of the source of nitrate in the precursor materials can range from about 0.05 wt % to about 5 wt %, from about 0.1 wt % to about 3 wt %, from about 0.2 wt % to about 2 wt %, from about 0.3 wt % to about 1 wt %, from about 0.4 wt % to about 0.8 wt %, or any range or subrange therebetween.

In aspects, step 603 can comprise exposing the melted precursor materials to an oxidizing environment, which will decrease the molar ratio of the multi-valent colorant by increasing the amount of the multi-valent colorant that is oxidized. For example, the oxidizing environment can comprise a greater partial pressure of oxygen than is found in air. In further aspects, the melted precursor materials can be exposed to an environment comprising a partial pressure of oxygen of about 25 kiloPascals (kPa) or more, about 30 kPa or more, about 35 kPa or more, about 40 kPa or more, about 50 kPa or more, about 100 kPa or less, about 80 kPa or less, about 70 kPa or less, about 60 kPa or less, about 50 kPa or less, about 45 kPa or less, or about 40 kPa or less. In further aspects, the melted precursor materials can be exposed to an environment comprising a partial pressure of oxygen can range from about 25 kPa to about 100 kPa, from about 30 kPa to about 80 kPa, from about 35 kPa to about 70 kPa, from about 40 kPa to about 60 kPa, from about 40 kPa to about 50 kPa, or any range or subrange therebetween.

In aspects, the glass article can be formed from the melted precursor materials in step 603 by forming the glass article with a variety of ribbon forming processes, for example, slot draw, down-draw, fusion down-draw, up-draw, press roll, redraw, or float. In further aspects, methods can proceed to step 607 (arrow 602) or step 611 (arrow 604) after the glass article is formed in step 603.

In aspects, after step 603, methods can proceed to step 605 comprising controlling a temperature of the melted precursor materials and/or a rate of change of the temperature of the melted precursor materials in forming the glass article from the melted precursor materials. The melted precursor materials can be heated to a first temperature that is about 1500° C. or more to form a melt. In further aspects, the melt can be cooled at a predetermined rate from the first temperature. In even further aspects, the melt can be quickly cooled (e.g., quenched, greater than 20° C./minute, or greater than 50° C./minute) from the first temperature to a temperature below 1400° C. (e.g., below the liquidus temperature), which can prevent subsequent changes to the molar ratio of the multi-valent colorant. In even further aspects, the predetermined rate from the first temperature to about 1400° C. or less can be about 0.1° C./minute (° C./min) or more, about 0.3° C./min or more, about 0.5° C./min, about 0.8° C./min or more, about 1° C./min or more, about 1.5° C./min or more, about 2° C./min or more, about 5° C./min or more, about 10° C./min or less, about 5° C./min or less, about 2° C./min or less, about 1.8° C./min or less, about 1.5° C./min or less, about 1.2° C./min or less, or about 1° C./min or less. In even further aspects, the predetermined rate from the first temperature to about 1400° C. or less can range from about 0.1° C./min to about 10° C./min, from about 0.3° C./min to about 5° C./min, from about 0.5° C./min to about 2° C./min, from about 0.8° C./min to about 1.8° C./min, from about 1° C./min to about 1.5° C./min, from about 1° C./min to about 1.2° C./min, or any range or subrange therebetween. Cooling the melt at a predetermined rate within the above-mentioned ranges can decrease the molar ratio of the multi-valent colorant. In further aspects, the glass article can be formed from the melt in step 605 by forming the glass article with a variety of ribbon forming processes, for example, slot draw, down-draw, fusion down-draw, up-draw, press roll, redraw, or float.

After step 603 or 605, as shown in FIG. 6, methods can proceed to step 607 comprising chemically strengthening the glass article. In aspects, as shown, step 607 can comprise contacting at least a portion of the glass article 511 with a molten salt solution 703 (e.g., contained in a bath 701). For example, as shown, the glass article 511 can be immersed in the molten salt solution 703 contained in the bath 701. In aspects, step 607 can develop the first compressive stress region, the second compressive stress region, and/or the tensile stress region discussed above and the corresponding region can comprise a maximum stress and/or depth of compression within one or more of the corresponding ranges discussed above. In aspects, the molten salt solution comprises sodium and/or potassium ions (e.g., from KNO₃ and/or NaNO₃). In aspects, the temperature of the molten salt solution 703 can be about 300° C. or more, about 360° C. or more, about 400° C. or more, about 500° C. or less, about 460° C. or less, or about 420° C. or less. In aspects, the temperature of the molten salt solution 703 can be in a range from about 300° C. to about 500° C., from about 360° C. to about 460° C., from about 400° C. to about 420° C., or any range or subrange therebetween. In aspects, the glass article 511 can be in contact with the molten salt solution 703 for about 30 minutes or more, about 45 minutes or more, about 1 hour or more, about 8 hours or less, about 4 hours or less, about 2 hours or less, or about 1.5 hours or less. In aspects, the glass article 511 can be in contact with the molten salt solution 703 for a time in a range from about 30 minutes to about 8 hours, from about 45 minutes to about 4 hours, from about 1 hour to about 2 hours, from about 1 hour to about 1.5 hours, or any range or subrange therebetween.

After step 607, methods can proceed to step 609 comprising assembling the glass article 511 into a natively colored glass housing, an electronic device (e.g., consumer electronic device). In aspects, step 609 can comprise disposing and/or attaching the glass article to the reflector (e.g., in a natively colored glass housing).

After step 605, 607, or 609, methods can be complete upon reaching step 611. In aspects, methods of making a glass article and/or a natively colored glass housing in accordance with aspects of the disclosure can proceed along steps 601, 603, 605, 607, 609, and 611 of the flow chart in FIG. 6 sequentially, as discussed above. In aspects, methods can follow arrow 602 from step 603 to step 607, for example, if the glass article is formed from melted precursor materials without the thermal treatment of step 605. In aspects, methods can follow arrow 604 from step 603 to step 611, for example if methods are complete at the end of step 603. In aspects, methods can follow arrow 606 from step 605 to step 611, for example, if methods are complete at the end of step 605. In aspects, methods can follow arrow 608 from step 607 to step 611, for example, methods are complete at the end of step 607. Any of the above options may be combined to make a foldable apparatus in accordance with the embodiments of the disclosure.

In aspects, the glass article can exhibit CIE L*, a*, and/or b* values within one or more of the corresponding ranges discussed above. The glass article is a silicate glass with the multi-valent colorant. In further aspects, the multi-valent colorant can be cerium, titanium, chromium, cobalt, copper, nickel, vanadium, or combinations thereof. In even further aspects, the multi-valent colorant can be cerium, chromium, titanium, or combinations thereof. The glass article can comprise a molar ratio of the multi-valent colorant within one or more of the corresponding ranges discussed above.

The multi-valent colorant of the precursor materials comprises a precursor molar ratio defined as an amount of the reduced form of the multi-valent colorant in the precursor materials divided by a total amount of the multi-valent colorant (i.e., the sum of the amount of the multi-valent colorant in the reduced form in the precursor materials and the sum of the amount of the multi-valent colorant in the oxidized form in the precursor materials). In aspects, the precursor molar ratio of the multi-valent colorant of the precursor materials can be about 0.1 or more, about 0.2 or more, about 0.3 or more, about 0.4 or more, about 0.5 or more, about 0.55 or more, about 0.6 or more, about 0.7 or more, about 0.9 or less, about 0.8 or less, about 0.75 or less, about 0.7 or less, about 0.65 or less, about 0.6 or less, about 0.5 or less, or about 0.4 or less. In aspects, the precursor molar ratio of the multi-valent colorant in the precursor materials can range from about 0.1 to about 0.9, from about 0.2 to about 0.9, from about 0.3 to about 0.9, from about 0.4 to about 0.9, from about 0.5 to about 0.9, from about 0.55 to about 0.8, from about 0.6 to about 0.75, from about 0.6 to about 0.7, from about 0.6 to about 0.65, or any range or subrange therebetween. Alternatively, in aspects, the molar ratio of the multi-valent colorant can range from about 0.3 to about 0.9, from about 0.4 to about 0.8, from about 0.5 to about 0.75, from about 0.5 to about 0.7, from about 0.5 to about 0.65, from about 0.5 to about 0.6, or any range or subrange therebetween.

In aspects, the precursor molar ratio of the multi-valent colorant in the precursor materials can be different than the molar ratio of the multi-valent colorant in the glass article. In further aspects, an absolute value of a difference between the precursor molar ratio of the multi-valent colorant in the precursor materials and the molar ratio of the multi-valent colorant in the glass article can be about 0.1 or more, about 0.15 or more, about 0.2 or more, about 0.25 or more, about 0.3 or more, about 0.5 or less, about 0.45 or less, about 0.4 or less, about 0.35 or less, about 0.3 or less, about 0.25 or less, or about 0.2 or less. In further aspects, an absolute value of a difference between the precursor molar ratio of the multi-valent colorant in the precursor materials and the molar ratio of the multi-valent colorant in the glass article can range from about 0.1 to about 0.5, from about 0.1 to about 0.45, from about 0.15 to about 0.4, from about 0.15 to about 0.35, from about 0.2 to about 0.3, from about 0.2 to about 0.25, or any range or subrange therebetween.

In further aspects, the precursor molar ratio of the multi-valent colorant in the precursor materials can be greater than the molar ratio of the multi-valent colorant in the glass article. In even further aspects, the precursor materials can comprise a source of sulfate, nitrate, zinc (e.g., ZnO), or combinations thereof, which can decrease the molar ratio of the multi-valent colorant in the glass article relative to the precursor molar ratio of the multi-valent colorant in the precursor materials. The amount of the source of sulfate, nitrate, zinc, or combinations thereof can be about 0.02 wt %, for example, within one or more of the corresponding ranges discussed above for the amount of the corresponding material in the precursor materials. In even further aspects, the precursor materials can comprise a source of sulfate within one or more of the corresponding ranges discussed above, which can decrease the molar ratio of the multi-valent colorant in the glass article relative to the precursor molar ratio of the multi-valent colorant in the precursor materials. In even further aspects, the precursor materials can comprise a source of nitrate within one or more of the corresponding ranges discussed above, which can decrease the molar ratio of the multi-valent colorant in the glass article relative to the precursor molar ratio of the multi-valent colorant in the precursor materials. In even further aspects, the precursor materials can comprise a source of zinc within one or more of the corresponding ranges discussed above, which can decrease the molar ratio of the multi-valent colorant in the glass article relative to the precursor molar ratio of the multi-valent colorant in the precursor materials.

In further aspects, the molar ratio of the multi-valent colorant in the glass article can be greater than the precursor molar ratio of the multi-valent colorant in the precursor materials. In even further aspects, the precursor materials can comprise a source of iron (e.g., Fe₂O₃), antimony (Sb₂O₃), carbon, or combinations thereof. In still further aspects, the precursor materials can comprise 0.01 wt % or more of a source of iron (e.g., Fe₂O₃), antimony (Sb₂O₃), carbon, or combinations thereof. In even further aspects, the precursor materials can comprise antimony (e.g., Sb₂O₃) in an amount within one or more of the corresponding ranges discussed above, which can increase the molar ratio of the multi-valent colorant in the glass article relative to the precursor molar ratio of the multi-valent colorant in the precursor materials. In even further aspects, the precursor materials can comprise a source of carbon in an amount within one or more of the corresponding ranges discussed above, which can increase the molar ratio of the multi-valent colorant in the glass article relative to the precursor molar ratio of the multi-valent colorant in the precursor materials. In further aspects, the melt formed from the melted precursor materials can be cooled at a rate of 0.5° C./min or more (e.g., from 0.5° C./min to 2° C./min) can increase the molar ratio of the multi-valent colorant in the glass article relative to the precursor molar ratio of the multi-valent colorant in the precursor materials.

As discussed above, the colorant package in the glass compositions can comprise one or more multi-valent colorant and optionally one or more additional compounds that contribute to the color. For example, a concentration of NiO+Co₃O₄+Cr₂O₃+CuO+CeO₂+TiO₂ was discussed above. Within the corresponding above-mentioned ranges for this concentration as well as within other aspects of the disclosure, the following, more specific combinations are also included. In aspects, the colorant package can include more than one multi-valent colorant, for example, both TiO₂ and NiO. Providing more than one multi-valent colorant can increase the color gamut achievable with a composition, for example, by adjusting the redox ratio as discussed herein. In further aspects, the colorant package can comprise an amount of TiO₂ of about 0.001 mol % or more, about 0.005 mol % or more, about 0.01 mol % or more, about 0.05 mol % or more, about 0.1 mol % or more, about 0.5 mol % or more, about 1.0 mol % or more, about 1.2 mol % or more, about 1.5 mol % or more, about 2.0 mol % or less, about 1.8 mol % or less, about 1.4 mol % or less, about 1.0 mol % or less, about 0.6 mol % or less, about 0.4 mol % or less, about 0.2 mol % or less, about 0.1 mol % or less, or about 0.04 mol % or less. In further aspects, the colorant package can comprise an amount of TiO₂ in a range from about 0.001 mol % to about 2.0 mol %, from about 0.005 mol % to about 1.8 mol %, from about 0.01 mol % to about 1.8 mol %, from about 0.05 mol % to about 1.4 mol %, from about 0.1 mol % to about 1.0 mol %, from about 0.5 mol % to about 1.0 mol %, or any range or subrange therebetween. In further aspects, the colorant package can comprise an amount of TiO₂ of about 0.5 mol % or less, for example in a range from about 0.001 mol % to about 0.4 mol %, from about 0.005 mol % to about 0.1 mol %, from about 0.01 mol % to about 0.04 mol %, or any range or subrange therebetween. In further aspects, the colorant package can comprise an amount of TiO₂ of about 0.2 mol % or more, for example in a range from about 0.2 mol % to about 2.0 mol %, from about 0.5 mol % to about 1.8 mol %, about 1.0 mol % to about 1.8 mol %, from about 1.2 mol % to about 1.4 mol %, or any range or subrange therebetween. In further aspects, the colorant package can comprise an amount of NiO of about 0.001 mol % or more, about 0.005 mol % or more, about 0.01 mol % or more, about 0.05 mol % or more, about 0.07 mol % or more, about 0.09 mol % or more, about 0.11 mol % or more, about 0.13 mol % or more, about 0.15 mol % or more, about 0.2 mol % or more, about 0.4 mol % or more, about 0.5 mol % or more, about 0.6 mol % or more, about 0.7 mol % or more, about 1.0 mol % or less, about 0.8 mol % or less, about 0.7 mol % or less, about 0.5 mol % or less, about 0.4 mol % or less, about 0.25 mol % or less, about 0.20 mol % or less, about 0.17 mol % or less, about 0.15 mol % or less, about 0.13 mol % or less, about 0.10 mol % or less, or about 0.08 mol % or less. In further aspects, the colorant package can comprise an amount of NiO in a range from about 0.001 mol % to about 1.0 mol %, from about 0.005 mol % to about 1.0 mol %, from about 0.01 mol % to about 1.0 mol %, from about 0.05 mol % to about 0.8 mol %, from about 0.07 mol % to about 0.7 mol, from about 0.09 mol % to about 0.5 mol %, from about 0.11 mol % to about 0.4 mol %, from about 0.13 mol % to about 0.25 mol %, from about 0.15 mol % to about 0.20 mol %, or any range or subrange therebetween. In further aspects, the colorant package can comprise an amount of NiO of about 0.5 mol % or less, for example, in a range from about 0.001 mol % to about 0.5 mol %, from about 0.005 mol % to about 0.5 mol %, from about 0.01 mol % to about 0.5 mol %, from about 0.05 mol % to about 0.5 mol %, from about 0.07 mol % to about 0.40 mol %, from about 0.09 mol % to about 0.25 mol %, from about 0.11 mol % to about 0.17 mol %, from about 0.13 mol % to about 0.15 mol %, or any range or subrange therebetween. In further aspects, the colorant package can comprise an amount of NiO of about 0.1 mol % or more, for example, in a range from about 0.1 mol % to about 1.0 mol %, from about 0.2 mol % to about 1.0 mol %, from about 0.4 mol % to about 1.0 mol %, from about 0.5 mol % to about 0.8 mol %, from about 0.6 mol % to about 0.7 mol %, or any range or subrange therebetween. In further aspects, the colorant package can comprise one or more of Fe₂O₃, MnO₂, or combinations thereof, which can act a redox couple to alter the redox ratio of the multi-valent colorants while not being defined as a multi-valent colorant itself within the scope of the present disclosure. In further aspects, the colorant package (in addition to TiO₂ and NiO within one or more of the corresponding ranges mentioned in this paragraph) can optionally include Fe₂O₃ in an amount of about 0.0001 mol % or more, about 0.005 mol % or more, about 0.01 mol % or more, about 0.02 mol % or more, about 0.05 mol % or more, about 0.07 mol % or more, about 0.10 mol % or more, about 0.12 mol % or more, about 1.0 mol % or less, about 0.4 mol % or less, about 0.20 mol % or less, about 0.15 mol % or less, about 0.13 mol % or less, about 0.10 mol % or less, about 0.08 mol % or less, about 0.05 mol % or less, about 0.03 mol % or less, or about 0.01 mol % or less. In further aspects, the colorant package (in addition to TiO₂ and NiO within one or more of the corresponding ranges mentioned in this paragraph) can optionally include Fe₂O₃ in a range from about 0.001 mol % to about 1.0 mol %, from about 0.001 mol % to about 0.4 mol %, from about 0.005 mol % to about 0.20 mol %, from about 0.01 mol % to about 0.15 mol %, from about 0.02 mol % to about 0.13 mol %, from about 0.05 mol % to about 0.10 mol %, from about 0.07 mol % to about 0.08 mol % or any range or subrange therebetween. In further aspects, the colorant package (in addition to TiO₂ and NiO within one or more of the corresponding ranges mentioned in this paragraph as well as optionally Fe₂O₃) can optionally include MnO₂ in an amount of 0.0001 mol % or more, about 0.0002 mol % or more, about 0.0004 mol % or more, about 0.002 mol % or more, about 0.01 mol % or more, about 0.02 mol % or more, about 0.03 mol % or more, about 0.04 mol % or more, about 0.05 mol % or more, about 0.10 mol % or more, about 0.13 mol % or more, about 0.15 mol % or more, about 0.20 mol % or less, about 0.17 mol % or less, about 0.15 mol % or less, about 0.12 mol % or less, about 0.10 mol % or less, about 0.07 mol % or less, about 0.05 mol % or less, about 0.04 mol % or less, about 0.03 mol % or less, about 0.02 mol % or less, about 0.01 mol % or less, or about 0.005 mol % or less. In further aspects, the colorant package (in addition to TiO₂ and NiO within one or more of the corresponding ranges mentioned in this paragraph as well as optionally Fe₂O₃) can optionally include MnO₂ in a range from about 0.0001 mol % to about 0.20 mol %, from about 0.0002 mol % to about 0.17 mol %, from about 0.0004 mol % to about 0.15 mol %, from about 0.002 mol % to about 0.12 mol %, from about 0.01 mol % to about 0.10 mol %, from about 0.02 mol % to about 0.07 mol %, from about 0.03 mol % to about 0.05 mol %, or any range or subrange therebetween. In further aspects, the colorant package (in addition to TiO₂ and NiO within one or more of the corresponding ranges mentioned in this paragraph as well as optionally Fe₂O₃) can optionally comprise MnO₂ in an amount of 0.01 mol % or more, for example in a range from 0.01 mol % to about 0.2 mol %, from about 0.02 mol % to about 0.17 mol %, from about 0.03 mol % to about 0.17 mol %, from about 0.04 mol % to about 0.15 mol %, from about 0.05 mol % to about 0.15 mol %, from about 0.10 mol % to about 0.12 mol %, or any range or subrange therebetween. Exemplary ranges for colorant packages discussed in this paragraph are presented in Table 1. Ranges R1-R5 comprise TiO₂ and NiO but is free of Fe₂O₃ and MnO₂. Ranges R6-R10 comprise TiO₂, NiO, and Fe₂O₃. Ranges R9-R12 comprise TiO₂, NiO, and MnO₂. While CIE L*, a*, and b* values are provided in Table 1, it is to be understood that these values are not necessarily limiting ranges R2-R5, R7-R8, R10, and/or R12, for example the CIE values for R1, R6, R10, and/or R12 can apply to any of the ranges stated in Table 1.

TABLE 1
Exemplary Ranges for Colorant Packages including TiO₂ and NiO

| | Range (mol %) | | | | |
|---|---|---|---|---|---|
| | R1 | R2 | R3 | R4 | R5 |
| TiO₂ | 0.001-2.0 | 0.001-0.05 | 0.2-2.0 | 0.001-2.0 | 0.01-0.05 |
| NiO | 0.001-1.0 | 0.001-1.0 | 0.001-1.0 | 0.05-0.5 | 0.005-0.5 |
| Fe₂O₃ | 0 | 0 | 0 | 0 | 0 |
| MnO₂ | 0 | 0 | 0 | 0 | 0 |
| L* | 70-95 | 80-90 | 88-93 | 80-90 | 88-93 |
| a* | −12-4 | 0.2-4 | 0.1-0.8 | 0.2-4 | 0.1-0.8 |
| b* | −35-35 | 25-35 | 12-18 | 25-35 | 12-18 |

| | Range (mol %) | | | |
|---|---|---|---|---|
| | R6 | R7 | R8 | R9 |
| TiO₂ | 0.001-2.0 | 0.001-0.05 | 0.2-2.0 | 0.2-2.0 |
| NiO | 5 × 10⁻⁵-1.0 | 5 × 10⁻⁵-1.0 | 5 × 10⁻⁵-0.1 | 0.1-1.0 |
| Fe₂O₃ | 0.001-0.2 | 0.001-0.2 | 0.001-0.2 | 0.001-0.2 |
| MnO₂ | 0 | 0 | 0 | 0.0001-0.2 |
| L* | 70-95 | 88-93 | 88-93 | 65-96 |
| a* | −13-4 | −12-1 | 0-0.8 | −13-4 |
| b* | −35-35 | −35-35 | 6-30 | −20-30 |

| | Range (mol %) | | |
|---|---|---|---|
| | R10 | R11 | R12 |
| TiO₂ | 0.001-2.0 | 0.001-2.0 | 0.01-0.6 |
| NiO | 0.05-0.25 | 0.05-0.25 | 0.05-0.25 |
| Fe₂O₃ | 0.05-0.13 | 0 | 0 |
| MnO₂ | 0.0002-0.01 | 0.0001-0.20 | 0.01-0.02 |
| L* | 87-93 | 65-96 | 87-93 |
| a* | 0.1-2 | −13-4 | 0.1-2 |
| b* | 10-20 | −20-30 | 10-20 |

In aspects, the colorant package can include more than one multi-valent colorant, for example, both TiO₂ and CeO₂. Providing more than one multi-valent colorant can increase the color gamut achievable with a composition, for example, by adjusting the redox ratio as discussed herein. In further aspects, the colorant package can comprise an amount of TiO₂ of about 0.001 mol % or more, about 0.005 mol % or more, about 0.01 mol % or more, about 0.02 mol % or more, about 0.05 mol % or more, about 0.1 mol % or more, about 0.5 mol % or more, about 1.0 mol % or more, about 1.1 mol % or more, about 1.2 mol % or more, about 2.0 mol % or less, about 1.5 mol % or less, about 1.2 mol % or less, about 1.0 mol % or less, about 0.6 mol % or less, about 0.04 mol % or less, about 0.2 mol % or less, about 0.1 mol % or less, or about 0.04 mol % or less. In further aspects, the colorant package can comprise an amount of TiO₂ in a range from about 0.001 mol % to about 2.0 mol %, from about 0.005 mol % to about 2.0 mol %, from about 0.01 mol % to about 1.5 mol %, from about 0.02 mol % to about 1.2 mol %, from about 0.05 mol % to about 1.0 mol %, from about 0.1 mol % to about 1.0 mol %, from about 0.5 mol % to about 1.0 mol %, or any range or subrange therebetween. In further aspects, the colorant package can comprise an amount of TiO₂ of about 0.5 mol % or less, for example in a range from about 0.001 mol % to about 0.5 mol %, from about 0.005 mol % to about 0.5 mol %, from about 0.01 mol % to about 0.4 mol %, from about 0.02 mol % to about 0.2 mol %, from about 0.05 mol % to about 0.2 mol %, or any range or subrange therebetween. In further aspects, the colorant package can comprise an amount of TiO₂ of about 0.1 mol % or more, for example in a range from about 0.1 mol % to about 2.0 mol, from about 0.5 mol % to about 1.8 mol %, from about 1.0 mol % to about 1.6 mol %, from about 1.1 mol % to about 1.4 mol %, or any range or subrange therebetween. In further aspects, the colorant package can comprise an amount of CeO₂ of about 0.001 mol % or more, about 0.005 mol % or more, about 0.01 mol % or more, about 0.1 mol % or more, about 0.2 mol % or more, about 0.5 mol % or more, about 0.6 mol % or more, about 0.7 mol % or more, about 0.8 mol % or more, about 1.0 mol % or less, about 0.8 mol % or less, about 0.7 mol % or less, about 0.6 mol % or less, about 0.5 mol % or less, about 0.4 mol % or less, about 0.3 mol % or less, about 0.2 mol % or less, about 0.1 mol % or less, about 0.05 mol % or less, or about 0.01 mol % or less. In further aspects, the colorant package can comprise an amount of CeO₂ in a range from about 0.001 mol % to about 1.0 mol %, from about 0.05 mol % to about 1.0 mol %, from about 0.1 mol % to about 1.0 mol, from about 0.2 mol % to about 0.8 mol %, from about 0.4 mol % to about 0.6 mol %, or any range or subrange therebetween. In further aspects, the colorant package can comprise an amount of CeO₂ of about 0.1 mol % or more, for example, in a range from about 0.1 mol % to about 1.0 mol %, from about 0.2 mol % to about 1.0 mol %, from about 0.5 mol % to about 0.8 mol %, from about 0.5 mol % to about 0.7 mol %, or any range or subrange therebetween. In further aspects, the colorant package can comprise one or more of Fe₂O₃, MnO₂, or combinations thereof, which can act a redox couple to alter the redox ratio of the multi-valent colorants while not being defined as a multi-valent colorant itself within the scope of the present disclosure. In further aspects, the colorant package (in addition to TiO₂ and CeO₂ within one or more of the corresponding ranges mentioned in this paragraph) can optionally include Fe₂O₃ in an amount of about 0.001 mol % or more, about 0.005 mol % or more, about 0.01 mol % or more, about 0.02 mol % or more, about 0.05 mol % or more, about 0.07 mol % or more, about 0.10 mol % or more, about 0.12 mol % or more, about 0.20 mol % or less, about 0.15 mol % or less, about 0.13 mol % or less, about 0.10 mol % or less, about 0.08 mol % or less, about 0.05 mol % or less, about 0.03 mol % or less, or about 0.01 mol % or less. In further aspects, the colorant package (in addition to TiO₂ and CeO₂ within one or more of the corresponding ranges mentioned in this paragraph) can optionally include Fe₂O₃ in a range from about 0.001 mol % to about 0.20 mol %, from about 0.005 mol % to about 0.20 mol %, from about 0.01 mol % to about 0.15 mol %, from about 0.02 mol % to about 0.13 mol %, from about 0.05 mol % to about 0.10 mol %, from about 0.07 mol % to about 0.08 mol % or any range or subrange therebetween. In further aspects, the colorant package (in addition to TiO₂ and CeO₂ within one or more of the corresponding ranges mentioned in this paragraph as well as optionally Fe₂O₃) can optionally include MnO₂ in an amount of about 0.01 mol % or more, about 0.02 mol % or more, about 0.05 mol % or more, about 0.10 mol % or more, about 0.2 mol % or more, about 0.5 mol % or more, about 0.7 mol % or more, about 0.8 mol % or more, about 1.0 mol % or less, about 0.8 mol % or less, about 0.6 mol % or less, about 0.4 mol % or less, about 0.3 mol % or less, about 0.2 mol % or less, about 0.10 mol % or less, or about 0.04 mol % or less. In further aspects, the colorant package (in addition to TiO₂ and CeO₂ within one or more of the corresponding ranges mentioned in this paragraph as well as optionally Fe₂O₃) can optionally include MnO₂ in a range from about 0.01 mol % to about 1.0 mol %, from about 0.02 mol % to about 0.8 mol %, from about 0.05 mol % to about 0.6 mol %, from about 0.10 mol % to about 0.4 mol %, from about 0.2 mol % to about 0.3 mol %, or any range or subrange therebetween. In further aspects, the colorant package (in addition to TiO₂ and CeO₂ within one or more of the corresponding ranges mentioned in this paragraph as well as optionally Fe₂O₃) can optionally comprise MnO₂ in an amount of 0.10 mol % or more, for example in a range from 0.10 mol % to about 1.0 mol %, from about 0.2 mol % to about 0.8 mol %, from about 0.5 mol % to about 0.7 mol %, from about 0.5 mol % to about 0.6 mol %, or any range or subrange therebetween. Exemplary ranges for colorant packages discussed in this paragraph are presented in Table 2. Ranges R13-R17 comprise TiO₂ and CeO₂ but is free of Fe₂O₃ and MnO₂. Ranges R18-R22 comprise TiO₂, CeO₂, and Fe₂O₃. Ranges R21-R22 comprise TiO₂, CeO₂, and MnO₂. While CIE L*, a*, and b* values are provided in Table 2, it is to be understood that these values are not necessarily limiting ranges R14-R17, R19-R20, and/or R22, for example the CIE values for R13, R18, and/or R21 can apply to any of the ranges stated in Table 2.

TABLE 2
Exemplary Ranges for Colorant Packages including TiO₂ and CeO₂

| | Range (mol %) | | | | | |
|---|---|---|---|---|---|---|
| | R13 | R14 | R15 | R16 | R17 | R18 |
| TiO₂ | 0.001-2.0 | 0.1-1.0 | 0.005-0.5 | 0.1-1.0 | 0.005-0.05 | 0.001-2.0 |
| CeO₂ | 0.001-1.0 | 0.001-1.0 | 0.001-1.0 | 0.001-1.0 | 0.1-1.0 | 0.01-1.0 |
| Fe₂O₃ | 0 | 0 | 0 | 0 | 0 | 0.001-0.2 |
| MnO₂ | 0 | 0 | 0 | 0 | 0 | 0 |
| L* | 80-96 | 80-94 | 90-94 | 80-96 | 80-94 | 80-96 |
| a* | −6-5 | −1-5 | −1-−0.01 | 0.01-5 | −6-5 | −1-5 |
| b* | −5-35 | 0-15 | 1-15 | −5-35 | 0-15 | −5-35 |

| | Range (mol %) | | | | | |
|---|---|---|---|---|---|---|
| | R19 | R20 | R21 | R22 | R23 | R24 |
| TiO₂ | 0.005-0.05 | 0.1-1.5 | 0.005-0.05 | 0.1-1.5 | 0 | 0 |
| CeO₂ | 0.01-1.0 | 0.1-1.0 | 0.1-1.0 | 0.01-0.1 | 0.01-2.0 | 0.05-1.0 |
| Fe₂O₃ | 0.01-0.15 | 0.01-0.15 | 0.01-0.15 | 0.01-0.15 | 0 | 0 |
| MnO₂ | 0 | 0 | 0.01-1.0 | 0.1-1.0 | 0.01-1.0 | 0.1-1.0 |
| L* | 92-96 | 80-96 | 80-96 | 90-96 | 80-96 | 80-96 |
| a* | −1-5 | −1-−0.1 | −6-5 | −6-−0.1 | −1-5 | −1-5 |
| b* | 1-30 | −5-35 | −5-35 | −5-15 | −5-35 | −5-35 |

In aspects, the colorant package can include more than one multi-valent colorant, for example, both NiO and CeO₂; all of TiO₂, CeO₂, and NiO; or all of TiO₂, CeO₂, NiO, and Co₃O₄. Providing more than one multi-valent colorant (e.g., 2 or more, or 3) can increase the color gamut achievable with a composition, for example, by adjusting the redox ratio as discussed herein. In further aspects, the colorant package can comprise an amount of NiO of about 5×10⁻⁵ mol % or more, about 0.0001 mol % or more, about 0.01 mol % or more, about 0.05 mol % or more, about 0.07 mol % more, about 0.10 mol % or more, about 0.12 mol % or more, about 0.15 mol % or more, about 0.17 mol % or more, about 0.20 mol % or more, about 0.3 mol % or more, about 0.4 mol % or more, about 0.5 mol % or more, about 0.6 mol % or more, about 0.3 mol % or less, about 0.20 mol % or less, about 0.15 mol % or less, about 0.10 mol % or less, or about 0.05 mol % or less, or about 0.01 mol % or less. In further aspects, the colorant package can comprise an amount of NiO in a range from about 5×10⁻⁵ mol % to about 0.3 mol %, from about 0.001 mol % to about 0.20 mol %, from about 0.01 mol % to about 0.15 mol %, from about 0.05 mol % to about 0.10 mol. In further aspects, the colorant package can comprise an amount of NiO of about 0.1 mol % or less, for example, in a range from about 5×10⁻⁵ mol % to about 0.1 mol %, from about 5×10⁻⁵ mol % to about 0.05 mol %, from about 0.001 mol % to about 0.05 mol %, from about 0.07 mol % to about 0.1 mol %, or any range or subrange therebetween. In further aspects, the colorant package can comprise an amount of CeO₂ of about 0.001 mol % or more, about 0.02 mol % or more, about 0.1 mol % or more, about 0.2 mol % or more, about 0.5 mol % or more, about 1.0 mol % or more, about 1.2 mol % or more, about 1.4 mol % or more, about 1.6 mol % or more, about 2.0 mol % or less, about 1.5 mol % or less, about 1.3 mol % or less, about 1.0 mol % or less, about 0.7 mol % or less, about 0.5 mol % or less, about 0.3 mol % or less, about 0.1 mol % or less, or about 0.05 mol % or less. In further aspects, the colorant package can comprise an amount of CeO₂ in a range from about 0.001 mol % to about 2.0 mol %, from about 0.02 mol % to about 1.5 mol %, from about 0.05 mol % to about 1.3 mol %, from about 0.1 mol % to about 1.0 mol %, from about 0.2 mol % to about 1.0 mol %, from about 0.2 mol % to about 0.5 mol %, or any range or subrange therebetween. In further aspects, the colorant package can comprise an amount of CeO₂ of about 0.2 mol % or more, for example, in a range from about 0.2 mol % to about 2.0 mol %, from about 0.5 mol % to about 1.5 mol %, from about 1.0 mol % to about 1.5 mol %, or any range or subrange therebetween. In further aspects, the colorant package can comprise (e.g., in addition to NiO and CeO₂) an amount of Co₃O₄ of about 0.0001 mol % or more, about 0.0003 mol % or more, about 0.0005 mol % or more, about 0.001 mol % or more, about 0.003 mol % or more, about 0.005 mol % or more, about 0.008 mol % or more, about 0.010 mol % or more, about 0.012 mol % or more, about 0.015 mol % or more, about 0.03 mol % or more, about 0.05 mol % or more, about 0.08 mol % or more, about 0.1 mol % or less, about 0.08 mol % or less, about 0.05 mol % or less, about 0.02 mol % or less, about 0.010 mol % or less, about 0.008 mol % or less, about 0.005 mol % or less, about 0.003 mol % or less, or about 0.0010 mol % or less. In further aspects, the colorant package can comprise (e.g., in addition to NiO and CeO₂) an amount of Co₃O₄ in a range from about 0.0001 mol % to about 0.1 mol %, from about 0.0003 mol % to about 0.08 mol %, from about 0.0005 mol % to about 0.05 mol %, from about 0.0010 mol % to about 0.02 mol %, from about 0.003 mol % to about 0.01 mol %, from about 0.005 mol % to about 0.008 mol %, or any range or subrange therebetween. In further aspects, the colorant package can comprise (e.g., in addition to NiO and CeO₂) an amount of Co₃O₄ of 0.01 mol % or less, for example in a range from about 0.0001 mol % to about 0.01 mol %, from about 0.0003 mol % to about 0.008 mol %, from about 0.0005 mol % to about 0.005 mol %, from about 0.001 mol % to about 0.002 mol %, or any range or subrange therebetween. In further aspects, the colorant package can comprise (e.g., in addition to NiO and CeO₂) an amount of Co₃O₄ of 0.01 mol % or more, for example in a range from about 0.01 mol % to about 0.10 mol %, from about 0.012 mol % to about 0.08 mol %, from about 0.015 mol % to about 0.05 mol %, from about 0.03 mol % to about 0.05 mol %, or any range or subrange therebetween. In further aspects, the colorant package can comprise (e.g., in addition to NiO, CeO₂, and/or Co₃O₄ in) an amount of TiO₂ of about 5×10⁻⁵ mol % or more, about 0.001 mol % or more, about 0.005 mol % or more, about 0.008 mol % or more, about 0.01 mol % or more, about 0.02 mol % or more, about 0.05 mol % or more, about 0.1 mol % or more, about 0.5 mol % or more, about 1.0 mol % or less, about 0.5 mol % or less, about 0.3 mol % or less, about 0.1 mol % or less, about 0.05 mol % or less, about 0.02 mol % or less, or about 0.01 mol % or less. In further aspects, the colorant package can comprise (e.g., in addition to NiO, CeO₂, and/or Co₃O₄ in) an amount of TiO₂ in a range from about 5×10⁻⁵ mol % to about 1.0 mol %, from about 0.001 mol % to about 0.5 mol %, from about 0.005 mol % to about 0.3 mol %, from about 0.008 mol % to about 0.1 mol %, from about 0.01 mol % to about 0.05 mol %, or any range or subrange therebetween. In further aspects, the colorant package can comprise an amount of TiO₂ of about 0.5 mol % or less, for example in a range from about 5×10⁵ mol % to about 0.5 mol %, from about 0.001 mol % to about 0.5 mol %, from about 0.005 mol % to about 0.5 mol %, from about 0.008 mol % to about 0.3 mol %, from about 0.01 mol % to about 0.1 mol %, or any range or subrange therebetween. In further aspects, the colorant package can comprise an amount of TiO₂ of about 0.01 mol % or more, for example in a range from about 0.01 mol % to about 1 mol %, from about 0.05 mol % to about 0.5 mol %, from about 0.05 mol % to about 0.3 mol %, from about 0.05 mol % to about 0.1 mol %, or any range or subrange therebetween. In further aspects, the colorant package can comprise Fe₂O₃ and/or MnO₂, which can act a redox couple to alter the redox ratio of the multi-valent colorants while not being defined as a multi-valent colorant itself within the scope of the present disclosure. In further aspects, the colorant package (in addition to Nio and CeO₂; NiO, CeO₂, and TiO₂; or NiO, CeO₂, and/or Co₃O₄ within one or more of the corresponding ranges mentioned in this paragraph) can optionally include Fe₂O₃ in an amount of about 0.0001 mol % or more, about 0.005 mol % or more, about 0.01 mol % or more, about 0.02 mol % or more, about 0.05 mol % or more, about 0.07 mol % or more, about 0.10 mol % or more, about 0.12 mol % or more, about 0.20 mol % or less, about 0.15 mol % or less, about 0.13 mol % or less, about 0.10 mol % or less, about 0.08 mol % or less, about 0.05 mol % or less, about 0.03 mol % or less, or about 0.01 mol % or less. In further aspects, the colorant package (in addition to Nio and CeO₂; NiO, CeO₂, and TiO₂; or NiO, CeO₂, and/or Co₃O₄ within one or more of the corresponding ranges mentioned in this paragraph) can optionally include Fe₂O₃ in a range from about 0.001 mol % to about 0.20 mol %, from about 0.005 mol % to about 0.20 mol %, from about 0.01 mol % to about 0.15 mol %, from about 0.02 mol % to about 0.13 mol %, from about 0.05 mol % to about 0.10 mol %, from about 0.07 mol % to about 0.08 mol % or any range or subrange therebetween. In further aspects, the colorant package (in addition to Nio and CeO₂; NiO, CeO₂, and TiO₂; or NiO, CeO₂, and/or Co₃O₄ within one or more of the corresponding ranges mentioned in this paragraph) can optionally include MnO₂ in a range from about 0.01 mol % to about 1.0 mol %, from about 0.02 mol % to about 0.8 mol %, from about 0.05 mol % to about 0.6 mol %, from about 0.10 mol % to about 0.4 mol %, from about 0.2 mol % to about 0.3 mol %, or any range or subrange therebetween. In further aspects, the colorant package (in addition to Nio and CeO₂; NiO, CeO₂, and TiO₂; or NiO, CeO₂, and/or Co₃O₄ within one or more of the corresponding ranges mentioned in this paragraph) can optionally comprise MnO₂ in an amount of 0.10 mol % or more, for example in a range from 0.10 mol % to about 1.0 mol %, from about 0.2 mol % to about 0.8 mol %, from about 0.5 mol % to about 0.7 mol %, from about 0.5 mol % to about 0.6 mol %, or any range or subrange therebetween. Exemplary ranges for colorant packages discussed in this paragraph are presented in Table 3. Ranges R25-R30 comprise NiO and CeO₂ but is free of TiO₂ and Fe₂O₃. Ranges R37-R38 and R42 comprise Co₃O₄ and at least NiO. Ranges R31-R36 comprise NiO, CeO₂, and TiO₂. Ranges R37-R42 comprise NiO and Fe₂O₃. Ranges R35-R36 comprise NiO, CeO₂, TiO₂, and Fe₂O₃. While CIE L*, a*, and b* values are provided in Table 3, it is to be understood that these values are not necessarily limiting ranges R26-R30, R32-R34, and/or R36-R41, for example the CIE values for R25, R31, R35, and/or R42 can apply to any of the ranges stated in Table 3.

TABLE 3
Exemplary Ranges for Colorant Packages including NiO, CeO₂, and/or TiO₂

| | Range (mol %) | | | | | |
|---|---|---|---|---|---|---|
| | R25 | R26 | R27 | R28 | R29 | R30 |
| NiO | 5 × 10⁻⁵-0.3 | 5 × 10⁻⁵-0.3 | 5 × 10⁻⁵-0.3 | 5 × 10⁻⁵-0.05 | 5 × 10⁻⁵-0.05 | 5 × 10⁻⁵-0.05 |
| CeO₂ | 0.001-2 | 0.001-0.2 | 0.2-2.0 | 0.001-2 | 0.001-0.2 | 0.2-2.0 |
| TiO₂ | 0 | 0 | 0 | 0 | 0 | 0 |
| Co₃O₄ | 0 | 0 | 0 | 0 | 0 | 0 |
| Fe₂O₃ | 0 | 0 | 0 | 0 | 0 | 0 |
| MnO₂ | 0 | 0 | 0 | 0 | 0 | 0 |
| L* | 60-96 | 80-96 | 60-96 | 60-96 | 80-96 | 80-96 |
| a* | −15-20 | −15-20 | 0.3-16 | −11-−0.1 | 0.3-16 | 0.3-16 |
| b* | 1-80 | 1-80 | 1-80 | 1-80 | 1-80 | 1-80 |

| | Range (mol %) | | | | | |
|---|---|---|---|---|---|---|
| | R31 | R32 | R33 | R34 | R35 | R36 |
| NiO | 5 × 10⁻⁵-0.3 | 5 × 10⁻⁵-0.3 | 5 × 10⁻⁵-0.3 | 5 × 10⁻⁵-0.3 | 5 × 10⁻⁵-0.3 | 5 × 10⁻⁵-0.3 |
| CeO₂ | 0.001-2 | 0.001-2 | 0.001-2 | 0.2-2.0 | 0.001-0.2 | 0.2-2.0 |
| TiO₂ | 5 × 10⁻⁵-1 | 0.01-1 | 5 × 10⁻⁵-0.01 | 0.005-0.5 | 5 × 10⁻⁵-1 | 0.005-0.5 |
| Co₃O₄ | 0 | 0 | 0 | 0 | 0 | 0 |
| Fe₂O₃ | 0 | 0 | 0 | 0 | 0.001-0.2 | 0.005-0.1 |
| MnO₂ | 0 | 0 | 0 | 0 | 0 | 0 |
| L* | 60-96 | 80-96 | 60-96 | 60-96 | 60-96 | 80-96 |
| a* | −15-20 | −15-20 | 0.3-16 | −11-−0.1 | −15-20 | −15-20 |
| b* | 1-80 | 1-80 | 1-80 | 1-80 | 1-80 | 1-80 |

| | Range (mol %) | | | | | |
|---|---|---|---|---|---|---|
| | R37 | R38 | R39 | R40 | R41 | R42 |
| NiO | 5 × 10⁻⁵-0.3 | 0.01-0.2 | 5 × 10⁻⁵-0.05 | 5 × 10⁻⁵-0.05 | 0.01-0.2 | 5 × 10⁻⁵-0.3 |
| CeO₂ | 0.001-2 | 0.001-2 | 0.001-2 | 0.01-0.2 | 0.01-0.2 | 0 |
| TiO₂ | 0.0001-1 | 0.005-0.05 | 0 | 0 | 0 | 0 |
| Co₃O₄ | 0.0001-0.1 | 0.0001-0.1 | 0 | 0 | 0 | 0.0001-0.1 |
| Fe₂O₃ | 0.005-0.2 | 0.005-0.2 | 0.001-0.2 | 0.005-0.2 | 0.005-0.2 | 0.005-0.2 |
| MnO₂ | 0 | 0.01-1.0 | 0 | 0 | 0 | 0 |
| L* | 60-96 | 80-96 | 60-96 | 60-96 | 80-96 | 60-96 |
| a* | −15-20 | −15-20 | 0.3-16 | −11-−0.1 | 0.3-16 | −15-20 |
| b* | 1-80 | 1-80 | 1-80 | 1-80 | 1-80 | 1-80 |

Additional example aspects of the disclosure are described below with the understanding that any of the features of the various aspects may be used alone or in combination with one another.

Aspect 48. The method of any one of aspects 1-25, wherein the multi-valent colorant comprises:
from 0.001 mol % to 2.0 molo TiO₂; and
from 0.001 mol % to 1.0 mol % NiO.

Aspect 49. The method of aspect 48, wherein the multi-valent colorant comprises from 0.01 mol % to 0.05 mol % of the TiO₂.

Aspect 50. The method of aspect 48, wherein the multi-valent colorant comprises from 0.2 mol % to 2.0 mol % of the TiO₂.

Aspect 51. The method of any one of aspects 48-50, wherein the multi-valent colorant comprises from 0.05 mol % to 0.5 mol % of the NiO.

Aspect 52. The method of any one of aspects 48-51, wherein the glass article exhibits a CIE a* value from −12 to 4 and a CIE b* value from −35 to 35.

Aspect 52. The method of aspect 52, wherein the CIE a* value is from 0.1 to 0.8, and the CIE b* value is from 12 to 18.

Aspect 53. The method of any one of aspects 1-25, wherein the multi-valent colorant comprises:
from 0.01 mol % to 2.0 mol % TiO₂; and
from 0.01 mol % to 1.0 mol % CeO₂.

Aspect 54. The method of aspect 53, wherein the multi-valent colorant comprises from 0.005 mol % to 0.5 mol % of the TiO₂.

Aspect 55. The method of aspect 53, wherein the multi-valent colorant comprises from 0.1 mol % to 1.0 mol % of the TiO₂.

Aspect 56. The method of any one of aspects 53-55, wherein the multi-valent colorant comprises from 0.1 mol % to 1.0 mol % of the CeO₂.

Aspect 57. The method of any one of aspects 53-56, wherein the glass article exhibits a CIE a* value from −6 to 5 and a CIE b* value from −5 to 35.

Aspect 58. The method of aspect 57, wherein the CIE a* value is from −1 to 5, and the CIE b* value is from 0 to 15.

Aspect 59. The method of any one of aspects 1-25, wherein the multi-valent colorant comprises:
from 5×10⁻⁵ mol % to 0.3 mol % NiO; and
from 0.0001 mol % to 2.0 mol % CeO₂.

Aspect 60. The method of aspect 59, wherein the multi-valent colorant comprises from 5×10⁻⁵ mol % to 0.05 mol % of the NiO.

Aspect 61. The method of aspect 59, wherein the multi-valent colorant comprises from 0.05 mol % to 0.3 mol % of the NiO.

Aspect 62. The method of any one of aspects 59-61, wherein the multi-valent colorant comprises from 0.001 mol % to 0.2 mol % of the CeO₂.

Aspect 63. The method of any one of aspects 59-61, wherein the multi-valent colorant comprises from 0.2 mol % to 2 mol % of the CeO₂.

Aspect 64. The method of any one of aspects 59-63, wherein the glass article exhibits a CIE a* value from −15 to 20, and a CIE b* value from 1 to 80.

Aspect 65. The method of aspect 64, wherein the CIE a* value is from 0.3 to 16.

Aspect 66. The method of aspect 64, wherein the CIE a* value is from −11 to −0.1.

Aspect 67. The method of any one of aspects 59-66, wherein the multi-valent colorant further comprises one or more of:
from 5×10⁻⁵ mol % to 1.0 mol % TiO₂;
from 0.0001 mol % to 0.1 mol % Co₃O₄; or
combinations thereof.

Aspect 68. A natively colored glass housing for a consumer electronic device, the natively colored glass housing comprising a glass article comprising a thickness defined between a first major surface and a second major surface opposite the first major surface, the thickness is from 200 μm to 5 mm, wherein the glass article comprises a silicate glass with a multi-valent colorant having a reduced form and an oxidized form, and a total transmittance of at least one 10 nm band within a wavelength range of 380 nm to 750 nm through the thickness is from 3% to 80%, wherein the multi-valent colorant comprises:
from 0.001 mol % to 2.0 mol % TiO₂; and
from 0.001 mol % to 1.0 mol % NiO.

Aspect 69. The natively colored glass housing of any one of aspects 26-47, wherein the multi-valent colorant comprises:
from 0.001 mol % to 2.0 mol % TiO₂; and
from 0.001 mol % to 1.0 mol % NiO.

Aspect 70. The natively colored glass housing of aspect 68 or 69, wherein the multi-valent colorant comprises from 0.01 mol % to 0.05 mol % of the TiO₂.

Aspect 71. The natively colored glass housing of aspect 68 or 69, wherein the multi-valent colorant comprises from 0.2 mol % to 2.0 mol % of the TiO₂.

Aspect 72. The natively colored glass housing of any one of aspects 68-71, wherein the multi-valent colorant comprises from 0.05 mol % to 0.5 mol % of the NiO.

Aspect 73. The natively colored glass housing of any one of aspects 68-72, wherein the glass article exhibits a CIE a* value from −12 to 4 and a CIE b* value from −35 to 35.

Aspect 74. The natively colored glass housing of aspect 73, wherein the CIE a* value is from 0.1 to 0.8, and the CIE b* value is from 12 to 18.

Aspect 75. A natively colored glass housing for a consumer electronic device, the natively colored glass housing comprising a glass article comprising a thickness defined between a first major surface and a second major surface opposite the first major surface, the thickness is from 200 μm to 5 mm, wherein the glass article comprises a silicate glass with a multi-valent colorant having a reduced form and an oxidized form, and a total transmittance of at least one 10 nm band within a wavelength range of 380 nm to 750 nm through the thickness is from 3% to 80%, wherein the multi-valent colorant comprises:
from 0.01 mol % to 2.0 mol % TiO₂; and
from 0.01 mol % to 1.0 mol % CeO₂.

Aspect 76. The natively colored glass housing of any one of aspects 26-47, wherein the multi-valent colorant comprises:
from 0.01 mol % to 2.0 mol % TiO₂; and
from 0.01 mol % to 1.0 mol % CeO₂.

Aspect 77. The natively colored glass housing of aspect 75 or 76, wherein the multi-valent colorant comprises from 0.005 mol % to 0.5 mol % of the TiO₂.

Aspect 78. The natively colored glass housing of aspect 75 or 76, wherein the multi-valent colorant comprises from 0.1 mol % to 1.0 mol % of the TiO₂.

Aspect 79. The natively colored glass housing any one of aspects 75-78, wherein the multi-valent colorant comprises from 0.1 mol % to 1.0 mol % of the CeO₂.

Aspect 80. The natively colored glass housing of any one of aspects 75-79, wherein the glass article exhibits a CIE a* value from −6 to 5 and a CIE b* value from −5 to 35.

Aspect 81. The natively colored glass housing of aspect 80, wherein the CIE a* value is from −1 to 5, and the CIE b* value is from 0 to 15.

Aspect 82. A natively colored glass housing for a consumer electronic device, the natively colored glass housing comprising a glass article comprising a thickness defined between a first major surface and a second major surface opposite the first major surface, the thickness is from 200 μm to 5 mm, wherein the glass article comprises a silicate glass with a multi-valent colorant having a reduced form and an oxidized form, and a total transmittance of at least one 10 nm band within a wavelength range of 380 nm to 750 nm through the thickness is from 3% to 80%, wherein the multi-valent colorant comprises:
from 5×10⁻⁵ mol % to 0.3 mol % NiO; and
from 0.0001 mol % to 2.0 mol % CeO₂.

Aspect 83. The natively colored glass housing of any one of aspects 26-47, wherein the multi-valent colorant comprises:
from 5×10⁻⁵ mol % to 0.3 mol % NiO; and
from 0.0001 mol % to 2.0 mol % CeO₂.

Aspect 84. The natively colored glass housing of aspect 81 or 83, wherein the multi-valent colorant comprises from 5×10⁻⁵ mol % to 0.05 mol % of the NiO.

Aspect 85. The natively colored glass housing of aspect 82, wherein the multi-valent colorant comprises from 0.05 mol % to 0.3 mol % of the NiO.

Aspect 86. The natively colored glass housing of any one of aspects 82-85, wherein the multi-valent colorant comprises from 0.001 mol % to 0.2 mol % of the CeO₂.

Aspect 87. The natively colored glass housing of any one of aspects 82-86, wherein the multi-valent colorant comprises from 0.2 mol % to 2 mol % of the CeO₂.

Aspect 88. The natively colored glass housing of any one of aspects 81-86, wherein the glass article exhibits a CIE a* value from −15 to 20, and a CIE b* value from 1 to 80.

Aspect 89. The natively colored glass housing of aspect 88, wherein the CIE a* value is from 0.3 to 16.

Aspect 90. The natively colored glass housing of aspect 88, wherein the CIE a* value is from −11 to −0.1.

Aspect 91. The method of any one of aspects 82-90, wherein the multi-valent colorant further comprises one or more of:
from 5×10⁻⁵ mol % to 1.0 mol % TiO₂;
from 0.0001 mol % to 0.1 mol % Co₃O₄; or
combinations thereof.

### EXAMPLES

Various aspects will be further clarified by the following examples. Examples AA-DD correspond to raw materials containing chromium with the properties of Examples AA-BB stated in Table 4. Examples 1-50 are glass articles with the composition and properties of Examples 1-50 provided in Tables 5-12. Unless otherwise stated in Tables 5-12, the composition refers to mol % of the glass article. Amounts of chrome (e.g., Cr₂O₃), iron (e.g., Fe₂O₃), and antimony (e.g., Sb₂O₃) are stated in parts-per-million (ppm) of the glass article. However, amounts of nitrate, carbon, and nitrate refer to wt % of the raw materials used to form the glass article. Unless otherwise stated, Examples 7-50 comprised about 57.4 mol % SiO₂, about 24.8 mol % Al₂O₃, about 6.5 mol % B₂O₃, about 4.5 mol % Li₂O, about 0.1 mol % K₂O, about 1.2 mol % MgO, and about 3.7 mol % CaO in addition to the components specified in Tables 6-12 for each Example. Examples 1-50 comprised a nominal thickness of 3.6 mm.

Table 4 presents properties of different commercially available chromium-containing materials. Examples AA-BB were analyzed using XPS to determine the amount of chromium in the Cr³⁺ oxidation state (reduced) and the Cr⁶⁺ state (oxidized) at the surface of these materials after fracture under ultrahigh vacuum. All X-ray Photoelectron Spectroscopy (XPS) measurements were performed with a Physical Electronics PHI Quantum 2000 XPS instrument equipped with monochromatized Al Kα radiation and used a combination of low energy electrons and Argon ions for charge neutralization. During the XPS measurements, an approximately 100 μm wide monochromatized Al Kα beam with a beam energy of approximately 25 Watts was rastered over the probed area which was 1 mm by 0.5 mm in size.

Raw materials of Examples AA and BB were melted into rods measuring approximately 5 mm×5 mm×10 mm. The rods were notched approximately 5 mm from the end along the 10 mm height so as to produce a known location from fracture initiation. The rods were individually placed in a custom built ultrahigh vacuum fracture unit attached to the XPS unit. During the ultrahigh vacuum fracture, the base pressure of the ultrahigh vacuum fracture unit was 2×10−9 Torrs. This vacuum fracture ensured that ambient gases (e.g., oxygen and water vapor that are in extremely low concentrations in ultrahigh vacuum) do not have adequate time to react with the fracture surface and change the oxidation state of chromium. After the ultrahigh vacuum fracture, the fractured rods were transferred directly into the analysis chamber of the XPS instrument within 120 seconds without exposure to air.

For each ultrahigh vacuum fracture surface, one area measuring 1 mm×0.5 mm was selected and XPS measurements were performed using the parameters described above. The pass energy of spectrometer was set to a value of 46.95 eV with a step size of 0.1 eV/step and dwell time of 50 milliseconds per step. The core levels monitored during the XPS measurements are listed below in the order they were measured and the number of scans that each core level was measured appears in parenthesis: Cr 2p (15 scans), O is (3 scans), C is (3 scans) Si 2p (4 scans), Na 2s (4 scans), and Bis (6 scans). Data analysis was performed using the MultiPak software package (Version 9.4.0.7) provided and sold by Physical Electronics (copyrighted by Ulvac-phi, Incorporated 1994-2011). During analysis, the energy scale was referenced to the C—C/C—H peak of adventitious hydrocarbons set at the commonly accepted value of 284.8 eV. Compositional analysis and chromium oxidation state was performed using the atomic sensitivity factors provided in the version of MultiPak software cited above.

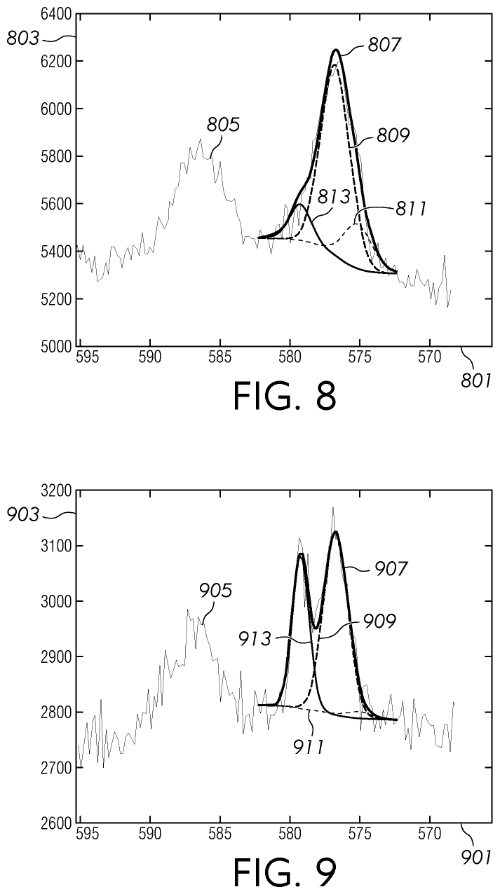

FIGS. 8-9 present the observed intensities for Cr 2p core level spectra of the ultrahigh vacuum fracture surfaces on the vertical axis 803 and 903 of different binding energies in electron volts on the horizontal axis 801 and 901 with curve 805 corresponding to Example AA and curve 905 corresponding to Example BB. These curves 805 and 905 were fit with sum-of-Gaussian-Lorentzian models to determine the amounts of different forms of chromium-containing compounds. Curves 807 and 907 represent the sum-of-Gaussian-Lorentzian approximation of curve 805 or 905, respectively, where 809 and 907 correspond to the sum of curves 809, 811, and 813 or curves 909, 911, and 913, respectively. Curves 807, 809, 811, and 813 and curves 907, 909, 911, and 913 are shown on a Shirley baseline connecting the average values at each of the endpoints of the fitted range. The region from binding energy of approximately 573 eV to 581 eV corresponds to the Cr 2p3/2 spin orbit split and was used for determination of oxidation state of chromium in these two examples. We used single Gaussian-Lorentzian peaks for each oxidation state of chromium as described in Table 7 of a publication by Beisinger et al. (Surface and Interface Analysis 36 (2004) 1550-1563). Curves 809 and 809 correspond to amounts of Cr(OH)₃ (i.e., Cr³⁺); curves 811 and 911 correspond to amounts of Cr₂O₃ (i.e., Cr³⁺); and curves 813 and 913 correspond to amounts of Cr⁶⁺. Table 4 presents the total amount of Cr³⁺ and the total amount of Cr⁶⁺ detected in Examples AA-BB. For Example AA, the precursor molar ratio was 0.886 while the precursor molar ratio of Example BB was 0.637. This demonstrates that even precursor materials nominally comprising the same material can have different molar ratios of a multi-valent colorant. Further, as discussed below for Table 5, the different precursor materials are associated with different CIE color coordinates (and molar ratios of the multi-valent colorant) in the resulting glass article.

TABLE 4
Oxidation state and molar ratio of
chromium-containing raw materials

| Example | AA | BB |
|---|---|---|
| Cr³⁺ (atom %) | 1.09 | 0.72 |
| Cr⁶⁺ (atom %) | 0.14 | 0.41 |
| Precursor molar | 0.886 | 0.637 |
| ratio (Cr³⁺/Cr⁶⁺) | | |

TABLE 5
Composition and Properties of Examples 1-6

| Example | 1 | 2 | 3 | 4 | 5 | 6 |
|---|---|---|---|---|---|---|
| Chrome | AA | AA | BB | CC | DD | DD |
| Source | | | | | | |
| SiO₂ | 60.93 | 60.88 | 60.89 | 60.89 | 60.93 | 60.88 |
| Al₂O₃ | 15.56 | 15.58 | 15.48 | 15.48 | 15.56 | 15.58 |
| B₂O₃ | 5.97 | 5.98 | 6.05 | 6.05 | 5.97 | 5.98 |
| Li₂O | 9.64 | 9.65 | 9.57 | 9.57 | 9.64 | 9.65 |
| Na₂O | 1.55 | 1.55 | 1.61 | 1.61 | 1.55 | 1.55 |
| K₂O | 0.07 | 0.07 | 0.20 | 0.20 | 0.07 | 0.07 |
| MgO | 1.98 | 1.98 | 1.93 | 1.93 | 1.98 | 1.98 |
| CaO | 4.23 | 4.23 | 4.27 | 4.27 | 4.23 | 4.23 |
| Fe₂O₃ | 0.034 | 0.034 | 0 | 0 | 0.034 | 0.034 |
| Cr₂O₃ | 0.034 | 0.042 | 0.013 | 0.013 | 0.034 | 0.042 |
| SiO₂ (wt) | 57.43 | 57.32 | 57.33 | 57.33 | 57.43 | 57.32 |
| Al₂O₃ | 24.89 | 24.89 | 24.74 | 24.74 | 24.89 | 24.89 |
| (wt) | | | | | | |
| B₂O₃ (wt) | 6.52 | 6.52 | 6.60 | 6.60 | 6.52 | 6.52 |
| Li₂O (wt) | 4.52 | 4.52 | 4.48 | 4.48 | 4.52 | 4.52 |
| Na₂O (wt) | 1.51 | 1.51 | 1.56 | 1.56 | 1.51 | 1.51 |
| K₂O (wt) | 0.10 | 0.10 | 0.29 | 0.29 | 0.10 | 0.10 |
| MgO (wt) | 1.25 | 1.25 | 1.22 | 1.22 | 1.25 | 1.25 |
| CaO (wt) | 3.72 | 3.72 | 3.75 | 3.75 | 3.72 | 3.72 |
| Fe₂O₃ | 840 | 840 | 0 | 0 | 840 | 840 |
| (ppm) | | | | | | |
| Cr₂O₃ | 850 | 1060 | 295 | 290 | 850 | 1040 |
| (ppm) | | | | | | |
| L* | 88.8 | 88.5 | 94.0 | 94.2 | 88.95 | 87.2 |
| a* | −9.35 | −11.95 | −3.7 | −3.2 | −8.8 | −10.5 |
| b* | 14.0 | 20.45 | 11.0 | 8.2 | 11.05 | 13.2 |

Table 5 presents the composition and properties of Examples 1-6 that were produced using one of the commercially available precursor materials AA-DD comprising a source of chrome (i.e., chromium). Examples 1-2 used source AA (same as Example AA), Example 3 used source BB (sample as Example BB), Example 4 used source CC, and Examples 5-6 used source DD. Examples 1 and 5 comprise the same composition other than the source of precursor materials; however, the CIE a* value of Example 1 is less than the CIE a* value of Example 5 by about 0.55 and the CIE b* value of Example 1 is greater than the CIE b* value of Example by about 3.05. These differences are clearly perceptible upon comparison with the naked eye. While the other compositions are not identical to one another other than the source material, the range of CIE color coordinates demonstrates that the difference in precursor molar ratio of the source material translates to different colors (and thus different molar ratios) in the resulting source material even with same processing conditions.

Table 6 presents compositions of the precursor materials and the properties of the resulting glass articles for Examples 7-11. Example 7 comprises 0.29 wt % of a source of nitrate in the precursor materials, and Examples 9-11 comprise from 0.001 wt % to 0.010 wt % of a source of carbon in the precursor materials. The only difference between the precursor materials for Examples 7 and 8 is that Example 7 includes the source of nitrate (0.29 wt %) while Example 8 does not. Compared to Example 8, the CIE a* value of Example 7 is lower by about 0.75 and the CIE b* value of Example 7 is greater by about 4.7. This demonstrates that the addition of a source of nitrate decreases the molar ratio of the multi-valent colorant (i.e., chromium) as the multi-valent colorant is oxidized by the nitrate.

The amount of carbon in the precursor materials increases from Example 9 to Example 10 and further to Example 11. In Examples 9-11, the source of carbon was charcoal. The CIE a* value increases from Example 9 to Example 10 by about 0.35 while the CIE b* value decreases by about 2. This demonstrates that the addition of a source of carbon increases the molar ratio of the multi-valent colorant (i.e., chromium) as the multi-valent colorant is reduced by the carbon. The change in CIE a* and b* values are less pronounced between Examples 10-11 compared to that between Examples 9-10. This suggests that the molar ratio of the multi-valent colorant may have a stronger response for (e.g., be more sensitive to marginal changes at) lower amounts of carbon (e.g., from about 0.001 wt % to about 0.005 wt %) for chromium than higher amounts of carbon, although the sensitivity of other multi-valent colorants may be different and/or other source materials may have increased sensitivity to other amounts of carbon. For example, the lower amount of carbon may be sufficient to reduce substantially all of the chromium from the 6+ oxidation state to the 3+ oxidation state for this concentration of chromium and the precursor redox ratio associated with this source of chromium; however, higher concentrations of chromium, other multi-valent colorants, and/or other precursor materials with different precursor redox ratios may have a noticeable response at other concentration ranges for carbon.

TABLE 6
Composition and Properties of Examples 7-11

| | Example | | | | |
|---|---|---|---|---|---|
| | 7 | 8 | 9 | 10 | 11 |
| Cr₂O₃ (ppm) | 370 | 370 | 375 | 390 | 370 |
| Nitrate (wt %) | 0.29 | 0 | 0 | 0 | 0 |
| Carbon (wt %) | 0 | 0 | 0.001 | 0.005 | 0.010 |
| L* | 93.2 | 93.2 | 93.55 | 93.6 | 93.65 |
| a* | −3.7 | −2.95 | −3.6 | −3.25 | −3.25 |
| b* | 10.4 | 5.8 | 7.0 | 5.0 | 4.85 |

TABLE 7
Composition and Properties of Examples 12-18

| Example | 12 | 13 | 14 | 15 | 16 | 17 | 18 |
|---|---|---|---|---|---|---|---|
| Cr₂O₃ (ppm) | 250 | 250 | 250 | 250 | 250 | 250 | 250 |
| Sulfate (wt %) | 0 | 0.01 | 0.02 | 0.04 | 0.05 | 0.10 | 0.20 |
| L* | 90.2 | 89.45 | 91.8 | 92.3 | 88.9 | 88.65 | 88.3 |
| a* | −3.50 | −1.9 | −2.05 | −2.7 | −4.25 | −4.7 | −5.0 |
| b* | 0.2 | 0.18 | 0.3 | 3.45 | 4.55 | 6.6 | 7.35 |

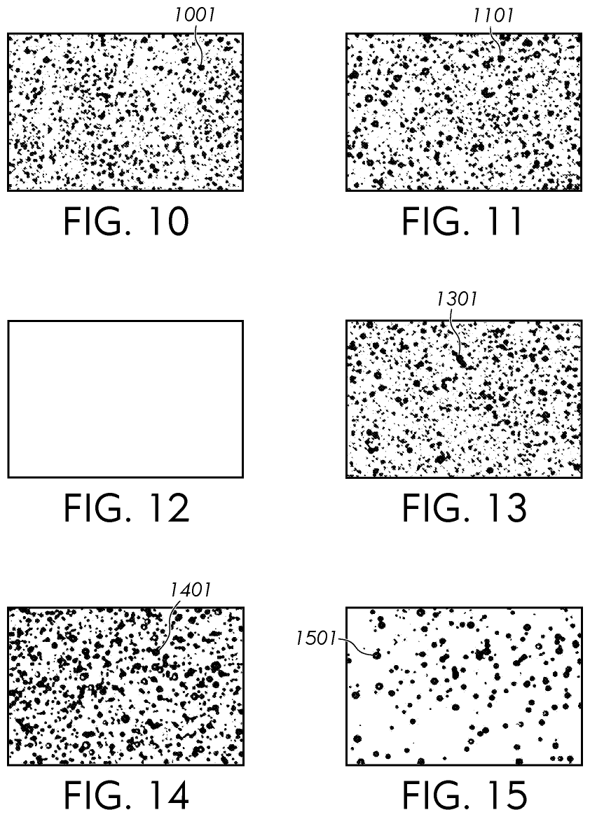

FIGS. 10-15 schematically represent cross-sections of examples comprising different amounts and types of fining agents. FIG. 10 corresponds to a composition without a source of nitrates, a source of sulfate, nor a source of sodium chloride. FIG. 11 corresponds to a composition containing a source of about 0.2 wt % nitrate in the precursor materials. FIG. 13 contains 0.2 wt % of sodium chloride. FIGS. 10-11 and 13 contain many air bubbles 1001, 1101, and 1301. FIG. 12 corresponds to Example 18 that comprises a source of 0.2 wt % sulfate in the precursor materials. As shown in FIG. 12 compared to FIGS. 10-11 and 13, the source of sulfate can reduce (e.g., eliminate air bubbles). Examples 16-17 comprise 0.05 wt % or 0.10 wt %, respectively, of a source of sulfate in the precursor materials. Although not shown, Examples 16-17 were visually free of bubbles like Example 18 (shown in FIG. 12). FIGS. 14-15 correspond to Examples 13-14, respectively, comprising 0.01 wt % or 0.02 wt %, respectively, of the source of sulfate in the precursor materials. FIGS. 14-15 both exhibit a plurality of air bubbles; however, compared to the air bubbles 1001 in FIG. 10, the air bubbles 1401 are larger, indicating that the sulfate is facilitating coalescence of the air bubbles; and FIG. 15 demonstrates fewer air bubbles 1501 than FIG. 14, indicating that the air bubbles are being removed as a result of the additional amount of the source material containing sulfate.

Table 7 presents the amount of a source of sulfate in the precursor material and the properties of the resulting glass article for Examples 12-18. Examples 13-14 had a large number of air bubbles and/or blisters that may have interfered with the measurement of the CIE color coordinates. Visually, it appears that Examples 13-14 with from 0.01 wt % to 0.02 wt % of the source of sulfate comprised substantially the same color as Example 12. For Examples 15-18 (compared to Example 12), the CIE a* value decreases (from −4.25 to −5.0) and the CIE b* value increases (from 4.55 to 7.35) as the amount of source of sulfate increases. This demonstrates that providing and/or increasing the amount of a source sulfate in the precursor materials reduces the molar ratio of the resulting glass article as the sulfate oxidizes the multi-valent colorant (chromium). Comparing Examples 12-14 to Examples 15-18, it appears that the color and precursor ratio change after a threshold amount of sulfate has been reached, for example, once there is a sufficient amount of the source of sulfate to remove the air bubbles. It is to be understood that similar effects are contemplated for other fining agents, which may also have an oxidizing effect.

Table 8 presents the amount of iron (e.g., Fe₂O₃) and the CIE color coordinates of Examples 19-24. The amount of iron increases from Example 19 to Example 24, ranging from 190 ppm to 590 ppm. As shown, the CIE a* value increases and the CIE b* value decreases as the amount of iron increases. This demonstrates that iron can increase the molar ratio of the multi-valent colorant (e.g., chromium) as iron reduces the multi-valent colorant. Further, the sensitivity of the CIE a* and b* values to iron decreases for more than 500 ppm. This suggests that the molar ratio of the multi-valent colorant may have a stronger response for (e.g., be more sensitive to marginal changes at) lower amounts of iron (e.g., from 190 ppm to 500 ppm) for chromium than higher amounts of iron, although the sensitivity of other multi-valent colorants may be different and/or other source materials may have increased sensitivity to other amounts of iron. For example, the lower amount of iron may be sufficient to reduce substantially all of the chromium from the 6+ oxidation state to the 3+ oxidation state for this concentration of chromium and the precursor redox ratio associated with this source of chromium; however, higher concentrations of chromium, other multi-valent colorants, and/or other precursor materials with different precursor redox ratios may have a noticeable response at other concentration ranges of iron.

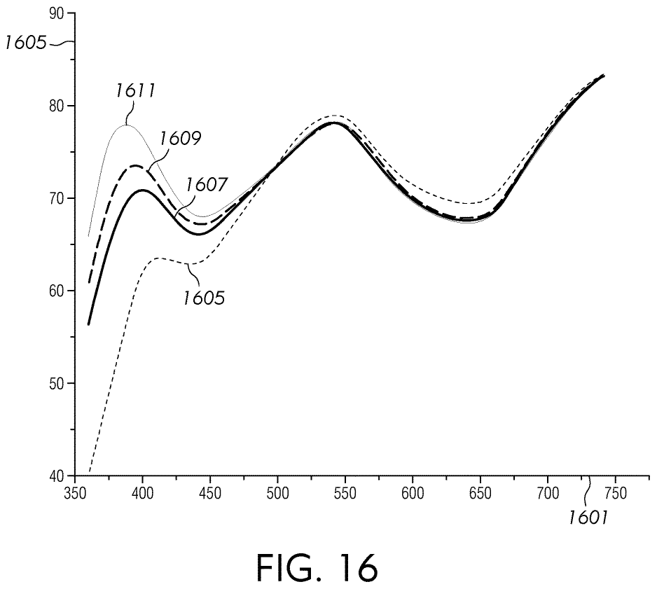

FIG. 16 presents the transmittance % on the vertical axis 1603 for optical wavelengths in nm on the horizontal axis 1601 for different glass articles. Curve 1605 corresponds to Example 20, curve 1607 corresponds to Example 22, curve 1609 corresponds to Example 23, and curve 1611 corresponds to Example 24. As shown, the blue and ultraviolent transmittance increases as the amount of iron increases; however, the transmittance at red wavelengths (e.g., from about 550 nm to about 700 nm) decreases as the amount of iron increases.

TABLE 8
Composition and Properties of Examples 19-24

| Example | 19 | 20 | 21 | 22 | 23 | 24 |
|---|---|---|---|---|---|---|
| Cr₂O₃ (ppm) | 510 | 510 | 500 | 500 | 495 | 495 |
| Fe₂O₃ (ppm) | 190 | 230 | 310 | 390 | 500 | 590 |
| L* | 89.48 | 89.28 | 88.78 | 88.72 | 88.86 | 88.92 |
| a* | −5.0 | −4.80 | −4.75 | −4.4 | −4.3 | −4.25 |
| b* | 10.8 | 8.7 | 7.0 | 5.0 | 3.8 | 3.7 |

TABLE 9
Composition and Properties of Examples 25-30

| Example | 25 | 26 | 27 | 28 | 29 | 30 |
|---|---|---|---|---|---|---|
| Cr2O3 (wt %) | 700 | 750 | 700 | 720 | 750 | 760 |
| ZnO (wt %) | 0.35 | 0.68 | 1.07 | 0.35 | 0.68 | 1.07 |
| Nitrate (wt %) | 0 | 0 | 0 | 0.1 | 0.1 | 0.1 |
| L* | 90.7 | 90.1 | 90.3 | 89.65 | 89.8 | 89.6 |
| a* | −7.55 | −7.95 | −8.0 | −10.7 | −10.55 | −10.6 |
| b* | 7.65 | 8.4 | 8.15 | 20.5 | 20.5 | 20.25 |

Table 9 presents the amount of zinc (ZnO) and CIE color coordinates for Examples 25-30. The precursor materials for Examples 28-30 were free of nitrate while Examples 25-27 included NaNO₃ as the source of nitrate. Comparing Examples 25-27 and Examples 28-30, adding a source of nitrate in the precursor materials decreases the CIE a* value by more than 2.5 and increases the CIE b* value by more than 12. This is more pronounced than Examples 7-8 but is consistent with the trend observed there. Although not shown, a similar but lesser effect was noticed when adding comparable wt % amounts of nitrate as KNO₃ instead of NaNO₃. The addition of zinc may increase the magnitude (e.g., absolute value) of the shift in precursor ratio compared to using a source of nitrate alone. Increasing an amount of zinc (ZnO) from 0.35 wt % to 0.68 wt % without a source of nitrate (Examples 25-26) decreased the CIE a* value by 0.45 and increased the CIE b* value by about 0.75. However, the effect of further increasing the amount of zinc (ZnO) beyond 0.68 wt % (from Example 26 to Example 27) had relatively modest changes to the CIE color coordinates (and molar ratio of the multi-valent colorant). With the source of nitrate (Examples 28-30), the CIE color coordinates (and molar ratio of the multi-valent colorant) were mostly insensitive to changes in the amount of ZnO from 0.35 wt % to 1.07 wt %.

Table 10 presents amounts of antimony, cobalt, and chromium as well as the CIE color coordinates for Examples 31-35. The amount of chromium and cobalt is substantially the same across Examples 31-35. As the amount of antimony increases, the CIE L* value increases, the CIE a* value increases, and the CIE b* value decreases. This demonstrates that the addition of a source of antimony increases the molar ratio of the multi-valent colorant (i.e., chromium) as the multi-valent colorant is reduced by the antimony. Further, the marginal change (i.e., sensitivity) in the CIE color coordinates (and the molar ratio of the multi-valent colorant) to changes in antimony concentration is greater for amounts of antimony less than 500 ppm than for greater amounts of antimony. For example, the lower amount of antimony (e.g., less than 500 ppm) may be sufficient to reduce substantially all of the chromium from the 6+ oxidation state to the 3+ oxidation state for this concentration of chromium and the precursor redox ratio associated with this source of chromium; however, higher concentrations of chromium, other multi-valent colorants, and/or other precursor materials with different precursor redox ratios may have a noticeable response at other concentration ranges of antimony.

TABLE 10
Composition and Properties of Examples 31-35

Example

| | 31 | 32 | 33 | 34 | 35 |
|---|---|---|---|---|---|
| Cr₂O₃ (ppm) | 453 | 454 | 451 | 450 | 449 |
| Co₃O₄ (ppm) | 48 | 46 | 48 | 49 | 50 |
| Sb₂O₃ (ppm) | 64 | 270 | 480 | 990 | 1530 |
| L* | 90.7 | 90.9 | 91.0 | 91.1 | 91.15 |
| a* | −4.4 | −4.0 | −3.8 | −3.75 | −3.70 |
| b* | 9.45 | 7.0 | 5.6 | 5.15 | 5.00 |

TABLE 11
Composition and Properties of Examples 36-41

| Example | 36 | 37 | 38 | 39 | 40 | 41 |
|---|---|---|---|---|---|---|
| Cr₂O₃ (ppm) | 780 | 740 | 750 | 740 | 770 | 760 |
| Co₃O₄ (ppm) | 0 | 0 | 0 | 0 | 0 | 0 |
| Sb₂O₃ (ppm) | 2400 | 4800 | 7300 | 2400 | 4800 | 7300 |
| L* | 90.3 | 90.75 | 90.35 | 90.15 | 90.35 | 89.8 |
| a* | −8.25 | −7.6 | −8.05 | −8.15 | −8.05 | −8.95 |
| b* | 8.15 | 7.5 | 8.0 | 8.35 | 8.1 | 8.8 |

Table 11 presents the amounts of antimony, cobalt, and chromium as well as the CIE color coordinates for Examples 36-41. Examples 31-35 were down drawn while Examples 36-41 were formed in Pt crucibles that were quenched to form the glass article. The amounts of antimony in Examples 36-41 were greater than the amount of antimony in Examples 31-35. At these higher amounts of antimony in Examples 36-41, further increasing the amount of antimony does not have a clear trend. Examples 36-38 did not include a source of nitrate in the precursor materials while Examples 39-41 did include NaNO₃ as a source of nitrate in the precursor materials. Comparing Examples 36-38 to Examples 39-41, including the source of nitrate decreases the CIE L* value, the CIE a* value decreases, and the CIE b* value increases. This trend is consistent with the trend observed above for the addition of a source of nitrate.

Table 12 presents the source of the multi-valent colorant (chromium), the cooling rate of the melt from 1500° C. to 1400° C., and the CIE values of the resulting glass article. “Quench” means that the melt was poured from a crucible without a controlled cooling rate. Examples 42-44 comprised source AA. Decreasing the cooling rate from quenching to 2° C./min to 0.5° C./min for Examples 42-44 decreased the CIE L* value and the CIE b* decreased. Examples 45-47 comprised source BB. Decreasing the cooling rate from quenching to 2° C./min to 0.5° C./min for Examples 45-47 did not noticeably change the CIE color coordinates. Examples 48-50 comprised source CC. Decreasing the cooling rate from quenching to 2° C./min to 0.5° C./min for Examples 48-50 increased the CIE L* value, increased the CIE a*, and decreased the CIE b* value. Notably, decreasing the cooling rate from 2° C./min to 0.5° C./min in Examples 48-49 has a very large impact on the CIE b* value. The different extent that changing the cooling rate had on the CIE color coordinates (and molar ratio) was different for the different source materials for the multi-valent colorant (chromium). This suggests that precursor materials with different precursor molar ratios will be affected differently by the various factors discussed herein (e.g., cooling rate, other components). For example, a precursor material with a low precursor molar ratio may not be significantly affected by decreasing the cooling rate (which may oxidize the multi-valent colorant) while another precursor material with a higher precursor molar ratio may be noticeably decreased by the same change in the cooling rate. Likewise, a precursor material with a high precursor molar ratio may not be significantly affected by increasing the cooling rate (which may prevent oxidation of the multi-valent colorant) while another precursor material with a lower precursor molar ratio may be noticeably increased by the same change in the cooling rate.

TABLE 12
Composition and Properties of Examples 42-50

| Example | 42 | 43 | 44 | 45 | 46 | 47 | 48 | 49 | 50 |
|---|---|---|---|---|---|---|---|---|---|
| Chrome Source | AA | AA | AA | BB | BB | BB | CC | CC | CC |
| Cr₂O₃ (ppm) | 350 | 350 | 325 | 359 | 295 | 300 | 230 | 390 | 240 |
| Cooling | 0.5 | 2 | Quench | 0.5 | 2 | Quench | 0.5 | 2 | Quench |
| Rate (° C./min) | | | | | | | | | |
| L* | 93.45 | 93.6 | 93.7 | 93.95 | 94.0 | 94.0 | 94.3 | 94.2 | 93.0 |
| a* | −3.75 | −3.65 | −3.8 | −3.7 | −3.7 | −3.7 | −2.45 | −3.2 | −4.25 |
| b* | 7.95 | 8.25 | 10.15 | 10.9 | 11.05 | 10.9 | 3.2 | 8.2 | 8.95 |

Tables 13-21 present the composition and color coordinates for Examples 51-222. Unless otherwise stated, Examples 51-222 comprised Composition A including about 60.9 mol % SiO₂, about 14.7 mol % Al₂O₃, about 6.0 mol % B₂O₃, about 9.0 mol % Li₂O, about 2.0 mol % Na₂O, about 4.5 mol % MgO, and about 1.5 mol % CaO (e.g., about 57.7 wt % SiO₂, about 23.7 wt % Al₂O₃, about 6.6 wt % B₂O₃, about 4.2 wt % Li₂O, about 0.3 wt % K₂O, about 2.9 wt % MgO, and about 1.3 wt % CaO) in addition to the components specified in Tables 13-21 for each Example. For Examples 51-222, the potassium was provided as potassium nitrate while the other components were provided as oxides or carbonates. The redox ratio was of a colorant package was modified by changing the amount of nitrate (e.g., changing the amount of potassium added as potassium nitrate), adding tin (SnO₂), and/or changing the presence and/or amounts of redox couples (e.g., Fe₂O₃, MnO₂). Also, changing the number of multi-valent colorants and concentration of the multi-valent colorant(s) produces different redox ratios. Examples 51-62 comprised a nominal thickness of 3.6 mm. Examples 63-222 were formed in Pt crucibles that were quenched to form the glass article while Examples 51-62 were formed in a down-draw process. Unless otherwise stated in Tables 13-21, the composition refers to mol % of the glass article with the values in wt % indicated by “(wt)” in the row label.

TABLE 13
Composition and Properties of Examples 51-62

| | Example (mol %) | | | | | | | |
|---|---|---|---|---|---|---|---|---|
| | 51 | 52 | 53 | 54 | 55 | 56 | 57 | 58 |
| NiO | 0.058 | 0.14 | 0.20 | 0.09 | 0.10 | 0.14 | 0.053 | 0.057 |
| CeO₂ | 0 | 0 | 0 | 0.26 | 0.50 | 0.29 | 0.27 | 0.71 |
| Co₃O₄ | 5 × 10⁻⁵ | 13 × 10⁻⁵ | 18 × 10⁻⁵ | 9 × 10⁻⁵ | 95 × 10⁻⁵ | 13 × 10⁻⁵ | 5 × 10⁻⁵ | 5 × 10⁻⁵ |
| TiO₂ | 1.07 | 0.43 | 0.009 | 0.40 | 0.009 | 0.009 | 0.70 | 0.009 |
| MnO₂ | 0 | 0 | 0 | 0 | 0 | 0 | 0 | 0 |
| NiO (wt) | 0.068 | 0.168 | 0.236 | 0.111 | 0.117 | 0.168 | 0.063 | 0.067 |
| CeO₂ (wt) | 0 | 0 | 0 | 0.72 | 1.34 | 0.77 | 0.71 | 0.72 |
| Co₃O₄ (wt) | 2 × 10⁻⁴ | 5 × 10⁻⁴ | 7 × 10⁻⁴ | 3 × 10⁻⁴ | 3 × 10⁻⁴ | 5 × 10⁻⁴ | 2 × 10⁻⁴ | 2 × 10⁻⁴ |
| TiO₂ (wt) | 1.34 | 0.54 | 0.011 | 0.49 | 0.011 | 0.011 | 0.88 | 0.011 |
| MnO₂ (wt) | 0 | 0 | 0 | 0 | 0 | 0 | 0 | 0 |
| L* | 92.24 | 85.1 | 82.02 | 88.99 | 88.13 | 85.28 | 92.25 | 91.77 |
| a* | 0.18 | 2.13 | 3.2 | 0.74 | 0.78 | 1.84 | −0.13 | −0.26 |
| b* | 14.3 | 31.6 | 37.2 | 24.1 | 26.8 | 32.7 | 15.9 | 17.6 |

| Example | 59 | 60 | 61 | 62 |
|---|---|---|---|---|
| NiO | 0 | 0 | 0 | 0 |
| CeO₂ | 0.26 | 0.71 | 0.29 | 0.26 |
| Co₃O₄ | 0 | 0 | 0 | 0 |
| TiO₂ | 0.40 | 0.009 | 0.009 | 0.70 |
| MnO₂ | 0.71 | 0.43 | 1.07 | 0.40 |
| NiO (wt) | 0 | 0 | 0 | 0 |
| CeO₂ (wt) | 1.91 | 0.71 | 1.89 | 0.76 |
| Co₃O₄ (wt) | 0 | 0 | 0 | 0 |
| TiO₂ (wt) | 0.49 | 0.011 | 0.011 | 0.87 |
| MnO₂ (wt) | 0.95 | 0.58 | 1.45 | 0.54 |
| L* | 93.11 | 90.47 | 92.41 | 94.02 |
| a* | 0.3 | 1.2 | 0.06 | 0.16 |
| b* | 8.6 | 12.9 | 10.7 | 6.31 |

TABLE 14
Composition and Properties of Examples 63-72

| | Example (mol %) | | | | | | | | | |
|---|---|---|---|---|---|---|---|---|---|---|
| | 63 | 64 | 65 | 66 | 67 | 68 | 69 | 70 | 71 | 72 |
| NiO | 0.027 | 0.041 | 0.059 | 0.065 | 0.066 | 0.078 | 0.098 | 0.098 | 0.10 | 0.087 |
| TiO₂ | 0.007 | 0.007 | 0.006 | 1.25 | 0.41 | 0.007 | 0.006 | 0.007 | 0.41 | 0.007 |
| Fe₂O₃ | 0.003 | 0.003 | 0.073 | 0.004 | 0.004 | 0.015 | 0.078 | 0.016 | 0.003 | 0.005 |
| SnO₂ | 0 | 0 | 0 | 0 | 0 | 0 | 0 | 0 | 0 | 0 |
| NiO (wt) | 0.032 | 0.048 | 0.070 | 0.077 | 0.078 | 0.093 | 0.115 | 0.115 | 0.117 | 0.101 |
| TiO₂ (wt) | 0.009 | 0.009 | 0.008 | 1.57 | 0.51 | 0.009 | 0.008 | 0.008 | 0.51 | 0.008 |
| Fe₂O₃ (wt) | 0.009 | 0.009 | 0.18 | 0.01 | 0.009 | 0.038 | 0.19 | 0.04 | 0.009 | 0.012 |
| SnO₂ (wt) | 0 | 0 | 0 | 0 | 0 | 0 | 0 | 0 | 0 | 0 |
| L* | 93.9 | 92.1 | 91.0 | 89.8 | 92.2 | 81.3 | 88.3 | 89.2 | 89.6 | 89.4 |
| a* | 0.39 | 0.7 | 0 | 0.44 | 0.03 | 0.21 | 0.53 | 0.66 | 0.59 | 0.8 |
| b | 6.29 | 10.0 | 17.8 | 25.2 | 16.4 | 18.4 | 26.2 | 25.0 | 24.8 | 21.7 |

Table 13 presents the colorant package and CIE color space coordinates for Examples 51-62. Examples 51-59 comprised at least two multi-valent colorants, namely NiO and TiO₂ (with Examples 51-59 further comprising Co₃O₄). Examples 54-58 further comprised CeO₂ as another multi-valent colorant. SnO₂ is not listed in Table 13 because Examples 51-58 did not have any tin. Examples 59-62 have both CeO₂ and TiO₂ as multi-valent colorants along with MnO₂. Examples 51-56 and 59-62 have a*>0 and b*>0. Examples 51-58 and 60-61 have b*>10.

Table 14 presents the colorant package and CIE color space coordinates for Examples 63-72. Examples 63-72 comprises two multi-valent colorants, namely, NiO and TiO₂ along with Fe₂O₃ as a redox couple. Examples 63-72 comprised a* Fe₂O₃0 and b*>0 with Examples 64-72 comprising b*≥10.

Table 15 presents the colorant package and CIE color space coordinates for Examples 73-126. Examples 73-126 comprised NiO and TiO₂ (with Examples 73-126 further comprising Co₃O₄) along with Fe₂O₃ as a redox couple and optionally SnO₂. Examples 73-126 comprised a*<0. Examples 73-75, 77-86, and 88 comprised b*<0 in addition to a*<0. Examples 76, 87, and 89-126 comprised b*>0 in addition to a*<0.

TABLE 15
Composition and Properties of Examples 73-126

| | Example (mol %) | | | | | | |
|---|---|---|---|---|---|---|---|
| | 73 | 74 | 75 | 76 | 77 | 78 | 79 |
| NiO | 8 × 10⁻⁵ | 8 × 10⁻⁵ | 8 × 10⁻⁵ | 9 × 10⁻⁵ | 8 × 10⁻⁵ | 9 × 10⁻⁵ | 17 × 10⁻⁵ |
| Co₃O₄ | 0.002 | 0.013 | 0.013 | 0.014 | 23 × 10 ⁻⁵ | 13 × 10⁻⁵ | 0.016 |
| TiO₂ | 0.009 | 0.009 | 0.009 | 0.011 | 0.007 | 0.010 | 0.009 |
| Fe₂O₃ | 0.004 | 0.005 | 0.005 | 0.008 | 0.009 | 0.018 | 0.005 |
| SnO₂ | 0 | 0 | 0 | 8 × 10⁻⁴ | 0.11 | 0 | 0 |
| NiO (wt) | 0.0001 | 0.0001 | 0.0001 | 0.0001 | 0.0001 | 0.0001 | 0.0002 |
| Co₃O₄ (wt) | 0.008 | 0.049 | 0.050 | 0.051 | 0.0009 | 0.0005 | 0.060 |
| TiO₂ (wt) | 0.011 | 0.011 | 0.011 | 0.014 | 0.009 | 0.012 | 0.050 |
| Fe₂O₃ (wt) | 0.011 | 0.012 | 0.013 | 0.021 | 0.024 | 0.045 | 0.114 |
| SnO₂ (wt) | 0 | 0 | 0 | 0.002 | 0.27 | 0 | 0 |
| L* | 85.9 | 90.2 | 90.6 | 72.8 | 92.9 | 95.3 | 89.1 |
| a* | −9.75 | −2.74 | −2.61 | −12.23 | −3.84 | −1.66 | −3.89 |
| b* | −1.56 | −5.28 | −5.49 | 16.4 | −3.21 | 4.12 | −5.1 |
| | Example (mol %) | | | | | | |
| | 80 | 81 | 82 | 83 | 84 | 85 | 86 |
| NiO | 17 × 10⁻⁵ | 17 × 10⁻⁵ | 25 × 10⁻⁵ | 25 × 10⁻⁵ | 25 × 10⁻⁵ | 34 × 10⁻⁵ | 42 × 10⁻⁵ |
| Co₃O₄ | 0.003 | 0.013 | 0.007 | 0.005 | 0.004 | 0.021 | 0.005 |
| TiO₂ | 0.009 | 0.009 | 0.009 | 0.009 | 0.006 | 0.009 | 0.009 |
| Fe₂O₃ | 0.005 | 0.005 | 0.05 | 0.005 | 0.003 | 0.004 | 0.005 |
| SnO₂ | 0 | 0 | 0.001 | 0 | 0 | 0 | 0 |
| NiO (wt) | 0.0002 | 0.0002 | 0.0003 | 0.0003 | 0.0003 | 0.0004 | 0.0005 |
| Co₃O₄ (wt) | 0.011 | 0.050 | 0.027 | 0.020 | 0.016 | 0.079 | 0.020 |
| TiO₂ (wt) | 0.011 | 0.011 | 0.011 | 0.014 | 0.008 | 0.012 | 0.011 |
| Fe₂O₃ (wt) | 0.012 | 0.013 | 0.012 | 0.011 | 0.007 | 0.011 | 0.012 |
| SnO₂ (wt) | 0 | 0 | 0.003 | 0 | 0 | 0 | 0 |
| L* | 93.0 | 90.3 | 92.0 | 88.7 | 85.1 | 86.6 | 92.6 |
| a* | −3.49 | −3.13 | −3.09 | −1.41 | −7.41 | −4.51 | −3.4 |
| b* | −0.5 | −4.83 | −2.5 | −10.2 | −6.89 | −7.72 | −0.92 |

| | Example (mol %) | | | | | | |
|---|---|---|---|---|---|---|---|
| | 87 | 88 | 89 | 90 | 91 | 92 | 93 |
| NiO | 0.0076 | 0.0011 | 0.0011 | 0.003 | 0.004 | 0.004 | 0.006 |
| Co₃O₄ | 11 × 10⁻⁵ | 0.005 | 0.013 | 0.013 | 8 × 10⁻⁵ | 11 × 10⁻⁵ | 13 × 10⁻⁵ |
| TiO₂ | 0.009 | 0.009 | 0.010 | 0.010 | 0.009 | 0.009 | 0.009 |
| Fe₂O₃ | 0.005 | 0.004 | 0.005 | 0.006 | 0.004 | 0.005 | 0.005 |
| SnO₂ | 0 | 0 | 0.0008 | 0.0009 | 0.0017 | 0 | 0 |
| NiO (wt) | 0.0009 | 0.0013 | 0.0013 | 0.0036 | 0.0044 | 0.0048 | 0.0071 |
| Co₃O₄ (wt) | 0.0004 | 0.019 | 0.051 | 0.050 | 0.0003 | 0.0004 | 0.0005 |
| TiO₂ (wt) | 0.011 | 0.012 | 0.014 | 0.012 | 0.011 | 0.011 | 0.011 |
| Fe₂O₃ (wt) | 0.012 | 0.011 | 0.014 | 0.014 | 0.011 | 0.012 | 0.012 |
| SnO₂ (wt) | 0 | 0 | 0.0019 | 0.0021 | 0.0042 | 0 | 0 |
| L* | 93.9 | 88.9 | 89.8 | 90.6 | 91.7 | 93.8 | 94.8 |
| a* | −3.48 | −1.68 | −4.65 | −4.04 | −5.94 | −3.52 | −2.27 |
| b* | 1.21 | −9.7 | 5.63 | 6.47 | 4.84 | 1.31 | 1.04 |

| | Example (mol %) | | | | | | |
|---|---|---|---|---|---|---|---|
| | 94 | 95 | 96 | 97 | 98 | 99 | 100 |
| NiO | 0.006 | 0.008 | 0.014 | 0.017 | 0.019 | 0.020 | 0.020 |
| Co₃O₄ | 11 × 10⁻⁵ | 11 × 10⁻⁵ | 8 × 10⁻⁵ | 8 × 10⁻⁵ | 11 × 10⁻⁵ | 11 × 10⁻⁵ | 13 × 10⁻⁵ |
| TiO₂ | 0.009 | 0.009 | 0.029 | 0.009 | 0.009 | 0.80 | 0.006 |
| Fe₂O₃ | 0.005 | 0.005 | 0.005 | 0.005 | 0.005 | 0.004 | 0.046 |
| SnO₂ | 0.0009 | 0 | 0.001 | 0 | 0 | 0 | 0 |
| NiO (wt) | 0.0076 | 0.0096 | 0.017 | 0.020 | 0.022 | 0.023 | 0.024 |
| Co₃O₄ (wt) | 0.0004 | 0.0004 | 0.0003 | 0.0003 | 0.0004 | 0.0004 | 0.0005 |
| TiO₂ (wt) | 0.011 | 0.011 | 0.037 | 0.011 | 0.011 | 1.01 | 0.008 |
| Fe₂O₃ (wt) | 0.012 | 0.012 | 0.012 | 0.012 | 0.012 | 0.0089 | 0.116 |
| SnO₂ (wt) | 0.0022 | 0 | 0.0031 | 0 | 0 | 0 | 0 |
| L* | 95.6 | 93.9 | 90.8 | 93.4 | 94.9 | 95.2 | 94.7 |
| a* | −1.33 | −3.25 | −5.39 | −3.55 | −1.69 | −0.16 | −0.27 |
| b* | 1.64 | 1.41 | 7.79 | 2.32 | 1.17 | 6.05 | 6.71 |
| | Example (mol %) | | | | | | |
| | 101 | 102 | 103 | 104 | 105 | 106 | 107 |
| NiO | 0.021 | 0.021 | 0.021 | 0.022 | 0.025 | 0.025 | 0.030 |
| Co₃O₄ | 11 × 10⁻⁵ | 11 × 10⁻⁵ | 3 × 10⁻⁵ | 1 × 10⁻⁵ | 10 × 10⁻⁵ | 13 × 10⁻⁵ | 11 × 10⁻⁵ |
| TiO₂ | 0.007 | 0.41 | 0.009 | 0.008 | 0.010 | 1.23 | 0.008 |
| Fe₂O₃ | 0.019 | 0.004 | 0.005 | 0.005 | 0.005 | 0.0004 | 0.005 |
| SnO₂ | 0 | 0 | 0 | 0 | 0 | 0 | 0 |
| NiO (wt) | 0.025 | 0.025 | 0.025 | 0.26 | 0.30 | 0.30 | 0.36 |
| Co₃O₄ (wt) | 0.0004 | 0.0004 | 0.0001 | 0.0001 | 0.0004 | 0.0005 | 0.0004 |
| TiO₂ (wt) | 0.009 | 0.51 | 0.012 | 0.011 | 0.013 | 1.55 | 0.011 |
| Fe₂O₃ (wt) | 0.048 | 0.0096 | 0.012 | 0.012 | 0.012 | 0.010 | 0.011 |
| SnO₂ (wt) | 0 | 0 | 0 | 0 | 0 | 0 | 0 |
| L* | 94.8 | 95.2 | 85.0 | 86.8 | 93.9 | 95.2 | 92.9 |
| a* | −0.18 | −0.16 | −11.15 | −7.86 | −2.75 | −0.2 | −3.63 |
| b* | 6.79 | 6.19 | 5.8 | 5.09 | 2 | 6.34 | 3.11 |
| | Example (mol %) | | | | | | |
| | 108 | 109 | 110 | 111 | 112 | 113 | 114 |
| NiO | 0.030 | 0.033 | 0.033 | 0.038 | 0.041 | 0.044 | 0.056 |
| Co₃O₄ | 23 × 10⁻⁵ | 11 × 10⁻⁵ | 13 × 10⁻⁵ | 11 × 10⁻⁵ | 3 × 10⁻⁵ | 5 × 10⁻⁵ | 4 × 10⁻⁵ |
| TiO₂ | 0.007 | 0.009 | 0.009 | 0.009 | 0.009 | 0.009 | 0.009 |
| Fe₂O₃ | 0.009 | 0.005 | 0.005 | 0.005 | 0.005 | 0.004 | 0.005 |
| SnO₂ | 0.10 | 0.001 | 0 | 0 | 0 | 0 | 0 |
| NiO (wt) | 0.37 | 0.039 | 0.039 | 0.045 | 0.048 | 0.052 | 0.066 |
| Co₃O₄ (wt) | 0.0009 | 0.0004 | 0.005 | 0.0004 | 0.0001 | 0.0002 | 0.0002 |
| TiO₂ (wt) | 0.010 | 0.011 | 0.012 | 0.011 | 0.012 | 0.011 | 0.011 |
| Fe₂O₃ (wt) | 0.024 | 0.012 | 0.012 | 0.012 | 0.012 | 0.011 | 0.011 |
| SnO₂ (wt) | 0.26 | 0.002 | 0 | 0 | 0 | 0 | 0 |
| L* | 94.1 | 93.5 | 94.6 | 93.5 | 83.6 | 85.3 | 84.0 |
| a* | −0.48 | −2.99 | −1.44 | −2.81 | −9.76 | −7.59 | −7.31 |
| b* | 9.44 | 2.51 | 2.84 | 2.74 | 10.3 | 9.15 | 11.6 |
| | Example (mol %) | | | | | | |
| | 115 | 116 | 117 | 118 | 119 | 120 | 121 |
| NiO | 0.057 | 0.058 | 0.059 | 0.062 | 0.075 | 0.077 | 0.078 |
| Co₃O₄ | 3 × 10⁻⁵ | 3 × 10⁻⁵ | 16 × 10⁻⁵ | 4 × 10⁻⁵ | 4 × 10⁻⁵ | 5 × 10⁻⁵ | 3 × 10⁻⁵ |
| TiO₂ | 0.009 | 0.009 | 0.006 | 0.009 | 0.008 | 0.009 | 0.009 |
| Fe₂O₃ | 0.004 | 0.004 | 0.046 | 0.004 | 0.005 | 0.005 | 0.005 |
| SnO₂ | 0 | 0 | 0 | 0 | 0 | 0 | 0 |
| NiO (wt) | 0.068 | 0.069 | 0.069 | 0.073 | 0.088 | 0.091 | 0.092 |
| Co₃O₄ (wt) | 0.0001 | 0.0001 | 0.0006 | 0.0002 | 0.0002 | 0.0002 | 0.0001 |
| TiO₂ (wt) | 0.011 | 0.011 | 0.008 | 0.011 | 0.011 | 0.011 | 0.011 |
| Fe₂O₃ (wt) | 0.011 | 0.011 | 0.117 | 0.011 | 0.012 | 0.012 | 0.012 |
| SnO₂ (wt) | 0 | 0 | 0 | 0 | 0 | 0 | 0 |
| L* | 82.4 | 78.5 | 91.6 | 82.6 | 80.5 | 80.3 | 80.8 |
| a* | −8.8 | −12.5 | −0.05 | −73.4 | −8.56 | −8.98 | −6.66 |
| b* | 13.1 | 17.0 | 17.1 | 13.0 | 16.7 | 15.4 | 15.7 |

| | Example (mol %) | | | | |
|---|---|---|---|---|---|
| | 122 | 123 | 124 | 125 | 126 |
| NiO | 0.079 | 0.081 | 0.098 | 0.10 | 0.10 |
| Co₃O₄ | 3 × 10⁻⁵ | 5 × 10⁻⁵ | 13 × 10⁻⁵ | 11 × 10⁻⁵ | 16 × 10⁻⁵ |
| TiO₂ | 0.009 | 0.009 | 0.007 | 0.82 | 0.007 |
| Fe₂O₃ | 0.004 | 0.004 | 0.016 | 0.004 | 0.048 |
| SnO₂ | 0 | 0 | 0 | 0 | 0 |
| NiO (wt) | 0.094 | 0.097 | 0.115 | 0.120 | 0.123 |
| Co₃O₄ (wt) | 0.0001 | 0.0002 | 0.0005 | 0.0004 | 0.0006 |
| TiO₂ (wt) | 0.011 | 0.011 | 0.008 | 1.03 | 0.008 |
| Fe₂O₃ (wt) | 0.011 | 0.011 | 0.041 | 0.010 | 0.12 |
| SnO₂ (wt) | 0 | 0 | 0 | 0 | 0 |
| L* | 81.2 | 79.3 | 89.2 | 92.3 | 88.6 |
| a* | −6.16 | −8.28 | 0.66 | −0.03 | −0.62 |
| b* | 17.3 | 15.6 | 25.0 | 16.4 | 26.5 |

TABLE 16
Composition and Properties of Examples 127-138

| | Example (mol %) | | | | | |
|---|---|---|---|---|---|---|
| | 127 | 128 | 129 | 130 | 131 | 132 |
| NiO | 9 × 10⁻⁵ | 9 × 10⁻⁵ | 26 × 10⁻⁵ | 0.022 | 0.042 | 0.061 |
| Co₃O₄ | 0.014 | 0.008 | 0.026 | 16 × 10⁻⁵ | 0.013 | 0.019 |
| TiO₂ | 0.011 | 0.009 | 0.007 | 0.007 | 0.007 | 0.007 |
| Fe₂O₃ | 0.008 | 0.050 | 0.005 | 0.005 | 0.006 | 0.006 |
| SnO₂ | 0.0008 | 0 | 0 | 0 | 0 | 0 |
| NiO (wt) | 0.0001 | 0.0001 | 0.0003 | 0.026 | 0.049 | 0.07 |
| Co₃O₄ (wt) | 0.051 | 0.031 | 0.099 | 0.0006 | 0.048 | 0.070 |
| TiO₂ (wt) | 0.014 | 0.011 | 0.008 | 0.009 | 0.009 | 0.009 |
| Fe₂O₃ (wt) | 0.021 | 0.125 | 0.012 | 0.013 | 0.016 | 0.016 |
| SnO₂ (wt) | 0.002 | 0 | 0 | 0 | 0 | 0 |
| L* | 91.0 | 92.1 | 67.9 | 94.6 | 92.1 | 90.3 |
| a* | −3.26 | −2.22 | 1.26 | −0.01 | −0.42 | −0.56 |
| b* | 4.57 | 0.051 | −35.0 | 6.73 | −1.7 | −2.5 |

| | Example (mol %) | | | | | |
|---|---|---|---|---|---|---|
| | 133 | 134 | 135 | 136 | 137 | 138 |
| NiO | 0.070 | 0.081 | 0.083 | 0.10 | 0.12 | 0.13 |
| Co₃O₄ | 0.021 | 0.023 | 0.024 | 0.025 | 0.027 | 0.027 |
| TiO₂ | 0.007 | 0.007 | 0.007 | 0.007 | 0.007 | 0.007 |
| Fe₂O₃ | 0.006 | 0.006 | 0.007 | 0.006 | 0.006 | 0.006 |
| SnO₂ | 0 | 0 | 0 | 0 | 0 | 0 |
| NiO (wt) | 0.082 | 0.095 | 0.097 | 0.12 | 0.14 | 0.15 |
| Co₃O₄ (wt) | 0.079 | 0.089 | 0.089 | 0.093 | 0101 | 0.0103 |
| TiO₂ (wt) | 0.009 | 0.014 | 0.011 | 0.008 | 0.009 | 0.009 |
| Fe₂O₃ (wt) | 0.016 | 0.016 | 0.017 | 0.016 | 0.016 | 0.016 |
| SnO₂ (wt) | 0 | 0 | 0 | 0 | 0 | 0 |
| L* | 89.6 | 64.05 | 63.84 | 87.13 | 85.48 | 57.22 |
| a* | −0.61 | −4.03 | −4351 | −1.31 | −1.61 | −3.67 |
| b* | −2.71 | −7.12 | −5.1 | −1.57 | −0.57 | −3.35 |

Table 16 presents the colorant package and CIE color space coordinates for Examples 127-133. As noted above, Examples 127-133 were formed in a Pt crucible. Examples 127-133 comprised NiO and TiO₂ (with Examples 127-133 further comprising Co₃O₄). along with Fe₂O₃ as a redox couple and optionally SnO₂. Examples 127-133 comprised a*<0 and b*<0.

Table 17 presents the colorant package and CIE color space coordinates for Examples 139-152. As noted above, Examples 139-152 were formed in a Pt crucible. Examples 139-152 comprised three multi-valent colorants, namely, NiO, TiO₂, and CeO₂, along with Fe₂O₃ as a redox couple and optionally SnO₂. Examples 139-150 comprised a*<0 and b*>0. Examples 140, 142-143, 146-148, and 151 comprised b*>10. Examples 151-152 comprised a*>0 and b*>0.

Table 18 presents the colorant package and CIE color space coordinates for Examples 153-166. As noted above, Examples 153-166 were formed in a Pt crucible. Examples 153-166 comprised three multi-valent colorants, namely, NiO, TiO₂, and CeO₂, along with Fe₂O₃ as a redox couple and optionally SnO₂. Examples 153-159, 161, 163, and 165-166 further comprise Co₃O₄ as an additional multi-valent colorant. Examples 153-166 comprised a*<0 and b*>0. Examples 155 and 159-166 comprised b*>10.

TABLE 17
Composition and Properties of Examples 139-152

| | Example (mol %) | | | | | | |
|---|---|---|---|---|---|---|---|
| | 139 | 140 | 141 | 142 | 143 | 144 | 145 |
| NiO | 8 × 10⁻⁵ | 17 × 10⁻⁵ | 33 × 10⁻⁵ | 51 × 10⁻⁵ | 0.020 | 0.021 | 0.049 |
| TiO₂ | 0.010 | 0.72 | 0.010 | 1.77 | 0.007 | 0.006 | 1.17 |
| CeO₂ | 0.0011 | 1.08 | 0.0025 | 0.44 | 0.72 | 0.31 | 0.39 |
| Fe₂O₃ | 0.005 | 0.005 | 0.005 | 0.005 | 0.004 | 0.004 | 0.005 |
| SnO₂ | 0.05 | 0.0004 | 0.05 | 0.0009 | 0 | 0 | 0.0004 |
| NiO (wt) | 0.0001 | 0.0002 | 0.0004 | 0.0006 | 0.024 | 0.024 | 0.059 |
| TiO₂ (wt) | 0.012 | 0.91 | 0.13 | 2.24 | 0.008 | 0.008 | 1.48 |
| CeO₂ (wt) | 0.003 | 2.91 | 0.007 | 1.19 | 1.95 | 0.83 | 1.07 |
| Fe₂O₃ (wt) | 0.012 | 0.013 | 0.012 | 0.013 | 0.010 | 0.010 | 0.013 |
| SnO₂ (wt) | 0.13 | 0.0009 | 0.13 | 0.0021 | 0 | 0 | 0.0009 |
| L* | 95.4 | 93.5 | 93.5 | 93.9 | 94.3 | 94.8 | 95.5 |
| a* | −1.46 | −1.63 | −3.42 | −2.7 | −0.71 | −0.5 | −0.27 |
| b* | 2.72 | 17.6 | 7.53 | 23.1 | 11.22 | 7.67 | 4.8 |

Example (mol %)

| | 146 | 147 | 148 | 149 | 150 | 151 | 152 |
|---|---|---|---|---|---|---|---|
| NiO | 0.059 | 0.060 | 0.061 | 0.062 | 0.10 | 0.10 | 0.13 |
| TiO₂ | 0.006 | 0.006 | 0.007 | 0.010 | 0.007 | 0.006 | 0.71 |
| CeO₂ | 0.51 | 0.31 | 0.72 | 1.07 | 0.72 | 0.31 | 0.002 |
| Fe₂O₃ | 0.004 | 0.004 | 0.004 | 0.005 | 0.004 | 0.004 | 0.005 |
| SnO₂ | 0 | 0 | 0 | 0.0005 | 0 | 0 | 0.0002 |
| NiO (wt) | 0.0070 | 0.071 | 0.071 | 0.073 | 0.118 | 0.115 | 0.161 |
| TiO₂ (wt) | 0.008 | 0.008 | 0.008 | 0.012 | 0.008 | 0.008 | 0.90 |
| CeO₂ (wt) | 0.003 | 2.91 | 0.007 | 1.19 | 1.95 | 0.83 | 1.07 |
| Fe₂O₃ (wt) | 0.010 | 0.010 | 0.010 | 0.014 | 0.010 | 0.010 | 0.012 |
| SnO₂ (wt) | 0 | 0 | 0 | 0.0011 | 0 | 0 | 0.0005 |
| L* | 91.7 | 91.7 | 91.2 | 94.8 | 94.5 | 89.0 | 93.4 |
| a* | −0.33 | −0.15 | −0.40 | −0.21 | −0.32 | 0.11 | 0.15 |
| b* | 19.5 | 18.5 | 21.8 | 6.75 | 8.68 | 24.8 | 9.56 |

TABLE 18
Composition and Properties of Examples 153-166

| | Example (mol %) | | | | | | |
|---|---|---|---|---|---|---|---|
| | 153 | 154 | 155 | 156 | 157 | 158 | 159 |
| NiO | 0.050 | 0.051 | 0.060 | 0.061 | 0.068 | 0.077 | 0.081 |
| Co₃O₄ | 0.011 | 0.009 | 0.009 | 0.014 | 0.011 | 0.014 | 0.004 |
| TiO₂ | 0.007 | 0.007 | 0.010 | 0.007 | 0.007 | 0.007 | 0.006 |
| CeO₂ | 0.079 | 0.077 | 0.076 | 0.076 | 0.075 | 0.077 | 0.075 |
| Fe₂O₃ | 0.007 | 0.007 | 0.008 | 0.006 | 0.006 | 0.006 | 0.006 |
| SnO₂ | 0 | 0 | 0 | 0 | 0 | 0 | 0 |
| NiO (wt) | 0.059 | 0.060 | 0.070 | 0.071 | 0.080 | 0.090 | 0.096 |
| Co₃O₄ (wt) | 0.042 | 0.034 | 0.035 | 0.052 | 0.043 | 0.052 | 0.017 |
| TiO₂ (wt) | 0.008 | 0.008 | 0.008 | 0.012 | 0.008 | 0.0008 | 0.903 |
| CeO₂ (wt) | 0.21 | 0.21 | 0.21 | 0.20 | 0.20 | 0.21 | 0.20 |
| Fe₂O₃ (wt) | 0.017 | 0.017 | 0.020 | 0.016 | 0.016 | 0.016 | 0.016 |
| SnO₂ (wt) | 0 | 0 | 0 | 0 | 0 | 0 | 0 |
| L* | 89.7 | 91.0 | 72.1 | 89.4 | 89.9 | 89.0 | 90.3 |
| a* | −3.01 | −2.75 | −9.62 | −2.79 | −2.79 | −2.86 | −3.94 |
| b* | 6.93 | 7.6 | 19.7 | 5.64 | 6.89 | 6.64 | 17.4 |
| | Example (mol %) | | | | | | |
| | 160 | 161 | 162 | 163 | 164 | 165 | 166 |
| NiO | 0.083 | 0.086 | 0.12 | 0.13 | 0.16 | 0.17 | 0.17 |
| Co₃O₄ | 0 | 0.0056 | 0 | 0.0045 | 0 | 0.0045 | 0.0045 |
| TiO₂ | 0.006 | 0.005 | 0.006 | 0.006 | 0.006 | 0.005 | 0.005 |
| CeO₂ | 0.076 | 0.077 | 0.077 | 0.077 | 0.075 | 0.078 | 0.078 |
| Fe₂O₃ | 0.006 | 0.006 | 0.006 | 0.006 | 0.006 | 0.006 | 0.006 |
| SnO₂ | 0 | 0 | 0 | 0 | 0 | 0 | 0 |
| NiO (wt) | 0.097 | 0.100 | 0.146 | 0.147 | 0.193 | 0.196 | 0.198 |
| Co₃O₄ (wt) | 0 | 0.017 | 0 | 0.017 | 0 | 0.017 | 0.017 |
| TiO₂ (wt) | 0.008 | 0.007 | 0.007 | 0.007 | 0.007 | 0.007 | 0.007 |
| CeO₂ (wt) | 0.206 | 0.207 | 0.207 | 0.207 | 0.204 | 0.209 | 0.209 |
| Fe₂O₃ (wt) | 0.15 | 0.015 | 0.015 | 0.016 | 0.015 | 0.015 | 0.016 |
| SnO₂ (wt) | 0 | 0 | 0 | 0 | 0 | 0 | 0 |
| L* | 91.8 | 90.0 | 91.2 | 90.1 | 90.3 | 87.9 | 88.9 |
| a* | −3.87 | −4.54 | −3.53 | −3.53 | −3.39 | −4.38 | −3.48 |
| b* | 20.1 | 19.2 | 21.9 | 18.4 | 24.4 | 24.4 | 21.1 |

TABLE 19
Composition and Properties of Examples 167-174

| | Example (mol %) | | | | | | | |
|---|---|---|---|---|---|---|---|---|
| | 167 | 168 | 169 | 170 | 171 | 172 | 173 | 174 |
| TiO₂ | 0.008 | 0.009 | 0.009 | 0.010 | 0.010 | 0.13 | 0.86 | 0.91 |
| CeO₂ | 0.0007 | 0.49 | 0.31 | 0.31 | 0.32 | 0.24 | 0.34 | 0.36 |
| Fe₂O₃ | 0.027 | 0.040 | 0.041 | 0.057 | 0.059 | 0.059 | 0.056 | 0.016 |
| MnO₂ | 0.28 | 0.42 | 0.44 | 0.64 | 0.66 | 0.62 | 0.59 | 0.12 |
| SnO₂ | 0 | 0 | 0 | 0 | 0 | 0 | 0 | 0 |
| TiO₂ (wt) | 0.0105 | 0.0108 | 0.0108 | 0.0124 | 0.0129 | 0.159 | 0.082 | 1.123 |
| CeO₂ (wt) | 0.002 | 1.34 | 0.83 | 0.84 | 0.86 | 0.64 | 0.93 | 0.96 |
| Fe₂O₃ (wt) | 0.07 | 0.101 | 0.104 | 0.143 | 0.148 | 0.147 | 0.141 | 0.041 |
| MnO₂ (wt) | 0.37 | 0.58 | 0.61 | 0.87 | 0.90 | 0.85 | 0.91 | 0.16 |
| SnO₂ (wt) | 0 | 0 | 0 | 0 | 0 | 0 | 0 | 0 |
| L* | 96.3 | 94.7 | 95.5 | 94.8 | 94.26 | 93.1 | 95.3 | 92.4 |
| a* | −0.21 | −0.27 | −0.33 | −0.62 | −0.42 | −0.14 | −0.32 | −0.04 |
| b* | 1.52 | 7.94 | 4.94 | 8.37 | 9.27 | 11.33 | 5.51 | 12.35 |

Table 19 presents the colorant package and CIE color space coordinates for Examples 167-174. As noted above, Examples 167-174 were formed in a Pt crucible. Examples 167-174 comprised TiO₂, and CeO₂ as multi-valent colorants along with Fe₂O₃ and MnO₂ as redox couples and optionally SnO₂. Examples 167-174 comprised a*<0 and b*>0.

Table 20 presents the colorant package and CIE color space coordinates for Examples 175-205. As noted above, Examples 175-205 were formed in a Pt crucible. Examples 175-205 comprised three multi-valent colorants, namely, NiO, TiO₂, and Co₃O₄, along with Fe₂O₃ and MnO₂ as redox couples and optionally SnO₂. Examples 175-205 comprised a*<0. Examples 175-177, 179-190, 194, and 197 comprised b*>0 as well as a*<0. Examples 178, 192-193, 195-196, and 198-205 comprised b*<0 as well as a*<0.

TABLE 20
Composition and Properties of Examples 175-205

| | Example (mol %) | | | | | |
|---|---|---|---|---|---|---|
| | 175 | 176 | 177 | 178 | 179 | 180 |
| Co₃O₄ | 3 × 10⁻⁵ | 3 × 10⁻⁵ | 8 × 10⁻⁵ | 8 × 10⁻⁵ | 11 × 10⁻⁵ | 11 × 10⁻⁵ |
| TiO₂ | 0.008 | 0.009 | 0.029 | 0.007 | 0.009 | 0.009 |
| NiO | 0.044 | 0.015 | 0.014 | 0.0002 | 0.0004 | 0.026 |
| Fe₂O₃ | 0.005 | 0.005 | 0.005 | 0.003 | 0.005 | 0.005 |
| MnO₂ | 0.0014 | 0.0018 | 0.0007 | 0.0007 | 0.0007 | 0.0022 |
| SnO₂ | 0 | 0 | 0.001 | 0 | 0 | 0 |
| Co₃O₄ (wt) | 0.0001 | 0.0001 | 0.0003 | 0.0003 | 0.0004 | 0.0004 |
| TiO₂ (wt) | 0.011 | 0.012 | 0.037 | 0.08 | 0.011 | 0.011 |
| NiO (wt) | 0.052 | 0.018 | 0.017 | 0.0002 | 0.0005 | 0.031 |
| Fe₂O₃ (wt) | 0.013 | 0.014 | 0.012 | 0.009 | 0.012 | 0.012 |
| MnO₂ (wt) | 0.0019 | 0.0025 | 0.0010 | 0.0010 | 0.0010 | 0.003 |
| SnO₂ (wt) | 0 | 0 | 0.003 | 0 | 0 | 0 |
| L* | 93.9 | 94.7 | 95.4 | 95.7 | 87.9 | 93.6 |
| a* | −2.09 | −2.02 | −1.26 | −1.36 | −10.67 | −2.97 |
| b* | 2.93 | 1.76 | 2.19 | −1.12 | 2.51 | 2.27 |

| | Example (mol %) | | | | | | |
|---|---|---|---|---|---|---|---|
| | 181 | 182 | 183 | 184 | 185 | 186 | 187 |
| Co₃O₄ | 11 × 10⁻⁵ | 0.036 | 0.087 | 0.052 | 0.022 | 0.0008 | 0.0002 |
| TiO₂ | 0.008 | 0.009 | 0.009 | 0.009 | 0.009 | 0.009 | 0.007 |
| NiO | 0.048 | 0.036 | 0.087 | 0.052 | 0.022 | 0.0008 | 0.0002 |
| Fe₂O₃ | 0.004 | 0.005 | 0.005 | 0.005 | 0.005 | 0.005 | 0.009 |
| MnO₂ | 0.0029 | 0.0007 | 0.0014 | 0.0007 | 0.0007 | 0.0007 | 0.0021 |
| SnO₂ | 0.001 | 0 | 0 | 0 | 0 | 0 | 0.105 |
| Co₃O₄ (wt) | 0.0004 | 0.0005 | 0.0005 | 0.0005 | 0.0005 | 0.0005 | 0.0007 |
| TiO₂ (wt) | 0.011 | 0.011 | 0.011 | 0.011 | 0.011 | 0.011 | 0.009 |
| NiO (wt) | 0.057 | 0.042 | 0.103 | 0.061 | 0.026 | 0.001 | 0.0003 |
| Fe₂O₃ (wt) | 0.011 | 0.012 | 0.012 | 0.011 | 0.012 | 0.012 | 0.024 |
| MnO₂ (wt) | 0.004 | 0.0010 | 0.002 | 0.0010 | 0.0010 | 0.0010 | 0.003 |
| SnO₂ (wt) | 0.002 | 0 | 0 | 0 | 0 | 0 | 0.026 |
| L* | 93.0 | 93.5 | 92.2 | 92.7 | 95.0 | 90.2 | 93.0 |
| a* | −2.94 | −2.71 | −3.07 | −3.35 | −1.36 | −7.99 | −3.41 |
| b* | 3.47 | 2.98 | 5.62 | 4.1 | 2.27 | 2.6 | 3.48 |

Example (mol %)

| | 188 | 189 | 190 | 191 | 192 | 193 | 194 |
|---|---|---|---|---|---|---|---|
| Co₃O₄ | 0.0006 | 8 × 10⁻⁵ | 0.0009 | 0.0014 | 0.0016 | 0.0022 | 0.0028 |
| TiO₂ | 0.007 | 0.008 | 0.0028 | 0.0090 | 0.0087 | 0.0087 | 0.0084 |
| NiO | 0.0006 | 8 × 10⁻⁵ | 8 × 10⁻⁵ | 43 × 10⁻⁵ | 42 × 10⁻⁵ | 34 × 10⁻⁵ | 17 × 10⁻⁵ |
| Fe₂O₃ | 0.009 | 0.005 | 0.005 | 0.005 | 0.004 | 0.004 | 0.006 |
| MnO₂ | 0.0014 | 0.0015 | 0.0007 | 0.0007 | 0.0007 | 0.0007 | 0.0009 |
| SnO₂ | 0.105 | 0.001 | 0 | 0 | 0 | 0 | 0.0009 |
| Co₃O₄ (wt) | 0.0008 | 0.0033 | 0.0034 | 0.0053 | 0.0059 | 0.0082 | 0.010 |
| TiO₂ (wt) | 0.009 | 0.011 | 0.004 | 0.011 | 0.011 | 0.011 | 0.011 |
| NiO (wt) | 0.0007 | 0.0001 | 0.0001 | 0.0005 | 0.0005 | 0.0004 | 0.0002 |
| Fe₂O₃ (wt) | 0.024 | 0.013 | 0.012 | 0.012 | 0.011 | 0.011 | 0.014 |
| MnO₂ (wt) | 0.002 | 0.002 | 0.0010 | 0.0010 | 0.0010 | 0.0010 | 0.0013 |
| SnO₂ (wt) | 0.26 | 0.002 | 0 | 0 | 0 | 0 | 0.002 |
| L* | 95.7 | 94.3 | 95.1 | 87.6 | 93.9 | 93.6 | 93.3 |
| a* | −0.67 | −2.69 | −1.81 | −8.95 | −2.97 | −3.04 | −3.12 |
| b* | 1.07 | 0.8 | 0.35 | −1.47 | −0.28 | −0.06 | 0.56 |

| | Example (mol %) | | | | | |
|---|---|---|---|---|---|---|
| | 195 | 196 | 197 | 198 | 199 | 200 |
| Co₃O₄ | 0.0033 | 0.0034 | 0.0038 | 0.0040 | 0.0040 | 0.0051 |
| TiO₂ | 0.0089 | 0.0066 | 0.0090 | 0.0059 | 0.0068 | 0.0088 |
| NiO | 17 × 10⁻⁵ | 34 × 10⁻⁵ | 17 × 10⁻⁵ | 51 × 10⁻⁵ | 8 × 10⁻⁵ | 93 × 10⁻⁵ |
| Fe₂O₃ | 0.004 | 0.003 | 0.005 | 0.003 | 0.003 | 0.005 |
| MnO₂ | 0.0022 | 0.0007 | 0.0007 | 0.0015 | 0.002 | 0.0007 |
| SnO₂ | 0 | 0 | 0.0012 | 0 | 0 | 0 |
| Co₃O₄ (wt) | 0.012 | 0.013 | 0.14 | 0.15 | 0.16 | 0.19 |
| TiO₂ (wt) | 0.011 | 0.008 | 0.011 | 0.008 | 0.012 | 0.011 |
| NiO (wt) | 0.0002 | 0.0004 | 0.0002 | 0.0006 | 0.0003 | 0.0011 |
| Fe₂O₃ (wt) | 0.011 | 0.008 | 0.012 | 0.007 | 0.011 | 0.012 |
| MnO₂ (wt) | 0.003 | 0.001 | 0.001 | 0.002 | 0.001 | 0.001 |
| SnO₂ (wt) | 0 | 0 | 0.003 | 0 | 0 | 0 |
| L* | 90.3 | 85.7 | 83.2 | 84.4 | 89.6 | 87.3 |
| a* | −2.75 | −8.02 | −13.26 | −8.61 | −6.32 | −2.01 |
| b* | −8.09 | −5.1 | 28.11 | −6.42 | −10.17 | −8.99 |

Example (mol %)

| | 201 | 202 | 203 | 204 | 205 |
|---|---|---|---|---|---|
| Co₃O₄ | 0.0080 | 0.010 | 0.011 | 0.013 | 0.017 |
| TiO₂ | 0.0091 | 0.0089 | 0.0073 | 0.010 | 0.0087 |
| NiO | 8 × 10⁻⁵ | 17 × 10⁻⁵ | 16 × 10⁻⁵ | 24 × 10⁻⁵ | 34 × 10⁻⁵ |
| Fe₂O₃ | 0.005 | 0.005 | 0.010 | 0.006 | 0.005 |
| MnO₂ | 0.0022 | 0.0007 | 0.0014 | 0.0004 | 0.0007 |
| SnO₂ | 0 | 0.001 | 0.11 | 0.0008 | 0.001 |
| Co₃O₄ (wt) | 0.031 | 0.039 | 0.043 | 0.051 | 0.063 |
| TiO₂ (wt) | 0.012 | 0.011 | 0.010 | 0.013 | 0.011 |
| NiO (wt) | 0.0001 | 0.0002 | 0.0002 | 0.003 | 0.0004 |
| Fe₂O₃ (wt) | 0.012 | 0.011 | 0.026 | 0.014 | 0.012 |
| MnO₂ (wt) | 0.003 | 0.001 | 0.002 | 0.0006 | 0.001 |
| SnO₂ (wt) | 0 | 0.003 | 0.26 | 0.002 | 0.004 |
| L* | 92.1 | 92.7 | 81.0 | 90.3 | 89.1 |
| a* | −2.98 | −2.49 | −1.57 | −0.37 | −3.26 |
| b* | −11.72 | −2.96 | −3.18 | −18.65 | −5.34 |

TABLE 21
Composition and Properties of Examples 206-222

| | Example (mol %) | | | | | |
|---|---|---|---|---|---|---|
| | 206 | 207 | 208 | 209 | 210 | 211 |
| Co₃O₄ | 3 × 10⁻⁵ | 13 × 10⁻⁵ | 13 × 10⁻⁵ | 16 × 10⁻⁵ | 0.0054 | 0.0084 |
| TiO₂ | 0.011 | 0.006 | 0.010 | 0.010 | 0.007 | 0.010 |
| NiO | 0.0016 | 9 × 10⁻⁵ | 9 × 10⁻⁵ | 26 × 10⁻⁵ | 9 × 10⁻⁵ | 34 × 10⁻⁵ |
| Fe₂O₃ | 0.008 | 0.005 | 0.022 | 0.048 | 0.006 | 0.034 |
| MnO₂ | 44 × 10⁻⁵ | 73 × 10⁻⁵ | 73 × 10⁻⁵ | 74 × 10⁻⁵ | 74 × 10⁻⁵ | 0.0015 |
| SnO₂ | 0.001 | 0 | 0 | 0 | 0 | 0 |
| Co₃O₄ (wt) | 0.0001 | 0.0005 | 0.0005 | 0.0006 | 0.020 | 0.032 |
| TiO₂ (wt) | 0.014 | 0.008 | 0.012 | 0.012 | 0.009 | 0.013 |
| NiO (wt) | 0.0019 | 0.0001 | 0.0001 | 0.0003 | 0.0001 | 0.0004 |
| Fe₂O₃ (wt) | 0.021 | 0.012 | 0.055 | 0.12 | 0.016 | 0.085 |
| MnO₂ (wt) | 0.0006 | 0.0010 | 0.0010 | 0.0010 | 0.0010 | 0.0020 |
| SnO₂ (wt) | 0.0024 | 0 | 0 | 0 | 0 | 0 |
| L* | 92.7 | 95.6 | 95.0 | 94.7 | 90.1 | 92.6 |
| a* | −5.04 | −1.45 | −2.11 | −1.89 | −0.56 | −1.62 |
| b* | 16.02 | −1.06 | 5.67 | 3.63 | −7.95 | −0.87 |

| | Example (mol %) | | | | | |
|---|---|---|---|---|---|---|
| | 212 | 213 | 214 | 215 | 216 | 217 |
| Co₃O₄ | 0.012 | 0.013 | 0.014 | 0.014 | 0.016 | 0.017 |
| TiO₂ | 0.007 | 0.011 | 0.010 | 0.008 | 0.007 | 0.007 |
| NiO | 9 × 10⁻⁵ | 67 × 10⁻⁵ | 17 × 10⁻⁵ | 0.048 | 0.052 | 0.057 |
| Fe₂O₃ | 0.0006 | 0.008 | 0.038 | 0.006 | 0.006 | 0.006 |
| MnO₂ | 0.0015 | 65 × 10⁻⁵ | 74 × 10⁻⁵ | 74 × 10⁻⁵ | 0.0022 | 0.0015 |
| SnO₂ | 0 | 0.001 | 0 | 0 | 0 | 0 |
| Co₃O₄ (wt) | 0.046 | 0.049 | 0.052 | 0.054 | 0.060 | 0.064 |
| TiO₂ (wt) | 0.009 | 0.014 | 0.012 | 0.009 | 0.009 | 0.008 |
| NiO (wt) | 0.0001 | 0.0008 | 0.0002 | 0.057 | 0.061 | 0.067 |
| Fe₂O₃ (wt) | 0.016 | 0.020 | 0.096 | 0.016 | 0.016 | 0.016 |
| MnO₂ (wt) | 0.0020 | 0.0009 | 0.001 | 0.001 | 0.003 | 0.002 |
| SnO₂ (wt) | 0 | 0.0025 | 0 | 0 | 0 | 0 |
| L* | 82.1 | 90.7 | 90.8 | 91.7 | 91.1 | 90.7 |
| a* | −0.67 | −3.57 | −1.89 | −0.45 | −0.49 | −0.52 |
| b* | −17.6 | 4.27 | −2.67 | −1.86 | −2.13 | −2.25 |

Example (mol %)

| | 218 | 219 | 220 | 221 | 222 |
|---|---|---|---|---|---|
| Co₃O₄ | 0.019 | 0.020 | 0.022 | 0.022 | 0.027 |
| TiO₂ | 0.011 | 0.007 | 0.007 | 0.007 | 0.007 |
| NiO | 9 × 10⁻⁵ | 0.067 | 0.074 | 0.082 | 0.13 |
| Fe₂O₃ | 0.037 | 0.006 | 0.006 | 0.007 | 0.006 |
| MnO₂ | 0.0013 | 0.0022 | 0.0015 | 0.0022 | 74 × 10⁻⁵ |
| SnO₂ | 8 × 10⁻⁵ | 0 | 0 | 0 | 0 |
| Co₃O₄ (wt) | 0.072 | 0.075 | 0.083 | 0.085 | 0.103 |
| TiO₂ (wt) | 0.014 | 0.009 | 0.009 | 0.009 | 0.009 |
| NiO (wt) | 0.0001 | 0.079 | 0.086 | 0.096 | 0.147 |
| Fe₂O₃ (wt) | 0.016 | 0.016 | 0.019 | 0.019 | 0.016 |
| MnO₂ (wt) | 0.002 | 0.003 | 0.002 | 0.003 | 0.001 |
| SnO₂ (wt) | 0 | 0 | 0 | 0 | 0 |
| L* | 89.7 | 89.9 | 89.2 | 87.6 | 85.7 |
| a* | −1.9 | −0.59 | −0.63 | −1.36 | −1.3 |
| b* | −3.99 | −2.53 | −2.89 | −0.92 | −0.99 |

Table 21 presents the colorant package and CIE color space coordinates for Examples 206-222. As noted above, Examples 206-222 were formed in a Pt crucible. Examples 206-222 comprised three multi-valent colorants, namely, NiO, TiO₂, and Co₃O₄, along with Fe₂O₃ and MnO₂ as redox couples and optionally SnO₂. Examples 206-222 comprised a*<0. Examples 206, 209-209, and 213 comprised b*>0 as well as a*<0. Examples 207, 210-212, and 214-222 comprised b*<0 as well as a*<0.

The above observations can be combined to provide glass articles and natively colored glass housings including the same comprising a multi-valent colorant. The glass articles can exhibit a high brightness (e.g., CIE L* value greater than 50 or greater than 70 and less than 96.5) color. A predetermined color of the glass article and/or natively colored glass can be achieved by controlling an amount of the multi-valent colorant in a reduced form compared to an oxidized form. Additionally, colors not previously obtainable from a given colorant package can be obtained by controlling a molar ratio of the multi-valent colorant in the reduced form to the total amount of the multi-valent colorant.

The glass-based material of the glass article can provide good dimensional stability, good impact resistance, good crack resistance, good puncture resistance, and/or good flexural strength. The glass article can include a compressive stress region (e.g., be chemically strengthened), which can provide improved crack resistance, puncture resistance, impact resistance, and/or improved flexural strength. Also, minimizing the combination of R₂O, CaO, MgO, and ZnO in the glass composition may provide the resultant colored glass article with a desirable dielectric constant, for example when the colored glass article is used as a portion of a housing for an electronic device. Providing a dielectric constant for frequencies from 10 GHz to 60 GHz from 5.6 to 6.4 can allow wireless communication through the glass article.

Providing a natively colored glass housing with a colored glass article can eliminate the need for an additional layer to impart color to the housing, which can simplify assembly and provide a more consistent color. Consequently, the natively colored glass housing including the glass article can provide an aesthetically pleasing appearance (e.g., color) while simultaneously protecting an electronic device from damage and/or permitting wireless communication therethrough.

Methods include forming a glass article from precursor materials comprising a multi-valent colorant with a precursor molar ratio that is different than the molar ratio of the multi-valent colorant in the resulting glass article. The molar ratio can be decreased by, for example, including a source of nitrate, sulfate, zinc, or combinations thereof in the precursor materials. The molar ratio can be increased by, for example, including a source of carbon, iron, antimony, or combinations thereof in the precursor materials. Adjusting a cooling rate of a melt formed from melting the precursor materials can also be used to control a molar ratio of the multi-valent colorant. Controlling the molar ratio of the multi-valent colorant can enable the glass article to reliably produce a predetermined color (e.g., CIE color coordinates). Controlling the molar ratio of the multi-valent colorant can increase a color gamut and/or a resolution of the colors obtained for a predetermined colorant package including the multi-valent colorant.

Directional terms as used herein—for example, up, down, right, left, front, back, top, bottom—are made only with reference to the figures as drawn and are not intended to imply absolute orientation.

It will be appreciated that the various disclosed aspects may involve features, elements, or steps that are described in connection with that aspect. It will also be appreciated that a feature, element, or step, although described in relation to one aspect, may be interchanged or combined with alternate aspects in various non-illustrated combinations or permutations.

It is also to be understood that, as used herein the terms “the,” “a,” or “an,” mean “at least one,” and should not be limited to “only one” unless explicitly indicated to the contrary. For example, reference to “a component” comprises aspects having two or more such components unless the context clearly indicates otherwise. Likewise, a “plurality” is intended to denote “more than one.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Ranges can be expressed herein as from “about” one particular value, and/or to “about” another particular value. When such a range is expressed, aspects include from the one particular value and/or to the other particular value. Similarly, when values are expressed as approximations, by use of the antecedent “about,” it will be understood that the particular value forms another aspect. Whether or not a numerical value or endpoint of a range in the specification recites “about,” the numerical value or endpoint of a range is intended to include two aspects: one modified by “about,” and one not modified by “about.” It will be further understood that the endpoints of each of the ranges are significant both in relation to the other endpoint and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In aspects, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

While various features, elements, or steps of particular aspects may be disclosed using the transitional phrase “comprising,” it is to be understood that alternative aspects, including those that may be described using the transitional phrases “consisting of” or “consisting essentially of,” are implied. Thus, for example, implied alternative aspects to an apparatus that comprises A+B+C include aspects where an apparatus consists of A+B+C and aspects where an apparatus consists essentially of A+B+C. As used herein, the terms “comprising” and “including”, and variations thereof shall be construed as synonymous and open-ended unless otherwise indicated.

The above aspects, and the features of those aspects, are exemplary and can be provided alone or in any combination with any one or more features of other aspects provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the aspects herein provided they come within the scope of the appended claims and their equivalents.

1-47. (canceled)

48. A method of making a housing for a consumer electronic device comprising:
melting precursor materials together to form a glass article,
wherein the glass article comprises a silicate glass with a multi-valent colorant having a reduced form and an oxidized form, the precursor materials comprising the multi-valent colorant, the multi-valent colorant is a metal selected from a group consisting of cerium, titanium, cobalt, copper, nickel, vanadium, chromium, and combinations thereof, a precursor molar ratio of the oxidized form of the multi-valent colorant in the precursor materials to a total of the oxidized form and the reduced form of the multi-valent colorant in the precursor materials is different than a molar ratio of the oxidized form of the multi-valent colorant in the glass article to the total of the oxidized form and the reduced form of the multi-valent colorant in the glass article.

49. The method of claim 48, wherein an absolute value of a difference between the precursor molar ratio of the precursor materials and the molar ratio of the glass article is from 0.1 to 0.5.

50. The method of claim 48, wherein the precursor materials further comprise 0.02 wt % or more of a source of sulfate, nitrate, zinc, or combinations thereof.

51. The method of claim 50, wherein the precursor materials comprise at least one of:
from 0.1 wt % to 0.3 wt % of the source of sulfate;
from 0.25 wt % to 1 wt % of the source of zinc;
from 0.1 wt % to 3 wt % of the source of nitrate.

52. The method of claim 48, wherein the molar ratio of the glass article is greater than the precursor molar ratio of the precursor materials.

53. The method of claim 52, wherein the precursor materials comprise from 300 ppm to 1,300 ppm of a source of iron.

54. The method of claim 48, wherein the precursor materials comprise from 0.004 wt % to 0.05 wt % of a source of carbon.

55. The method of claim 48, wherein the melting the precursor materials comprises heating the precursor materials to a first temperature of 1500° C. or more to form a melt, and cooling the melt at a predetermined rate from the first temperature to 1400° C. before forming the glass article from the melt, wherein the predetermined rate is from 0.5° C./min to 2° C./min.

56. The method of claim 48, wherein:
a CIE a* value of the glass article is less than −3;
a CIE b* value of the glass article is greater than 5; or both.

57. The method of claim 48, wherein the molar ratio of the reduced form to the total of the reduced form and the oxidized form in the glass article is from 0.5 to 0.9.

58. A natively colored glass housing for a consumer electronic device, the natively colored glass housing comprising a glass article comprising a thickness defined between a first major surface and a second major surface opposite the first major surface, the thickness is from 200 μm to 5 mm, wherein the glass article comprises a silicate glass with a multi-valent colorant having a reduced form and an oxidized form, a molar ratio of the reduced form of the multi-valent colorant to a total of the reduced form and the oxidized form is from 0.3 to 0.9, and a total transmittance of at least one 10 nm band within a wavelength range of 380 nm to 750 nm through the thickness is from 3% to 80%.

59. The natively colored glass housing of claim 58, wherein an absolute value of a CIE a* value of the glass article is 0.3 or more, and an absolute of the CIE b* value of the glass article is 0.2 or more.

60. The natively colored glass housing of claim 58, wherein:
a CIE a* value of the glass article is less than −3;
a CIE b* value of the glass article is greater than 5; or both.

61. The natively colored glass housing of claim 58, wherein the molar ratio of the reduced form to the total of the reduced form and the oxidized form is from 0.5 to 0.9.

62. The natively colored glass housing of claim 58, wherein the glass article comprises at least one of:
200 ppm or more of Fe₂O₃;
from 0.25 wt % to 1 wt % of ZnO.

63. The natively colored glass housing of claim 58, wherein the multi-valent colorant is a metal selected from a group consisting of cerium, titanium, cobalt, copper, nickel, vanadium, chromium, and combinations thereof.

64. The natively colored glass housing of claim 58, wherein the glass article comprises, as a mol % of the glass article:
from 50 mol % to 75 mol % SiO₂;
from 7 mol % to 20 mol % Al₂O₃;
from 10 mol % to 20 mol % of at least one alkali metal oxide, alkali metal oxides including Li₂O, Na₂O, and K₂O;
from 0.001 mol % to 1 mol % of the multi-valent colorant; and
at least one of B₂O₃ or P₂O₅.

65. The natively colored glass housing of claim 58, wherein the glass article comprises, as a mol % of the glass article:
from 60 mol % to 65 mol % SiO₂;
from 12 mol % to 17 mol % Al₂O₃;
from 3 mol % to 6 mol % B₂O₃;
from 10 mol % to 16 mol % of at least one alkali metal oxide, alkali metal oxides including Li₂O, Na₂O, and K₂O;
from 3 mol % to 5 mol % CaO;
from 0 mol % to 1 mol % ZrO₂;
from 0 mol % to 0.25 mol % SnO₂; and
from 0.005 mol % to 0.2 mol % of the multi-valent colorant.

66. The natively colored glass housing of claim 58, further comprising a first compressive stress region extending to a first depth of compression from the first compressive stress region, and a maximum compressive stress of the first compressive stress region is 400 MegaPascals or more.

67. The natively colored glass housing of claim 58, further comprising:
circuitry comprising an antenna that transmits signals within a range of 26 GHz to 40 GHz;
the natively colored glass housing at least partially surrounding the circuitry; and
a structure formed as an integral portion of the glass article, wherein the structure comprises a perimeter demarcating a second thickness of the structure that differs from the thickness of the glass article by at least 150 μm,
wherein the antenna is positioned and oriented such that the signals are transmitted through the structure of the glass sheet of the panel of the housing.
